(19) United States
(12) Patent Application Publication
(10) Pub. No.: US 2026/0256110 A1
(43) Pub. Date: Sep. 3, 2026

(54) THERMAL EXCHANGE PAD AND SYSTEM FOR LIVESTOCK FLOORING

(71) Applicant: Innovative Heating Technologies Inc., Oak Bluff (CA)

(72) Inventors: Matthew Robins, Winnipeg (CA); R Jorrel Nepomuceno, Winnipeg (CA); Randolph Crasto, Starbuck (CA); Cheuk Wang SENE, Winnipeg (CA); Anton PUTOV, Winnipeg (CA)

(73) Assignee: Innovative Heating Technologies Inc., Oak Bluff (CA)

(21) Appl. No.: 19/656,762

(22) Filed: Apr. 23, 2026

Related U.S. Application Data
(63) Continuation of application No. PCT/CA2024/051406, filed on Oct. 24, 2024.
(60) Provisional application No. 63/592,729, filed on Oct. 24, 2023.

(51) Int. Cl. A01K 1/015; A01K 1/00

(52) U.S. Cl. CPC A01K 1/0158; A01K 1/0076

(57) ABSTRACT

Embodiments of the present disclosure provide thermal exchange pads and systems to address stress in livestock exposed to hot or cold environmental conditions in barns or transport trailer environments. An illustrative embodiment of a thermal exchange pad for livestock flooring includes a thermally conductive heat exchange plate and a fluid plate together defining excreta debris drains and heat exchange fluid channels. The thermal exchange pad may be position on top of existing floor structure, or optionally may provide the structure required for flooring supporting livestock. An illustrative embodiment of a thermal exchange system for livestock flooring includes a plurality of thermal exchange pads, optional coupling raceways enclosing controller cables and fluid supply and return lines, a controller, a pump, a heat exchange fluid reservoir, a thermal source, and flow regulating valves.

### CROSS-REFERENCE TO RELATED APPLICATION

This is a continuation patent application of international Patent Cooperation Treaty Application No. CA/2024/051406, filed October 24, 2024, titled THERMAL EXCHANGE PAD AND SYSTEM FOR LIVESTOCK FLOORING, which is an international PCT application claiming priority to US Provisional Patent Application No. 63/592,729, filed October 24, 2023, and titled THERMAL EXCHANGE PAD AND SYSTEM FOR LIVESTOCK FLOORING, all of which are hereby incorporated herein by reference.

### TECHNICAL FIELD

Embodiments of this disclosure relate generally to cooling or heating system and components for livestock flooring to promote well-being and reproductive performance, and more particularly to systems and components for controlling the temperature of and waste drainage for portions of a livestock flooring systems for barns and for transport trailers.

### BACKGROUND

The need to address heat stress in livestock is not limited to swine; however, swine production is an example of livestock operations the greatly benefit from controlling the temperature of the animals due to ambient and induced environmental conditions. Modern swine farrowing operations have reached a state in which the ambient environmental conditions preferred for piglets are usually significantly different from that preferred for the sow. Selection for increased litter size and lean growth has led to the selection of piglets with decreased birth weights and less body energy reserves at birth. To promote survival rates of the piglets, ambient environmental (room) temperatures greater than 25° C. and a floor lying area temperature of about 37° C. provided by heat pads or heat lamps is currently recommended for farrowing barns. Therefore, in most swine producing areas, the farrowing rooms are maintained at about 25° C. for about nine months of the year, and the barns are often still warmer during summer months.

However, sows have an increased susceptibility to heat stress, if the ambient temperature in the farrowing room rises above 25° C. Recently, greater than 60% of sow farm operations in the U.S.A. reported a decline in fertility during the warmest summer months of July and August. Moreover, daily feed intakes, milk production levels, and subsequent reproductive performance of sows are negatively impacted as a result of maintaining farrowing room temperatures of 25° C. to promote piglet survival. This issue has been worsened by increases in litter size and milk production which have increased the heat production of lactating sows by 55% to 70% and reduced their upper critical temperature to approximately 18° C.

If the anticipated ambient environmental temperatures continue to be increased, it will become increasingly more important for lactating sows to be provided with some form of active cooling to maintain their productivity and welfare. Attempts have been made to provide cooling systems embedded within the floors of sow farrowing crates to reduce the impact of heat stress on sows and improve sow productivity and reproductive performance by local removal of excess heat from the animals. However, such known attempts to date have been limited by inefficient heat transfer from the sow and do not allow for changes in the amount of cooling relative to the sow's heat production or surrounding environmental conditions.

Heat stress on boars can reduce the quality of semen collected for artificial insemination, so it is also beneficial to providing cooling for boars in warm environments. Additionally, it is important to prevent contamination during the process of collecting semen from boars. A significant challenge to preventing contamination during collection relates to livestock flooring and any residue or buildup of animal excreta.

Transport trailers to transport adult and piglet swine are generally open air with numerous large vents that expose the livestock to ambient conditions, including extreme heat or extreme cold. In some cases the mortality rate of piglets is as high as 50% due to extreme or unexpected environmental conditions during transport. Because the transport trailers are so exposed to ambient conditions, typical force air heating or cooling systems used for transporting other goods are not effective at overcoming the ambient conditions, so another solution is needed.

The present disclosure is partly an extension of the systems and methods disclosed in U.S. Pat. No. 11,219,192 to Schinckel et al. Accordingly, the disclosure of U.S. Pat. No. 11,219,192 is incorporated herein by reference in its entirety.

It was realized by the inventors of the current disclosure that problems exist with prior livestock flooring heating and cooling systems and components, including inefficient heat transfer, buildup of livestock excreta, costly system construction, difficult installation and maintenance, and reliability. Certain features of the present disclosure address these and other needs and provide important advantages.

### SUMMARY

Embodiments of the present disclosure provide thermal exchange pads and systems to address stress in livestock exposed to hot or cold environmental conditions in barns or transport trailers environments. An illustrative embodiment of a thermal exchange pad for livestock flooring includes a thermally conductive, heat exchange plate and an insulating base defining excreta debris drains and heat exchange fluid channels, an optional temperature sensor, and an optional access compartment for installation and maintenance. The thermal exchange pad may be position on top of existing floor structure, or optionally may provide the structure required for flooring supporting livestock. An illustrative embodiment of a thermal exchange system for livestock flooring includes a plurality of thermal exchange pads, optional coupling raceways enclosing controller cables and fluid supply and return lines, a controller, a pump, a heat exchange fluid reservoir, a thermal source, and flow control devices.

An illustrative embodiment of a thermal exchange pad for livestock flooring according to the present disclosure, comprises: a base plate that is thermally insulating and defines: a first serpentine channel for receiving a heat exchange fluid therein; and an access compartment at a first end, at least opposite ends of the first serpentine channel defined within the access compartment; and a rigid heat exchange plate that is thermally conductive and spans over and is supported by the base plate, the heat exchange plate defining: a removable access cover portion spanning the access compartment of the base plate; and a main portion spanning the remaining portion of the base plate; and wherein: the first serpentine channel is in direct thermal contact with a bottom surface of the heat exchange plate; and the access cover portion and the main portion of the heat exchange plate form a continuous top surface for supporting livestock.

Additionally or alternatively, wherein the heat exchange plate further defines anti-slip treads protruding from a top surface of the heat exchange plate. Additionally or alternatively, wherein: the base plate defines a first plurality of openings therethrough; the first serpentine channel transits past opposite sides of at least a subset of the first plurality of openings; and the heat exchange plate defines a second plurality of openings therethrough, the second plurality of openings coterminous with the first plurality of openings to provide a plurality of debris drains through the thermal exchange pad. Additionally or alternatively, wherein a bottom surface of the base plate defines recesses that encompass a plurality of the debris drains and form debris channels to enable the flow of debris from debris drains located atop a supporting livestock floor member. Additionally or alternatively, wherein at least a portion of the top surface of the heat exchange plate is sloped downwardly from a center toward at least a pair of opposite sides, thereby facilitating runoff of debris from the top surface. Additionally or alternatively, wherein an edge perimeter of the base plate is angled outwardly from a top edge to a bottom edge. Additionally or alternatively, wherein the first serpentine channel is open to the bottom surface of the heat exchange plate, thereby enabling the heat exchange fluid to directly contact the bottom surface of the heat exchange plate.

Additionally or alternatively, the thermal exchange pad further comprising an intermediate layer located between the heat exchange plate and the base plate. Additionally or alternatively, wherein the intermediate layer includes a fluid seal between the portions of the heat exchange plate and the base plate, including sealing the first serpentine channel. Additionally or alternatively, wherein the intermediate layer is formed to further define the first serpentine channel and carry the heat exchange fluid. Additionally or alternatively, wherein the intermediate layer forms a first recessed channel coterminous with the first serpentine channel and the heat exchange fluid contained within the first recessed channel between the intermediate layer and the bottom surface of the heat exchange plate. Additionally or alternatively, wherein the intermediate layer spans entirely over at least the main portion of the heat exchange plate.

Additionally or alternatively, the thermal exchange pad, further comprising at least one conduit positioned within the first serpentine channel, the heat exchange fluid contained within the at least one conduit and the at least one conduit in direct thermal contact with the bottom surface of the heat exchange plate. Additionally or alternatively, wherein a lateral cross-section of the at least one conduit defines a largest width that is greater than a largest height. Additionally or alternatively, wherein a lateral cross-section of the first serpentine channel defines a largest width that is greater than a largest height. Additionally or alternatively, wherein the access compartment further defines a fluid supply manifold fluidly coupled to the first serpentine channel and including fluid supply connections at opposite sides of the base plate and a fluid discharge connection on at least one side of the base plate. Additionally or alternatively, wherein the base plate defines a receptacle for a temperature sensor, the receptacle adapted to position the temperature sensor in contact with a bottom surface of the heat exchange plate. Additionally or alternatively, wherein the base plate is configured to rest upon an existing livestock flooring in a barn. Additionally or alternatively, wherein the thermal exchange pads is configured to couple with existing livestock flooring of a livestock transport trailer. Additionally or alternatively, wherein the top surface of the heat exchange plate is thermally coupled with the bottom surface of the existing livestock flooring. Additionally or alternatively, wherein the thermal exchange pad is configured to provide structural support to function as the livestock flooring in a barn or in a livestock transport trailer. Additionally or alternatively, wherein the base plate is formed as a unitary structure.

Additionally or alternatively, the thermal exchange pad, further comprising heat exchange fluid supply and return connections located at one of an end or a side of the thermal exchange pad. Additionally or alternatively, wherein the temperature sensor includes a thermally conductive protective sheath encapsulating a sensor portion of the temperature sensor, the thermally conductive protective sheath in thermal contact with a bottom side of the heat exchange plate. Additionally or alternatively, wherein the sensor portion of the temperature sensor includes a plurality of individual sensors each in thermal contact with the thermally conductive protective sheath and mounted on a circuit board. Additionally or alternatively, wherein the receptacle for the temperature sensor and the temperature sensor are configured for removal and reinsertion of the temperature sensor with only the access cover portion of the heat exchange plate removed from the base plate.

Additionally or alternatively, wherein the access cover portion and the access compartment form a watertight seal that prevents liquid intrusion into the access compartment. Additionally or alternatively, wherein a slope of the top surface of the heat exchange plate is directed toward at least one of the plurality of debris drains. Additionally or alternatively, wherein a supply end of the first serpentine channel coupled to the fluid supply manifold transits along the remaining portion of the base adjacent a midpoint between the opposite sides of the base and a fluid discharge end of the first serpentine channel is located adjacent one of the opposite sides. Additionally or alternatively, wherein the base plate further defines a second serpentine channel fluidly coupled to the fluid supply manifold and fluidly in parallel with the first serpentine channel. Additionally or alternatively, wherein a heat transfer array is thermally coupled to a bottom surface of the heat exchange plate and extends downward into the first serpentine channel, thereby increasing heat exchange between the heat exchange plate and the heat exchange fluid.

Additionally or alternatively, the thermal exchange pad, further comprising a gasket between the heat exchange plate and the base to fluidly seal the first serpentine channel. the thermal exchange pad, wherein a top surface of the base further defines compression stops to prevent over-compression of the gasket.

Additionally or alternatively, the thermal exchange pad, further comprising an intermediate layer formed from a sheet of uniform thickness and spanning at least the remaining portion of the base, the intermediate layer defining: a first recessed channel coterminous with the first serpentine channel; and a third plurality of openings therethrough, the third plurality of openings coterminous with the first and second pluralities of openings to provide a plurality of debris drains through the thermal exchange pad; and wherein the intermediate layer is bonded to the bottom surface of the heat exchange plate to fluidly contain the heat exchange fluid between a bottom surface of the heat exchange plate and a top surface of the intermediate layer within the first serpentine channel. Additionally or alternatively, wherein: the heat exchange plate includes two sheets, a top layer comprising a thicker sheet and a bottom layer comprising a thinner sheet; the bottom layer is welded, brazed, or soldered to the intermediate layer; and the bottom layer defines a third plurality of openings conterminous with the first and second plurality of openings; and the top layer is bonded to the bottom layer.

Additionally or alternatively, wherein the intermediate layer is bonded to the bottom surface of the heat exchange plate using a filler alloy. Additionally or alternatively, wherein: a first recessed channel of the intermediate layer and an overlying portion of the bottom surface of the heat exchange plate defines a fluid supply manifold fluidly coupled to the first serpentine channel and including fluid supply connections at a opposite sides of the base; and the fluid supply manifold is received within the access compartment of the base. Additionally or alternatively, wherein the intermediate layer further defines a plurality of supports having upper surfaces bonded with the bottom surface of the heat exchange plate.

Additionally or alternatively, the thermal exchange pad, further comprising insulation located between the intermediate layer and the base and within the first serpentine channel. Additionally or alternatively, the thermal exchange pad further comprising a thermally conductive tube positioned within the first serpentine channel and in contact with a bottom surface of the heat exchange plate, the thermally conductive tube for transporting the heat exchange fluid through the thermal exchange pad. Additionally or alternatively, wherein the thermally conductive tube includes planar extensions along opposite sides adjacent a top, the planar extensions in contact with the bottom surface of the heat exchange plate. Additionally or alternatively, further comprising a thermal paste layer between the conduit and the bottom surface of the heat exchange plate. Additionally or alternatively, wherein the bottom surface of the base plate defines areas of differing heights to accommodate elevated areas of livestock flooring.

An illustrative embodiment of a thermal exchange system for livestock flooring, according to the present disclosure comprises: a first plurality of thermal exchange pads each including: a base plate that is thermally insulating and defines a first heat exchange fluid channel; a heat exchange plate that is thermally conductive and spans over and is supported by the base plate and is in direct thermal contact with the first heat exchange fluid channel; and a thermal fluid system, including: a heat exchange fluid reservoir; a thermal source supplying temperature regulated heat exchange fluid to the heat exchange reservoir; pad supply line supplying heat exchange fluid from the reservoir to the heat exchange fluid channels of the first plurality of thermal exchange pads; pad return line for returning heat exchange fluid from the heat exchange fluid channels to the heat exchange fluid reservoir; a supply pump for pumping the heat exchange fluid between the reservoir and the heat exchange channels; and a recirculation valve for selectively directing heat exchange fluid in the return line to the reservoir and to the pad supply line; and a controller; a reservoir temperature sensor to enable the controller to control the thermal source to maintain the heat exchange fluid in the reservoir at a preset reservoir temperature; and a first return line temperature sensor to measure the temperature of the heat exchange fluid exiting the heat exchange fluid channels of the first plurality of thermal exchange pads; and wherein the controller is configured to selectively switch the recirculation valve at a preset temperature of the heat exchange fluid measured by the first return line temperature sensor.

Additionally or alternatively, the thermal exchange system, further comprising an ambient temperature sensor; and wherein the controller is configured to activate the thermal fluid system above or below a preset ambient temperature.

Additionally or alternatively, wherein: each base plate defines an access compartment at a first end, at least opposite ends of the first heat exchange fluid channel defined within the access compartment; and each heat exchange plate defines an access cover portion spanning the access compartment of the base plate and a main portion spanning the remaining portion of the base plate; and the thermal exchange system further comprising a plurality of protective raceways bridging adjacent ones of the first plurality of thermal exchange pads, each of the plurality of raceways including: at least one fluid connector for coupling the heat exchange fluid between adjacent ones of the first plurality of thermal exchange pads; a body overlying the at least one fluid connector; a first end of the body received within the access compartment of a first one of the adjacent ones of the first plurality of thermal exchange pads; a second end of the body received within the access compartment of a second one of the adjacent ones of the first plurality of thermal exchange pads; and a central portion of the body located between the first one and the second one of the adjacent ones of the first plurality of thermal exchange pads.

Additionally or alternatively, wherein the body of each of the plurality of raceways is free to move laterally in the space between adjacent ones of the first plurality of thermal exchange pads and is retained within the space between adjacent ones of the first plurality of thermal exchange pads by the first and second ends received within the access compartments of adjacent ones of the first plurality of thermal exchange pads.

Additionally or alternatively, the thermal exchange system, further comprising: a second plurality of thermal exchange pads; a second return line temperature sensor; a first flow control device controlled by the controller for selectively supplying the flow of heat exchange fluid to the first plurality of thermal exchange pads; a second flow control device controlled by the controller for selectively supplying the flow of heat exchange fluid to the second plurality of thermal exchange pads; and, wherein the controller is further configured to control the first and second flow control devices to maintain the heat exchange fluid exiting the heat exchange fluid channels of the first plurality of thermal exchange pads to a preset temperature based in part on a signal from the first return line temperature sensor and to maintain the heat exchange fluid exiting the heat exchange fluid channels of the second plurality of thermal exchange pads to a preset temperature based on a signal from the second return line temperature sensor.

Additionally or alternatively, the thermal exchange system, further comprising a first supply line temperature sensor, and wherein the controller is configured to control the fluid system to maintain the heat exchange fluid entering the heat exchange fluid channels of the first plurality of thermal exchange pads to a preset temperature.

Additionally or alternatively, the thermal exchange system, further comprising a pad temperature sensor thermally coupled to a bottom surface of at least one of the first plurality of thermal exchange pads, and wherein the controller is configured to control the fluid system to maintain the at least one of the first plurality of thermal exchange pads to a preset temperature. Additionally or alternatively, wherein the controller controls the supply pump and recirculation valve for continuous flow circulation of the heat exchange fluid through the first heat exchange fluid channel of the first plurality of thermal exchange pads. Additionally or alternatively, wherein the controller controls an average rate of flow of the heat exchange fluid by modulating the instantaneous rate of flow of the heat exchange fluid. Additionally or alternatively, wherein the controller controls an average rate of flow of the heat exchange fluid by modulating the proportion of time periods for which the flow is on and the flow is off.

Additionally or alternatively, wherein the thermal source is at least one of a chiller and heater. Additionally or alternatively, wherein the thermal source is a geothermal system. Additionally or alternatively, wherein: the thermal source is a fresh water supply; the heat exchange fluid is water; and the controller is configured to discharge a portion of the return line heat exchange fluid based on at least one of a temperature signal from the reservoir temperature sensor and a temperature signal from the first return line temperature sensor. Additionally or alternatively, wherein the thermal fluid system further includes a flow rate sense and a fluid reservoir level sensor in communication with the controller.

Additionally or alternatively, wherein the thermal exchange system is adapted for installation on a livestock transport trailer. Additionally or alternatively, wherein the thermal source, the heat exchange fluid reservoir, and the controller are coupled to an outside surface of the livestock transport trailer. Additionally or alternatively, wherein the base plates of the first plurality of thermal exchange pads are configured to rest upon an existing livestock flooring in a barn. Additionally or alternatively, wherein the first plurality of thermal exchange pads are configured to couple with existing livestock flooring of the livestock transport trailer. Additionally or alternatively, wherein a top surfaces of the heat exchange plate of the first plurality of thermal exchange pads are thermally coupled with the bottom surface of the existing livestock flooring. Additionally or alternatively, wherein the first plurality of thermal exchange pads are configured to provide structural support to function as the livestock flooring in a barn or in a livestock transport trailer.

Additionally or alternatively, wherein the plurality of raceways are selected from a group comprising varying lengths of the body. Additionally or alternatively, wherein the body and the access compartment are configured to provide a selectable length of the first end the body received within the access compartment upon installation. Additionally or alternatively, wherein the central portion of the body defines fillets between a top and each opposite side.

This summary is provided to introduce a selection of the concepts that are described in further detail in the detailed description and drawings contained herein. This summary is not intended to identify any primary or essential features of the subject matter. Some or all of the described features may be present in the corresponding independent or dependent claims, but should not be construed to be a limitation unless expressly recited in a particular claim. Each embodiment described herein does not necessarily address every object described herein, and each embodiment does not necessarily include each feature described. Other forms, embodiments, objects, advantages, benefits, features, and aspects of the present disclosure will become apparent to one of skill in the art from the detailed description and drawings contained herein. Moreover, the various apparatuses and methods described in this summary section, as well as elsewhere in this application, can be expressed as a large number of different combinations and subcombinations. All such useful, novel, and inventive combinations and subcombinations are contemplated herein, it being recognized that the explicit expression of each of these combinations is unnecessary.

### BRIEF DESCRIPTION OF THE DRAWINGS

Some of the figures shown herein may include dimensions or may have been created from scaled drawings. However, such dimensions, or the relative scaling within a figure, are by way of example, and not to be construed as limiting.

FIG. 1 illustrates a prior art livestock crate and livestock flooring system with an illustrative embodiment of a thermal exchange system installed, including a thermal exchange pad upon existing livestock grate flooring;

FIG. 2 illustrates the prior art livestock crate and livestock flooring system of FIG. 1 without the illustrative embodiment installed;

FIG. 3 illustrates a prior art row of livestock pens and livestock flooring system with an illustrative embodiment of a thermal exchange system installed;

FIG. 4 illustrates the prior art row of livestock pens and livestock flooring system of FIG. 1, without the illustrative embodiment installed;

FIG. 5 illustrates is an exemplary embodiment of the thermal exchange pad of FIG. 1;

FIG. 6 illustrates the embodiment of the thermal exchange pad of FIG. 5 shown with the access cover portion of the heat exchange plate removed;

FIG. 7 illustrates an embodiment of the thermal exchange pad of FIG. 5 shown with the heat exchange plate removed;

FIG. 8 illustrates the thermal exchange portion of an illustrative embodiment of a thermal exchange pad, including fluid channels and manifolds;

FIG. 9 is a cross-sectional view of another embodiment of a thermal exchange pad according to the present disclosure;

FIG. 10 illustrates a first exemplary embodiment of a raceway coupling two adjacent thermal exchange pads;

FIG. 11 illustrates a first exemplary raceway coupling in two adjacent thermal exchange pads of FIG. 10 with the access cover portion of the heat exchange plates removed;

FIG. 12 illustrates an assembled bottom view of an embodiment of a thermal exchange pad of FIG. 5 with a first drainage pattern;

FIG. 13 illustrates an assembled bottom view of an embodiment of a thermal exchange pad of FIG. 5 with a second drainage pattern;

FIG. 14 illustrates the prior art livestock crate and livestock flooring system of FIG. 15 without the illustrative embodiment installed;

FIG. 15 illustrates a prior art livestock crate and livestock flooring system with an illustrative embodiment of a thermal exchange system installed, including a thermal exchange pad serving as the livestock flooring within the prior art livestock crate;

FIG. 16 illustrates a schematic diagram of the fluid system and control system of the thermal exchange system of FIG. 3;

FIG. 17 illustrates an exploded view of an illustrative embodiment of a thermal exchange pad according to the present disclosure;

FIG. 18 illustrates a cross-sectional assembled view of the embodiment of the thermal exchange pad of FIG. 17;

FIG. 19 illustrates a cross-sectional assembled view of another illustrative embodiment of a thermal exchange pad according to the present disclosure;

FIG. 20 illustrates an assembled bottom view of the embodiment of a thermal exchange pad of FIG. 17;

FIG. 21 illustrates a partially exploded assembly view of an illustrative temperature sensor assembly according to the present disclosure;

FIG. 22 illustrates the illustrative temperature sensor assembly of FIG. 21 in the process of being installed with a heat transfer pad according to the present disclosure;

FIGS. 23-25 illustrate an exemplary assembly of the temperature sensor assembly of FIG. 21 with the heat transfer pad;

FIGS. 26 and 27 illustrate another embodiment of a thermal exchange pad having a sloped surface according to the present disclosure;

FIG. 28 illustrates a cross-sectional view of another embodiment of a thermal exchange pad according to the present disclosure;

FIG. 29 illustrates a cross-sectional view of another embodiment of a thermal exchange pad according to the present disclosure;

FIG. 30 illustrates an exploded view of the embodiment of the thermal exchange pad of FIG. 29;

FIG. 31 illustrates a top view of the embodiment of the thermal exchange pad of FIG. 29;

FIG. 32 illustrates an exemplary conduit of the thermal exchange pad of FIG. 29;

FIGS. 33-35 illustrate exemplary conduit fittings of the thermal exchange pad of FIG. 29;

FIG. 36 illustrates an exploded view of an illustrative embodiment of a thermal exchange pad according to the present disclosure;

FIG. 37 illustrates a top view of the embodiment of the thermal exchange pad with the heat exchange plate removed;

FIG. 38 is an enlarged view of a portion of FIG. 37 labelled 38;

FIG. 39 illustrates and exploded view of another illustrative embodiment of a thermal exchange pad according to the present disclosure;

FIG. 40 illustrates a top view of another illustrative embodiment of a thermal exchange pad according to the present disclosure;

FIG. 41 illustrates a partially exploded view of the thermal exchange pad of FIG. 40;

FIG. 42 illustrates a top perspective view of the base portion of another embodiment of a thermal exchange pad according to the present disclosure;

FIG. 43 illustrates an exploded view of another illustrative embodiment of a thermal exchange pad according to the present disclosure;

FIG. 44 illustrates a gasket and base portion of the thermal exchange pad of FIG. 43;

FIGS. 45 illustrates the base portion of the thermal exchange pad of FIG. 44;

FIG. 46 illustrates the heat exchange fluid flow path through channels of the thermal exchange pad of FIGS. 43-44;

FIG. 47 illustrates a livestock transport trailer having an illustrative embodiment of thermal exchange system of FIG. 16;

FIG. 48 illustrates a semitransparent view of the livestock transport trailer and thermal exchange system of FIG. 47;

FIG. 49 illustrates portions of the thermal exchange system adapted for installation in a livestock transport trailer;

FIG. 50 illustrates an embodiment of the thermal exchange pads adapted for installation with existing flooring in a livestock transport trailer;

FIG. 51 illustrates an embodiment of the thermal exchange pads adapted for installation as the flooring in a livestock transport trailer; and

FIG. 52 illustrates and exploded view of the thermal exchange pads adapted for installation in a livestock transport trailer.

### DETAILED DESCRIPTION OF THE ILLUSTRATED EMBODIMENTS

For the purposes of promoting an understanding of the principles of the disclosure, reference will now be made to one or more embodiments, which may or may not be illustrated in the drawings, and specific language will be used to describe the same. It will nevertheless be understood that no limitation of the scope of the disclosure is thereby intended; any alterations and further modifications of the described or illustrated embodiments, and any further applications of the principles of the disclosure as illustrated herein are contemplated as would normally occur to one skilled in the art to which the disclosure relates. At least one embodiment of the disclosure is shown in great detail, although it will be apparent to those skilled in the relevant art that some features or some combinations of features may not be shown for the sake of clarity.

Any reference to “invention” within this document is a reference to an embodiment of a family of inventions, with no single embodiment including features that are necessarily included in all embodiments, unless otherwise stated. Furthermore, although there may be references to benefits or advantages provided by some embodiments, other embodiments may not include those same benefits or advantages, or may include different benefits or advantages. Any benefits or advantages described herein are not to be construed as limiting to any of the claims.

This disclosure provides systems and components capable of heating or cooling an animal, for example, a sow within a swine farrowing barn that is maintained at an ambient environmental temperature that is higher than what is desired for optimal performance of the sow. As an example, farrowing rooms for swine farrowing operations are often maintained at ambient temperatures of about 25° C. for nine months of the year, and they can often be warmer during summer months. Since milk production, daily feed intake performance, and expression of estrus after weaning have all been linked to the reaction of the animal to the ambient environmental temperature, agricultural production can be improved by regulating the animal's body temperature to promote its reproductive performance. In addition to potential improvements to production, regulation of the animal's body temperature relative to the ambient environmental temperature may significantly improve the welfare and well-being of the animal. As such, the systems and components disclosed herein provide reliable, economical active cooling and waste buildup reduction for an adult animal. Although the invention will be described herein with specific references to cooling a sow in a farrowing crate and to cooling boars in pens in a barn, it is foreseeable and within the scope of the invention that the illustrative embodiments and variations thereof may be applicable to heating or cooling other livestock environments and to other animals.

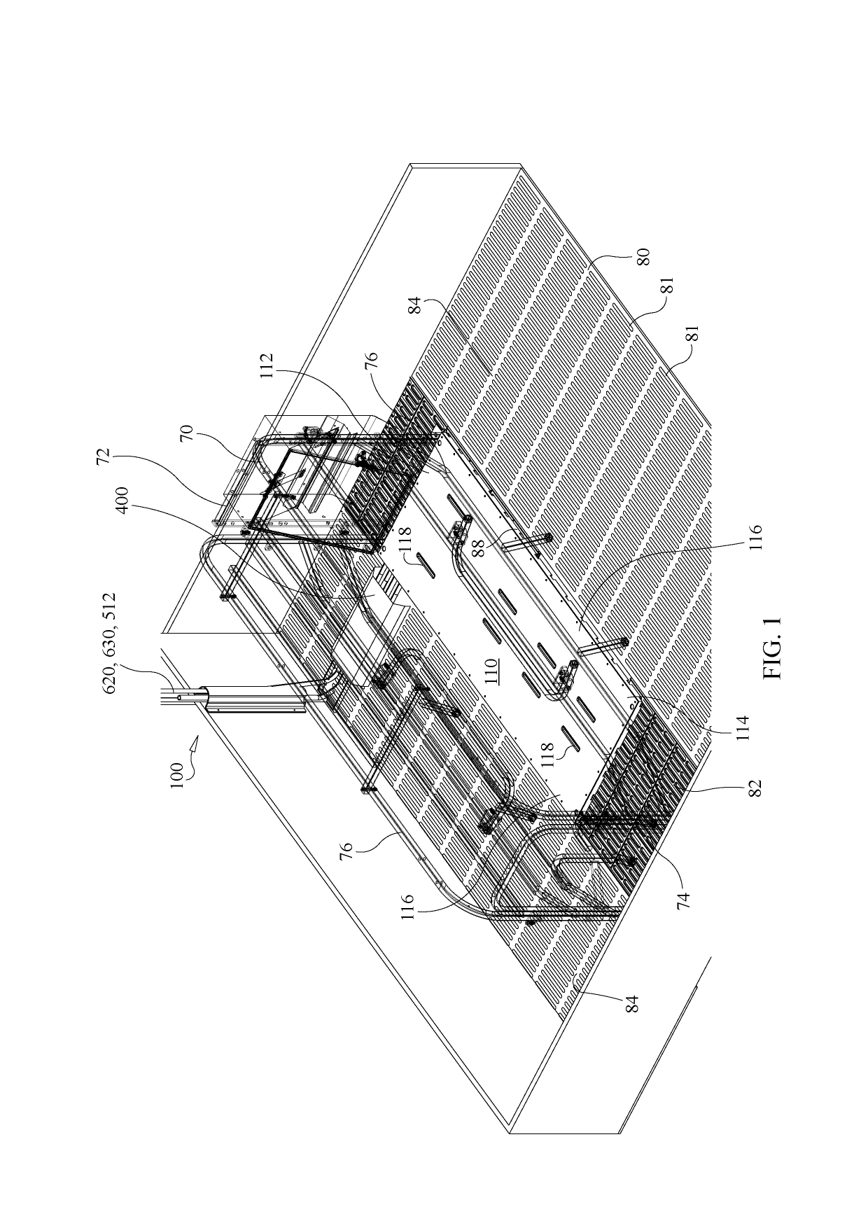

Referring to FIG. 1, a prior art farrowing crate 70 and livestock flooring system 80 is shown with an illustrative embodiment of a thermal exchange system 100 according to the present disclosure installed. Such farrowing crates 70 are used to contain a sow that is nursing piglets, and is particularly helpful in limiting the range of movement of the sow to providing nursing for the piglets, well-being for the sow, and to limit the risk of accidental crushing of piglets. The thermal exchange system 100 components illustrated in FIG. 1 include an illustrative embodiment of a thermal exchange pad 110, fluid supply line 620 and fluid return line 630, controller cable 512, and raceway 400 used to cover or enclose and protect from the livestock the controller cable and supply and return lines.

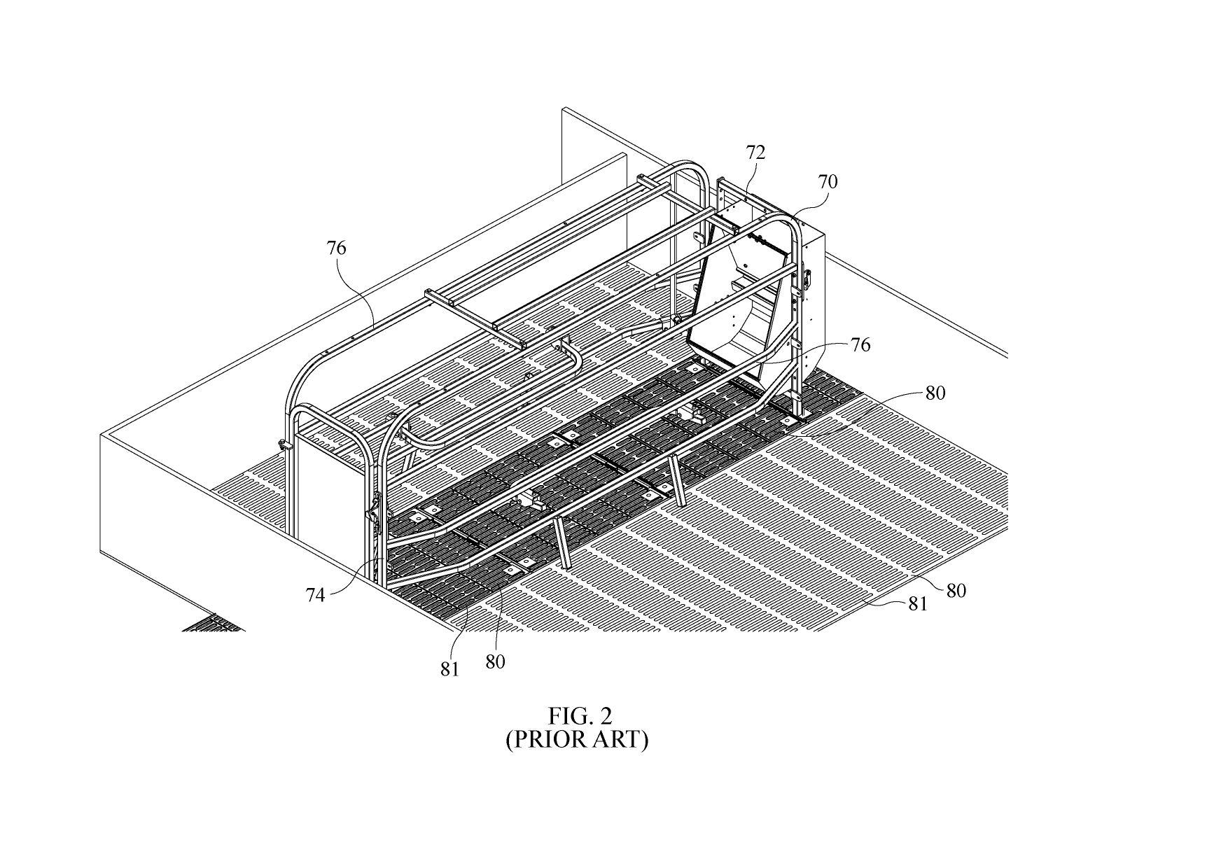

As will be discussed further below, the supply line 620 and return line 630 provide selective flow of a heat exchange fluid 612, for example chilled or heated water, through the thermal exchange pad 110 in order to provide a desired temperature for the pad, thereby alleviating stress from heat or cold for the livestock. Other components of the thermal exchange system 100 not shown in FIG. 1 will be introduced further below. To better illustrate the environment in which the thermal exchange system 100 is installed, FIG. 2 illustrates the prior art farrowing crate 70 without the thermal exchange system 100 installed. For example, typically the grated livestock flooring 80 within the farrowing crate 70 will be cast iron, steel, or similar structure to support the weight of an adult sow. In contrast, the grated livestock flooring 80 to each side of the farrowing crate, which only need to support the weight of piglets, may be fiberglass or another material other materials providing sufficient strength to support the weight of piglets, and corrosion resistance.

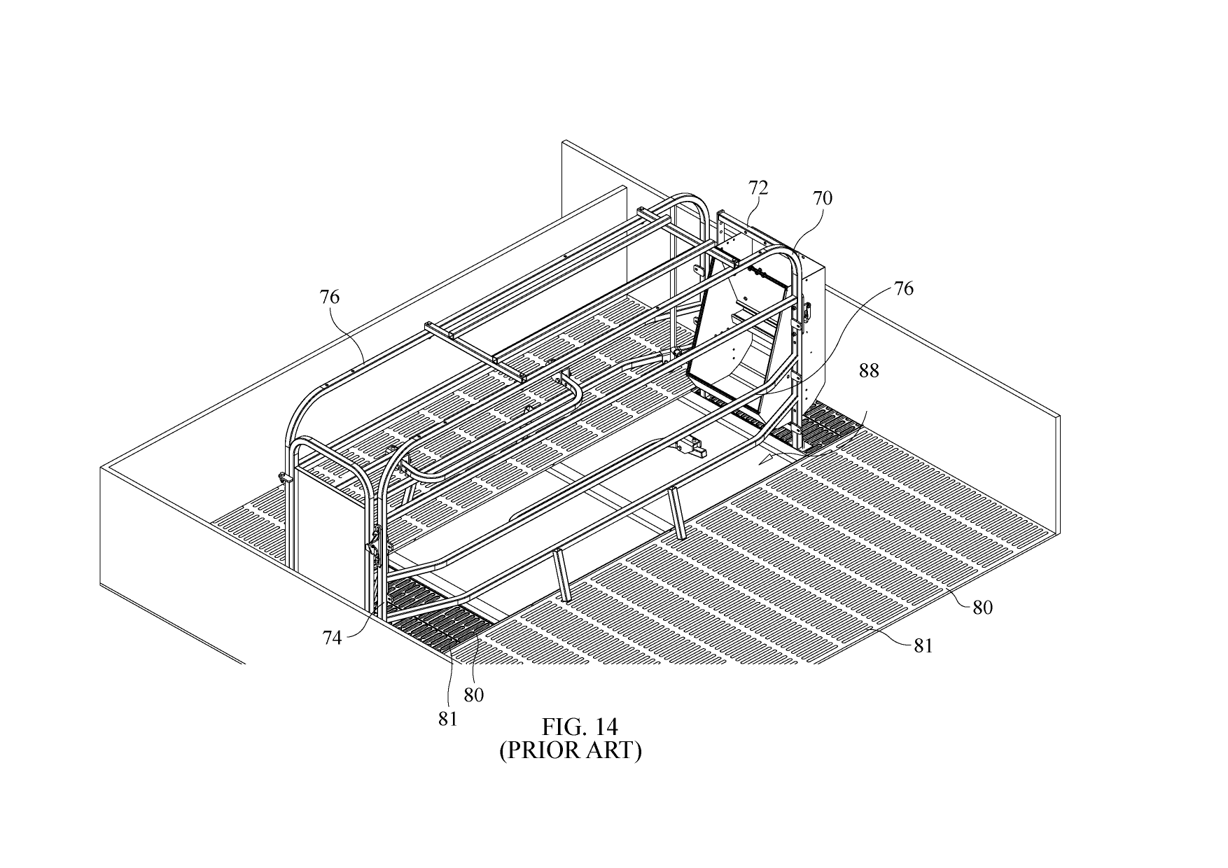

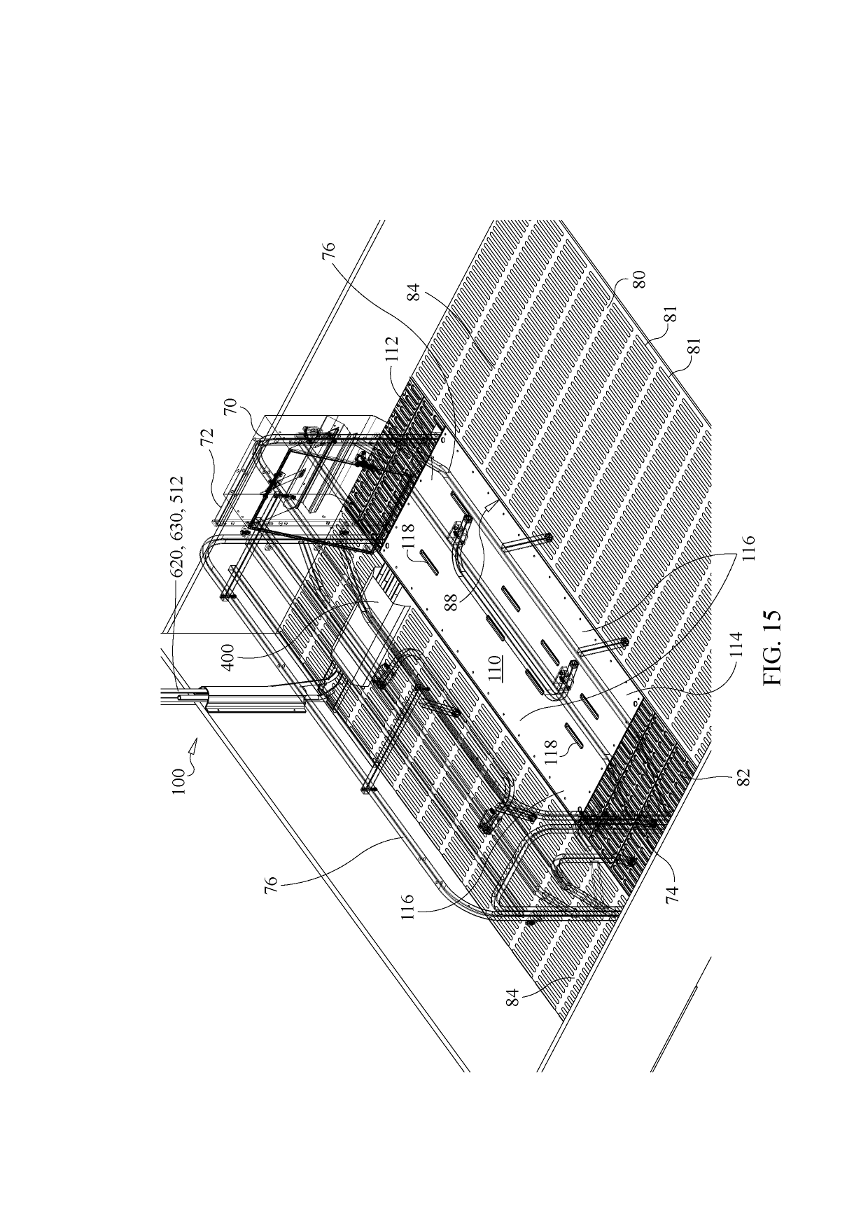

The thermal exchange pad 110 can be supported and rest on top of the livestock flooring 80. In alternative embodiments, the thermal exchange pad 110 is supported directly on a flooring superstructure 85, for example extending across an excreta pit 88 located below the livestock flooring 80, for example as shown in FIGS. 14 and 15. Advantageously, the thermal exchange pad 110 can includes debris drains 118 defined therethrough, which prevent buildup of livestock excreta by allowing it to flow and/or be flushed through drains 82 of livestock flooring 80 and into the pit 88. Maintaining the thermal exchange pad 110 free from buildup of excreta is important to minimizing the risk of bacterial inventions and other potential wellness issues for the livestock, therefore the debris drains 118 perform an advantageous function.

This illustrated embodiment of the thermal exchange pad 110 is sized to fit within the farrowing crate 70 and is further sized and positioned to ensure that at least the sow’s head, neck, shoulder, and the area of the sow’s udders will contact and be supported by the thermal exchange pad when lying down. As noted from the illustration of FIG. 1, the thermal exchange pad 110 is positioned with a first end 112 located adjacent a head end 72 of the farrowing crate 70. A second end 114 of the thermal exchange pad 110 stops short of a tail end 74 of the farrowing crate 70, leaving an open area 82 of livestock flooring 80. The sides 116 of the thermal exchange pad 110 extend to a location adjacent each side 76 of the farrowing crate 70. Side areas 84 of the livestock flooring 80 are open for movement of the nursing piglets, and for side access to the nursing sow. Additionally, open area 82 of the livestock flooring generally extends both inside and outside the tail end 74 of the farrowing crate 70 so that the nursing piglets have access to both sides of the nursing soul.

The illustrated embodiment of the thermal exchange pad 110 sized for farrowing crate 70 spans up to 24 inches (61 cm) in width and 48 to 60 inches (122 to 152 cm) in length. Other sizes of thermal exchange pad 110 are also applicable to the embodiments disclosed herein, both for this illustrative application, as well as for other applications and for other types of livestock.

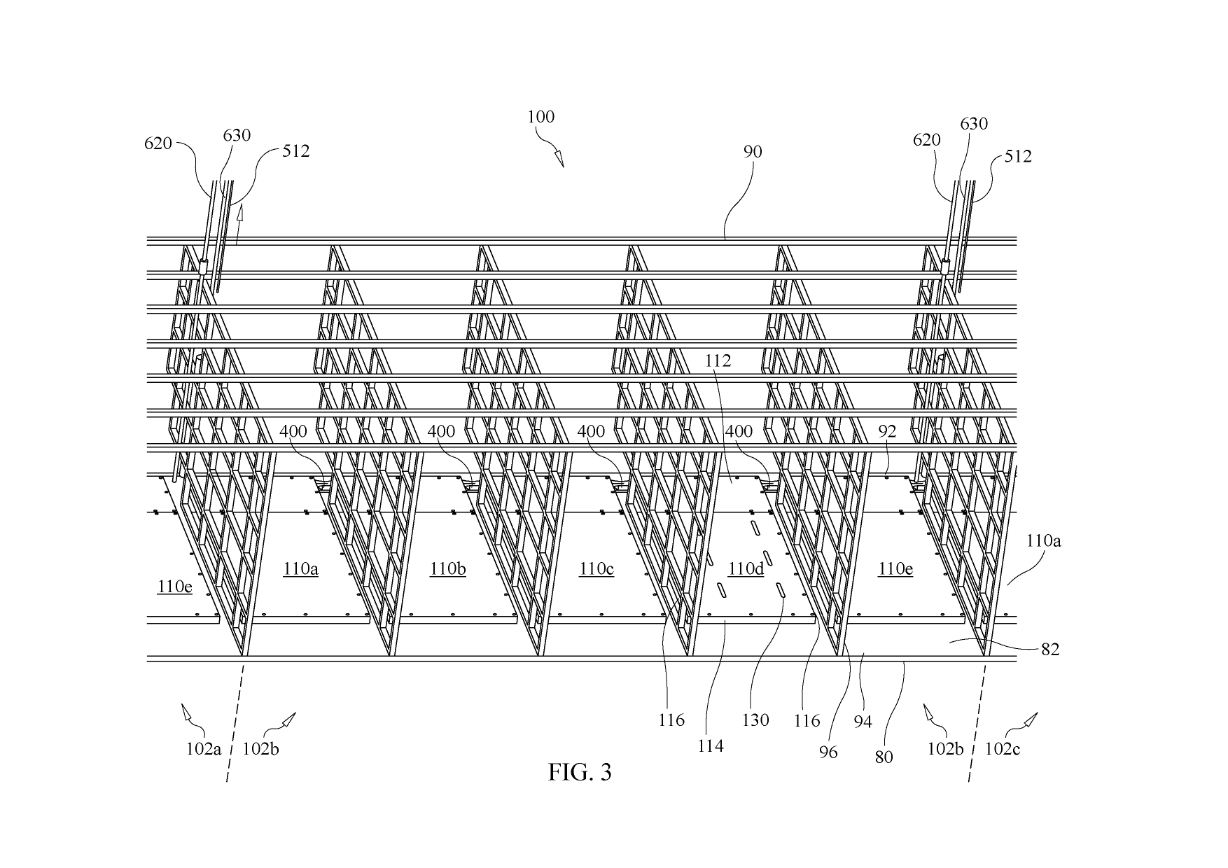

Referring to FIG. 3, a prior art row of boar hog pens 90 and livestock flooring system 80 is shown with a second illustrative embodiment of the thermal exchange system 100 according to the present disclosure installed therewith. In this example, the prior art row of pens 90 are sized to comfortably hold each boar in one orientation, for example, for semen collection. The thermal exchange system 100 components illustrated in FIG. 3 include three zones 102a-c, with each zone having a set of an illustrative embodiment of thermal exchange pads 110a-e (individually and collectively referred to as “110”), a heat exchange fluid supply line 620 and return line 630, a controller cable 512, and raceways 400 used to cover or to enclose and protect from the livestock the controller cable and the supply and return lines. The controller cable 512, supply line 620, and return line 630 protected by raceway 400 between each adjacent thermal exchange pad 110 within a zone 102 couple the zone’s thermal exchange pad 110 electrically and fluidly, for example, in a parallel or in a series fluid connection.

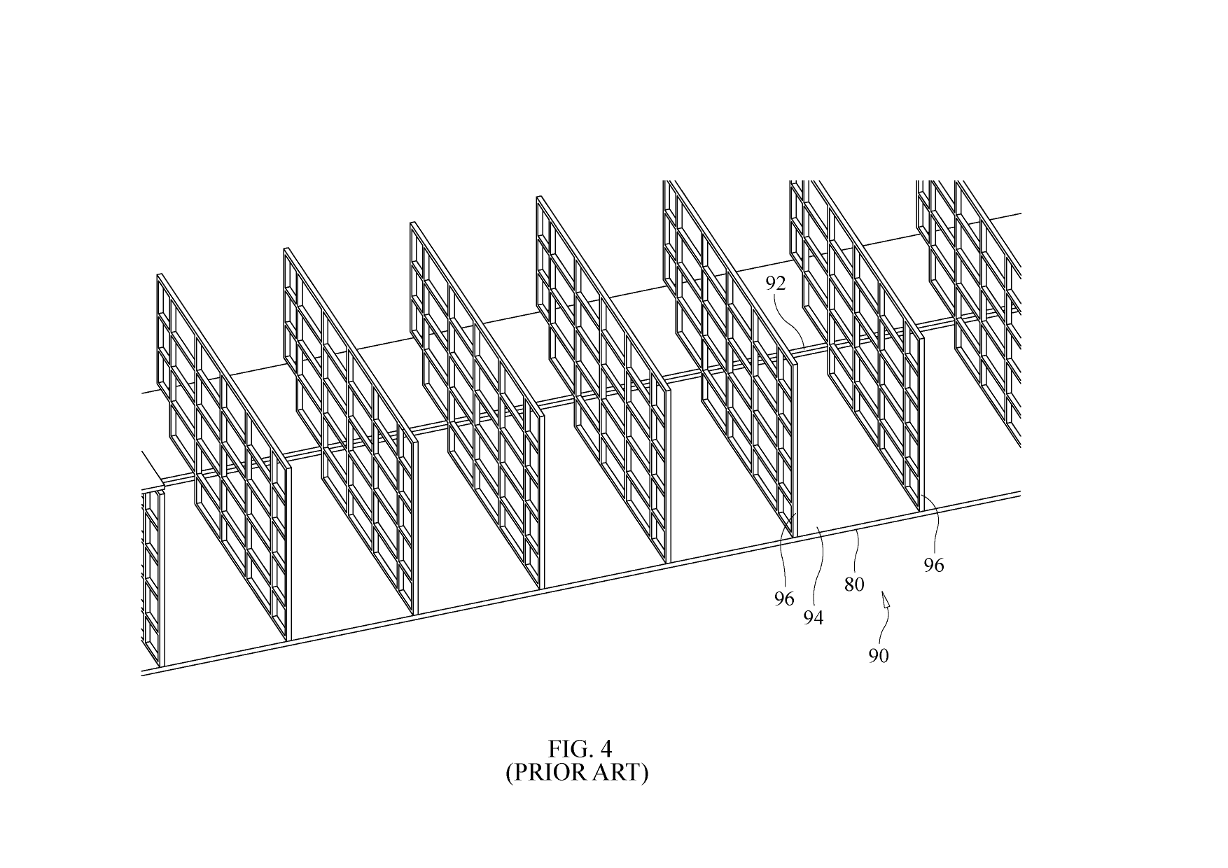

A central zone 102b is illustrated as including five boar pens 90 and thus includes five thermal exchange pads 110; however, additional or fewer pens and thermal exchange pads may be included in this zone as well as for adjacent zones 102a and 102c. As will be discussed further below, grouping pens and the thermal exchange pads 110 into zones 102a-c reduces the number of components of thermal exchange system 100 that are required, and also allows individual zones to be activate or inactive depending on occupancy. Other components of the thermal exchange system 100 not shown in FIG. 3 will be introduced further below. To better illustrate the environment in which the thermal exchange system 100 is installed, FIG. 4 illustrates the prior art row of boar pens 90 without the thermal exchange system 100 installed.

The thermal exchange pads 110 can be supported and rest on top of the livestock flooring 80. In alternative embodiments, the thermal exchange pad 110 are supported directly on a flooring superstructure 85, for example extending across an excreta pit 88 and replacing the livestock flooring 80 for the floor area in which the thermal exchange pad is located. Advantageously, the thermal exchange pads 110 includes debris drains 118 defined therethrough, which prevent buildup of livestock excreta by allowing it to flow and/or be flushed through drains 82 (not shown) of livestock flooring 80 and into the pit 88 (not shown).

This illustrated embodiment of the thermal exchange pad 110 is sized to fit within an individual boar pen 90 and is further sized and positioned to ensure that at least the boar’s head, neck, shoulder, and central trunk area will contact and be supported by the thermal exchange pad when lying down. As noted from the illustration of FIG. 3, the thermal exchange pads 110 are each positioned with a first end 112 located adjacent a head end 92 of the boar pen 90. A second end 114 of the thermal exchange pad 110 adjacent a tail end 94 of the boar pen 90 may leave no open area 82 or leave a smaller open area 82 of livestock flooring 80 as compared to that for farrowing crate 70 shown in FIG. 1 as there are no nursing piglets as with a farrowing crate 70 to provide a chase and nursing area for and temperature control of the boar’s body is important for quality semen collection. The sides 116 of the thermal exchange pads 110 extend to a location adjacent each side 96 of the boar pens 90.

The illustrated embodiment of the thermal exchange pads 110 sized for boar pens 90 spans up to 24 inches (61 cm) in width and 36 to 54 inches (91 to 137 cm) in length. Other sizes of thermal exchange pads 110 are also applicable to the embodiments disclosed herein, both for this illustrative application, as well as for other applications and for other types of livestock. For example, for larger boars and/or pens, an illustrative thermal exchange pad 110 may be up to 48 inches (122 cm) wide and 72 inches (183 cm) long.

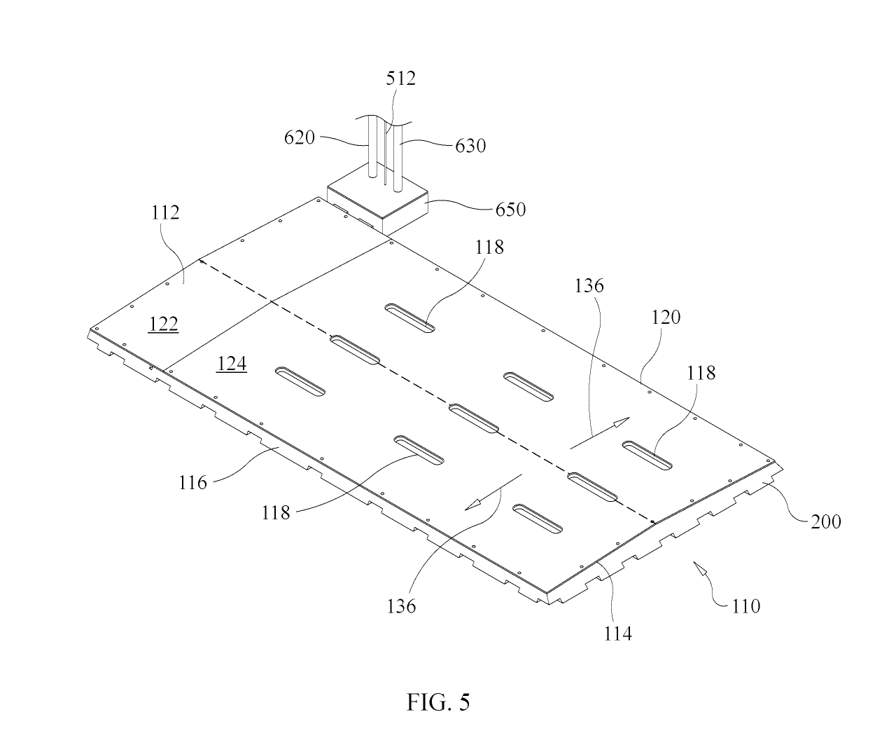

Referring to FIG. 5, an illustrative embodiment of a thermal exchange pad 110 according to the present disclosure is shown. The thermal exchange pad 110 includes a thermally conductive heat exchange plate 120 spanning and mounted upon a thermally insulating base 200. In the illustrative embodiment the heat exchange plate is optionally rigid. A series of debris drains 118 are defined through the thermal exchange pad 110 to facilitate the discharge of excreta, preventing buildup and residue, and to also promote better drainage during washing operations. Additionally, the ends 112, 114 and sides 116 of the thermal exchange pad 110 are sloped outwardly to minimize corners and/or edges that may injure livestock or provide a leverage point.

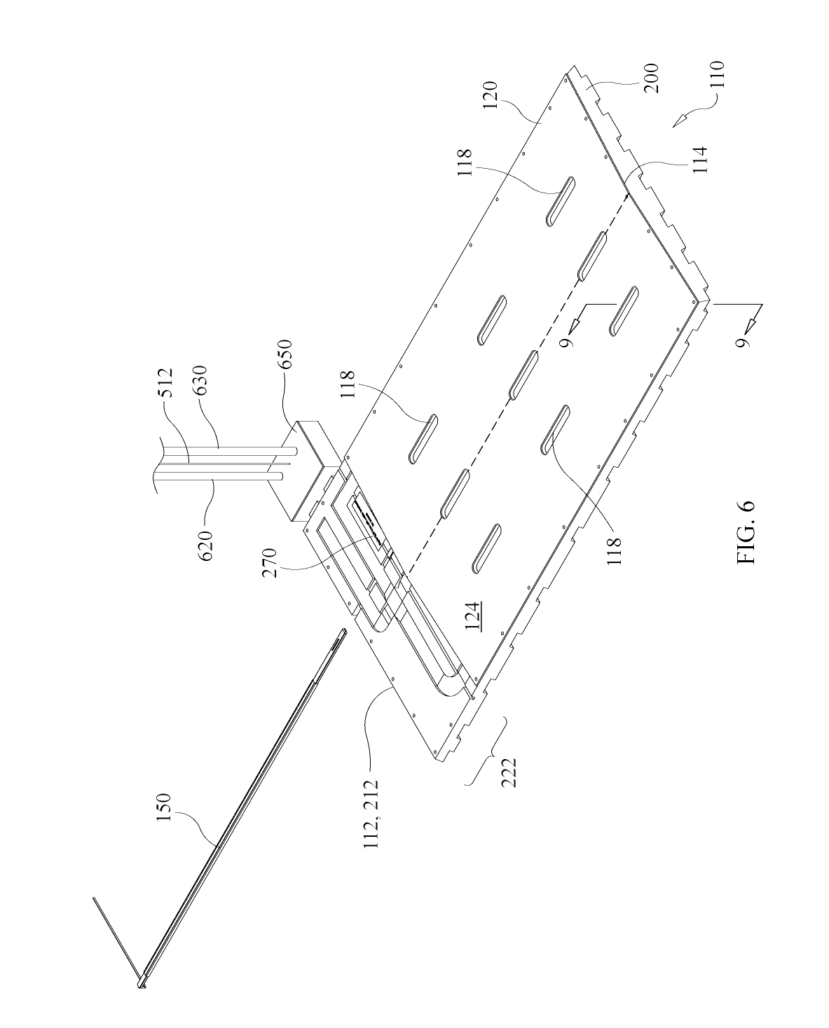

Optionally, thermal exchange pad 110 can include a sloped surface downward toward the sides 116 according to the present disclosure as illustrated in FIGS. 5 and 6. Additionally, the treads 134 of the heat exchange plate 120 can be arranged to facilitate guiding excreta along the downward slope 136 and toward either one or more debris drains 118 or to one or more sides 116 or ends 112 or 114. The sloped surface can be formed by the heat exchange plate 120 being formed with one or more bends, for example, a central longitudinal bend, or by two halves forming each contrasting slope of the heat exchange plate. The base 200 can be formed to match the slope of the heat exchange plate 120.

Referring now to FIG. 6, an access compartment 222 is defined by the base 200 along a first end 212. As can be understood by comparing FIGS. 5 and 6, the heat exchange plate 120 can be divided between a main portion 124 and an access cover portion 122 to facilitate accessing an access compartment 222 without having to unfasten and remove the entire heat exchange plate 120. The access compartment 222 houses and provides access to various components for supplying and returning heat exchange fluid 612 which provides the heating or cooling of the thermal exchange pad 110, and provides access for insertion or removal of one or more temperature sensors 150, shown in an uninstalled position in FIG. 6.

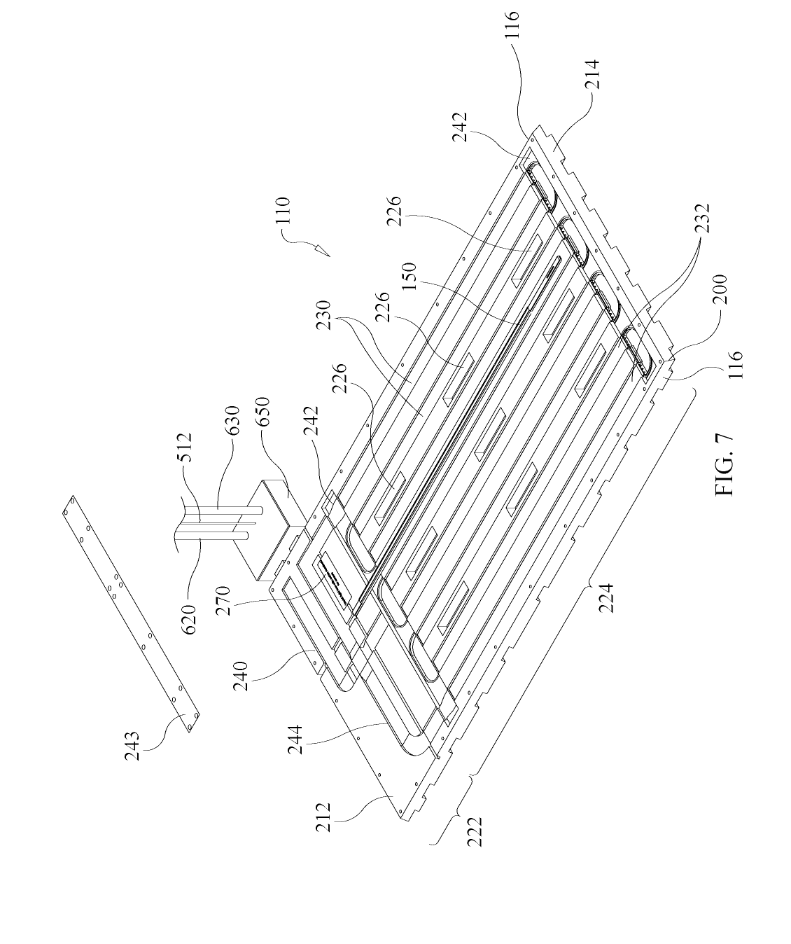

Referring now to FIG. 7, the thermal exchange pad 110 is illustrated with both portions 122 and 124 of the heat exchanged plate 120 removed. To facilitate the distribution of heat exchange fluid 612, the base 200, also referred to as the base plate or the fluid plate, defines the various fluid conveying structures. The access compartment 222 defines a fluid supply channel 240 and a fluid return channel 244. The fluid supply channel 240 may receive heat exchange fluid 612 from an expansion box 650 via supply line 620. The fluid return channel 244 returns thermally expended heat exchange fluid 612 to the expansion box 650 and return line 630. The base 200 may also define manifolds 242, for example adjacent to or housed by access compartment 222 and another located adjacent second end 214, for the distribution of heat exchange fluid 612 to and from one or more channels 230,232 defined by the top surface 220 of the base 200. The channels 230 and 232 optionally follow a serpentine path as will be further discussed below.

One or more temperature sensors 150 are optionally also received by base 200 for measuring the temperature of the heat exchange plate 120. The access compartment 222 optionally includes an electrical terminal box 270 for routing and/or electrical connections associated with controller cable 512, which is also coupled to the heat exchanger pad 100 by the expansion box 650.

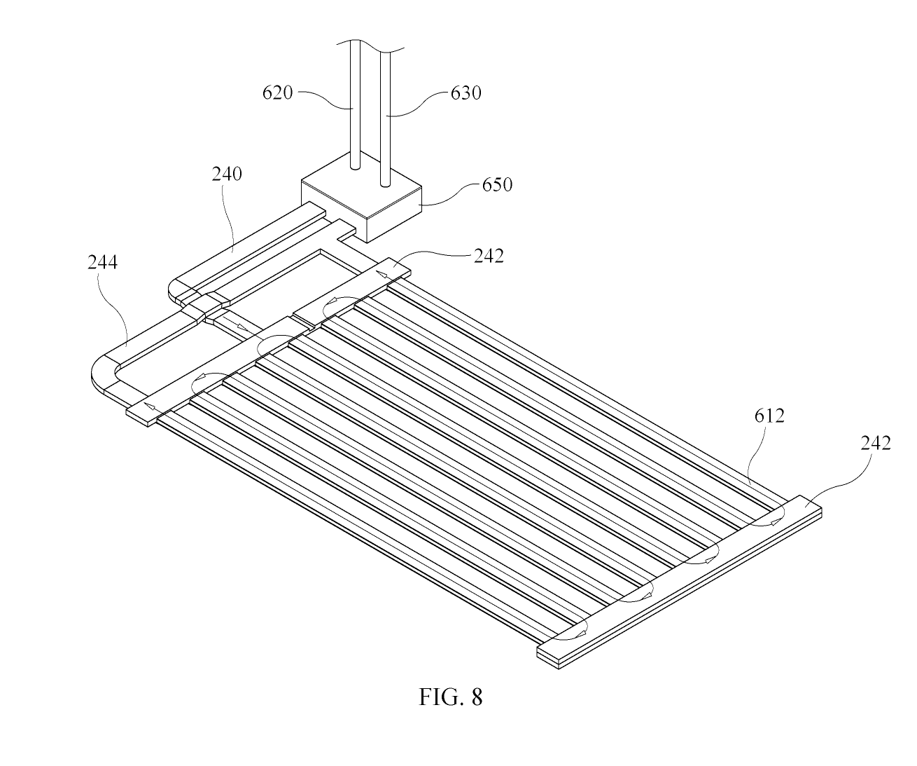

Advantageously, as understood from FIG. 8, the first and second channels 230, 232 each form a serpentine path across the heat exchange plate 120 and the channels are fluidly in parallel, thus maximizing the heat exchange for both sides of the heat exchange plate 120 with the heat exchange fluid 612. Additionally, first and second channels 230, 232 can be fluidly and mechanically coupled at opposite ends by manifolds 242 to support the channels and to provide the serpentine path for transmission of the heat exchange fluid 612. Also, the manifold 242 can also provide fluid and mechanical coupling to the fluid supply channel 240 and fluid return channel 244. In at least one embodiment of the thermal exchange pad 100, only a single serpentine path is defined for the heat exchange fluid 612 flowing through the pad. In at least another embodiment, more than two serpentine paths are defined. As shown in FIGS. 7 and 8, the fluid supply channel 240 can be fluidly coupled to and supply heat exchange fluid 612 to the first and second channels 230, 232 adjacent a midpoint between the opposite sides 116, and the fluid return channel 244 can be coupled to and receive heat exchange fluid 612 from the first and second channels 230, 232 adjacent the sides 116. The fluid supply channel 240 and fluid return channel 244 cross within the compartment 222.

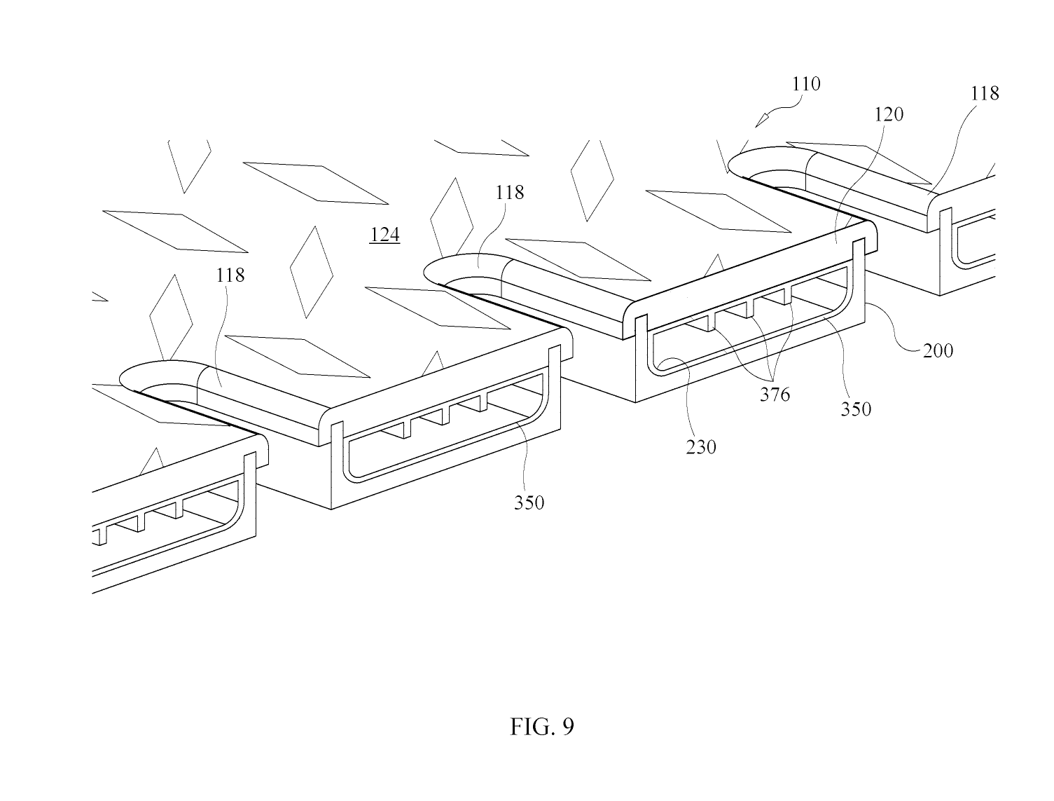

Referring to FIG. 9, a cross-sectional view of another embodiment of a thermal exchange pad 110 according to the present disclosure is illustrated. To maximize the heat conductance between the heat exchange fluid 612 and the heat exchange plate 120 a thermally conductive conduit 350 is received with the first and second channels 230 and 232 defined in the top surface 220 of base 200. The top 356 of the conduit 350 includes an integrally formed heat transfer array 376 extending into the fluid carrying center of the conduit to provide additional thermal transfer contact area with the bottom surface 146 of the heat exchange plate 120. Additionally, the largest width 352 of the lateral cross-section of the conduit 350 is located at the top 356 adjacent the planar extensions 358, and the width 352 is greater than the height 354.

To reduce condensation and maximize heat exchange with the heat exchange plate 120, the channel 230 defined by base 200 is form fit with the conduit 350. The illustrative embodiment of the conduit 350 can be extruded from an aluminum alloy; however, other thermally conductive materials and manufacturing methods can be used. The conduit 350 may have a lateral cross-sections as illustrated in the drawings and as other than those illustrated, including approximately rectangular, trapezoidal, circular, elliptical, and triangular.

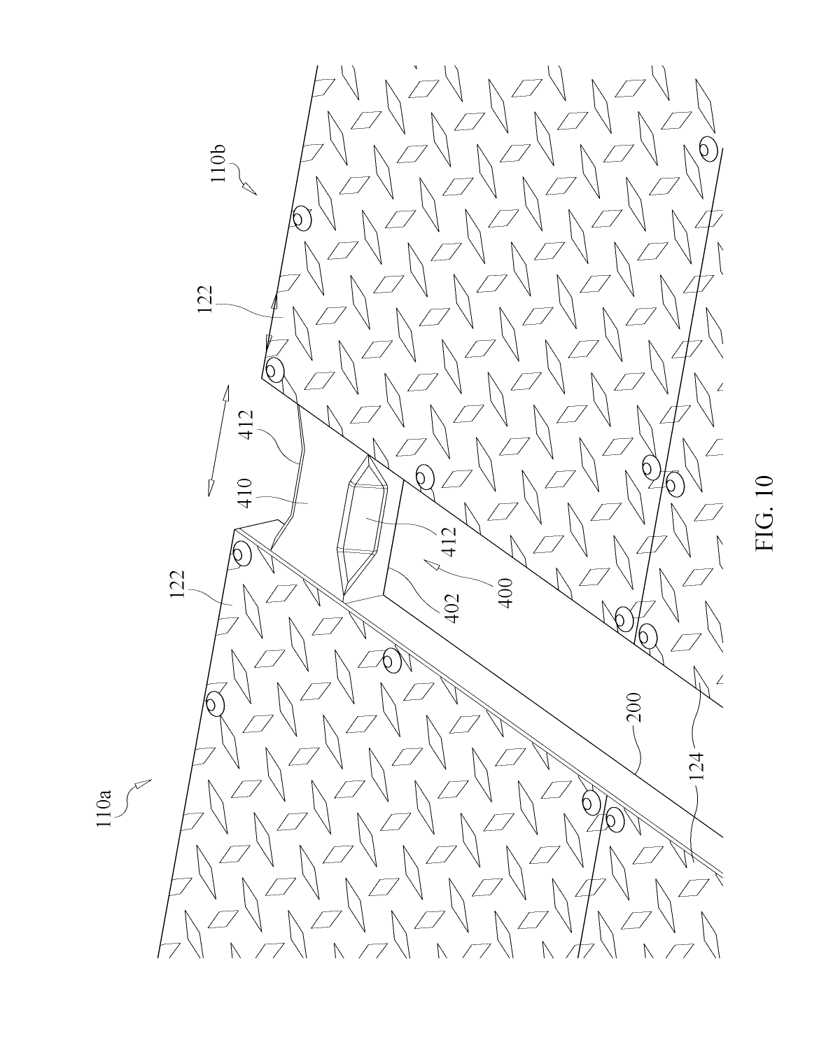

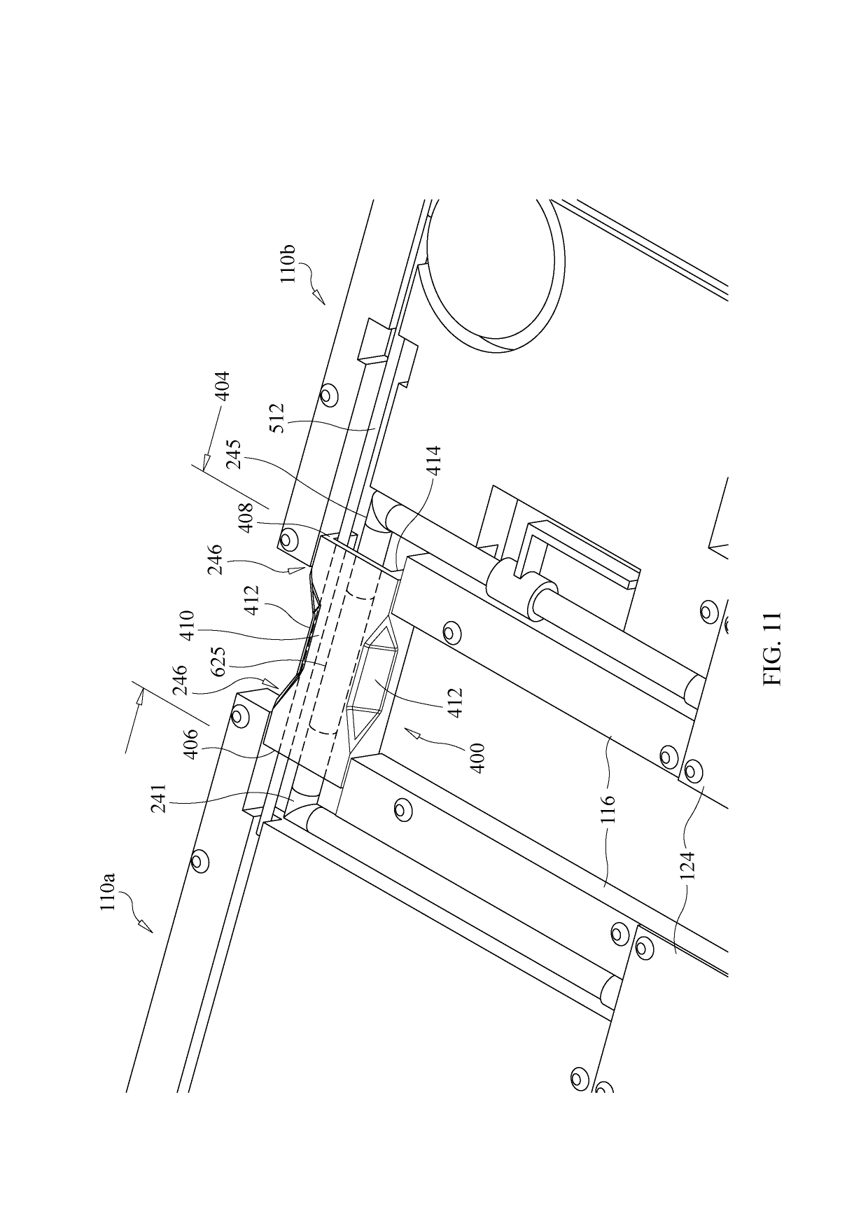

Referring to FIG. 10, two adjacent thermal exchange pads 110a-b from zone 102b of FIG. 3 illustrate a raceway 400 coupling the pads. FIG. 11 is the same illustration but with the access cover portions 122 of the heat exchanger plates 120 removed from the thermal exchange pads 110a-b. Additionally, in FIG. 11 the raceway 400 is illustrated as transparent to provide better clarity to the disclosure. The raceway 400 protects from the livestock the controller cable 512 and heat exchange fluid connectors 625 that connect between adjacent thermal exchange pads 110, for example, by covering or enclosing them. The raceway 400 also optionally provides a watertight, sealed conveyance between the adjacent thermal exchange pads 110a-b.

Referring to FIG. 11, a first end 406 of the raceway 400 is received by a receptacle 246 of the base 200 of thermal exchange pad 110a. A second end 408 of the raceway 400 is received by a receptacle 246 of the base 200 of the thermal exchange pad 110b. A channel 414 is defined along the length of the body 402 of raceway 400 to accommodate the passage of the fluid connector 625 and controller cable 512 therethrough. The channel 414 may be an opening, or if a watertight seal is not necessary, may simply be a slot cut from a bottom side of the body 402.

Variations in the distance between the sides 116 of the adjacent thermal exchange pads 110a-b that is spanned by the raceway 400 is accommodated by one or both receptacles 246 accepting a variable depth of penetration of the first or second ends 406, 408, and by raceways 400 being provided in various lengths 404. For example, if the length 404 of the raceway 400 is greater than the distance between the sides 116 of the adjacent thermal exchange pads 110a-b, then the raceway may float within the receptacles 246 but will not escape from them. In another embodiment the raceway 400 ends 406 and 408 can be interlocked with receptacles 246 to prevent movement and/or to provide a watertight seal with the thermal exchange pads 110a-b. To protect the livestock from injury and minimize a point of leverage, a center portion 410 of body 402 of raceway 400 may define fillets 412, i.e. round edges, or the like to reduce sharp corners and slope the center portion. The raceway 400 may be formed from a rigid material, for example, a metal or a non-metallic material such as HDPE.

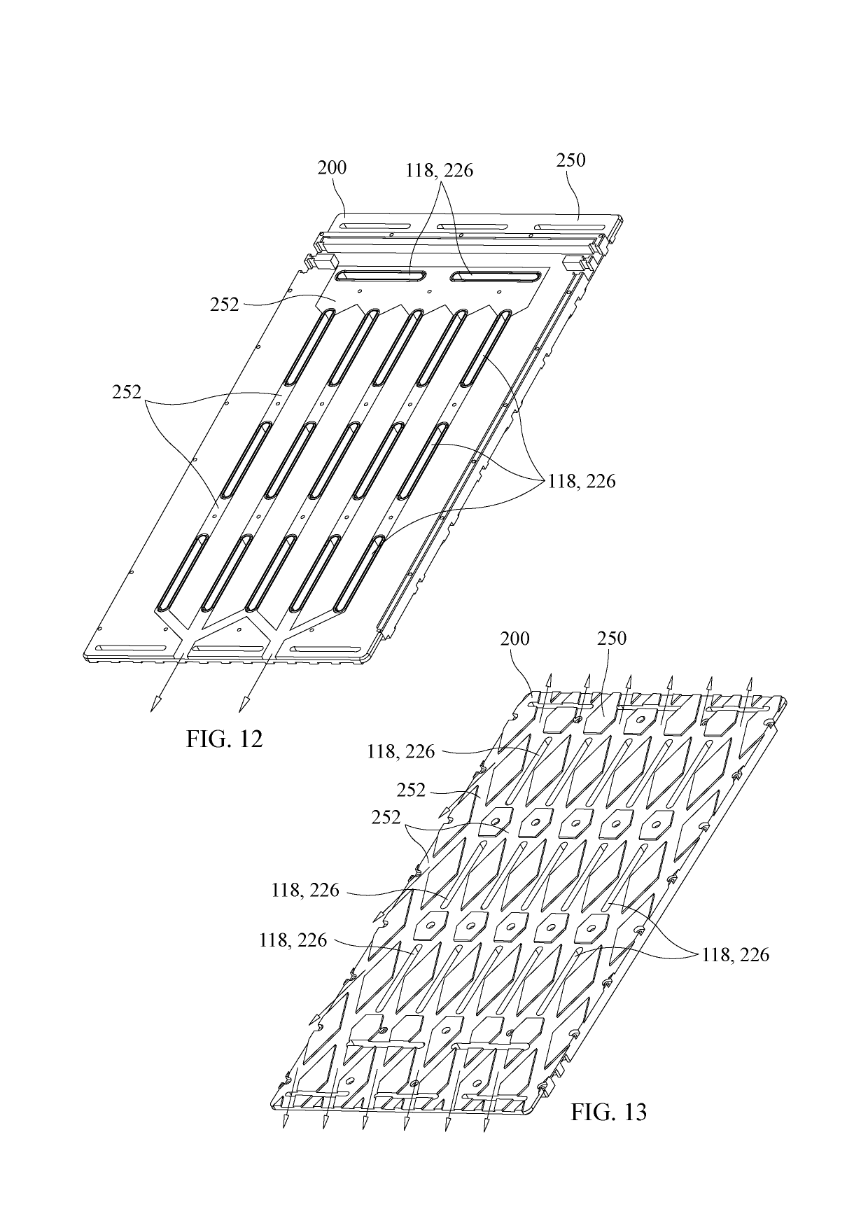

FIG. 12 illustrates an assembled bottom view of an embodiment of a thermal exchange pad 110 of FIG. 5 with a first drainage pattern formed by recesses 252 formed around the debris drains 118, the first drainage pattern formed by the recesses 252 extending to an end of the base 200 of the thermal exchange pad. FIG. 13 illustrates an assembled bottom view of an embodiment of a thermal exchange pad 110 of FIG. 5 with an alternative, second drainage pattern the extends to both opposite sides and an end of the base 200 of thermal exchange pad 110.

The recesses 252 are provided to facilitate flow of excreta from the debris drains and into underlying drains 82 in the livestock flooring 80 (see FIG. 2) or into the pit 88 under the livestock flooring super structure 85 such as support beams (see FIG. 14). In some cases, areas of flooring 80 under the thermal exchange pad may lack drains 82 or lack sufficient concentration of drains 82 underlying a debris drain 118, thus recesses 252 expands the unobstructed open area between each debris drain and the livestock flooring to help ensure excreta does not back up and clog any of the debris drains. The recesses 252 also facilitate flushing of debris away from the thermal exchange pad 110, for example using a power washing wand from underneath the pad and livestock flooring 80, or by extending a power washing wand from above, thru debris drains 118, including using a wand with an angled tip installed, for example, a 30, 60, or 90 degree angled tip, to direct the water stream from the wand along the pathways formed by recesses 252 to remove debris from between the pad and the livestock flooring.

FIG. 14 illustrates a prior art livestock farrowing crate 70 of FIG. 15 without the illustrative embodiment of the thermal exchange pad 110 installed. Livestock flooring 80 is located adjacent to the crate 70, but the areas under the farrowing crate are open to the underlying pit 88, with only flooring support beams or other such flooring superstructure 85 spanning the opening to the underlying pit. Referring to FIG. 15, the same prior art livestock farrowing crate of 70 lacking flooring within the crate is now shown with an illustrative embodiment of the thermal exchange pad 110 installed. Advantageously, the thermal exchange pad 110 can rest upon the flooring superstructure 85 and with no grate or other livestock flooring 80 under it, debris can more easily clear around the pad and thru the debris drains 118 defined thru the pad and into the pit 88 beneath. Also advantageously, the base 200 and heat exchange plate 120 can be selected from material and include material of sufficient thickness to support the weight of the adult sow when using crate 70. The thermal exchange pad 110 resting on flooring superstructure 85 rather than on top of flooring 80, a top surface 132 of the pad 110 can be level with the surrounding flooring 80.

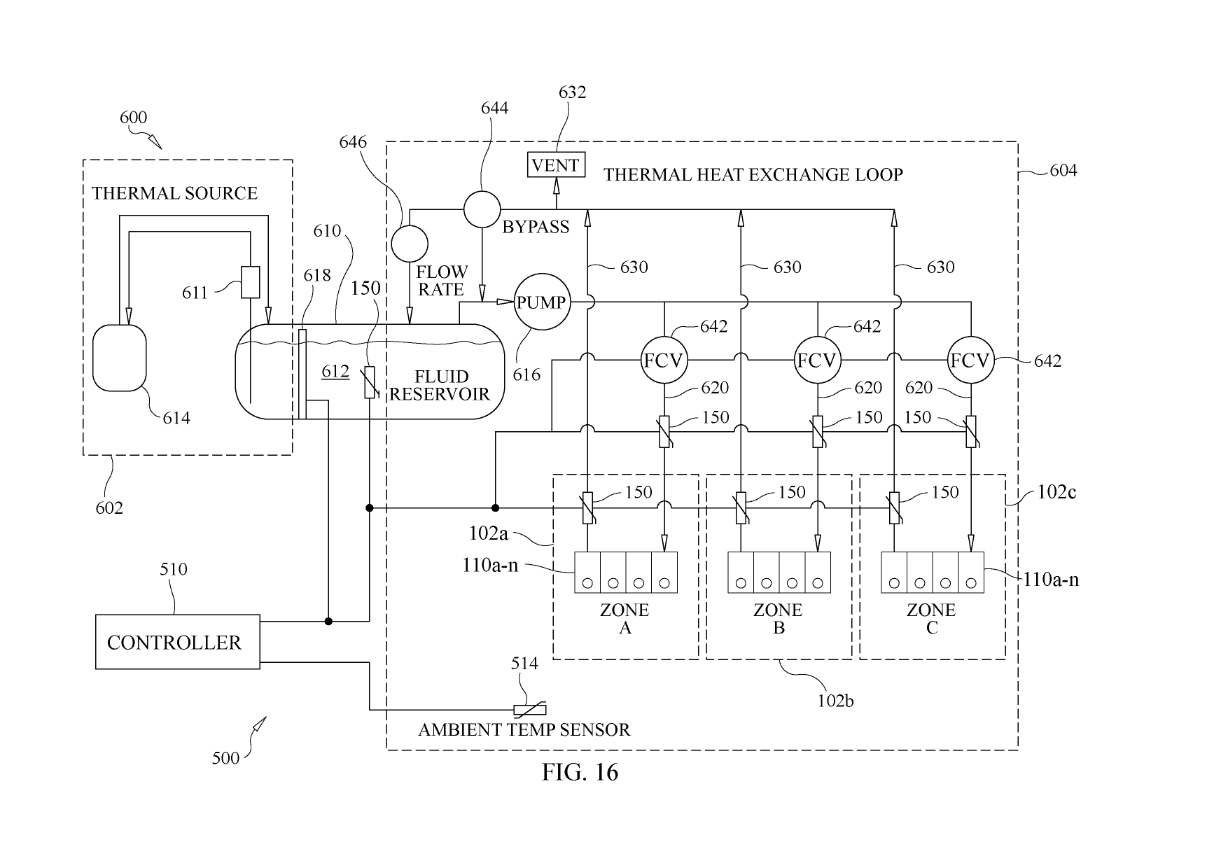

Referring to FIG. 16, a schematic block diagram of an illustrative control system 500 and an illustrative fluid system 600 of the thermal exchange system 100 according to the present disclosure is shown. As discussed above for FIG. 3, the thermal exchange system 100 may include multiple zones 102a-n, and each zone may include multiple thermal exchange pads 110a-n. The illustrative fluid system 600 includes a thermal source 602 that provides heating or cooling to a fluid reservoir 612. At least one pump 616 provides flow of heat exchange fluid from the fluid reservoir through thermal heat exchange loop 604, including the thermal exchange pads 110a-n, and either back to the fluid reservoir 612, or recirculating back to the thermal exchange pads, thus bypassing the fluid reservoir, depending on the state of a bypass valve 644. The heat exchange fluid 612 may be supplied to the pads 110 with a zone 102 either in a parallel or series fluid connection.

A controller 510 and at least one temperature sensor 150 are used to control the flow of heat exchange fluid 612 in the heat exchange loop 604 and to control the temperature of the heat exchange fluid 612, and ultimately the temperature of the thermal exchange pads 110a-n within a zone 102 in order to provide optimum body temperatures for livestock supported upon the thermal exchange pads. In various embodiments, the temperature sensor(s) 150 may be associated with and measure the temperature of one or more of the thermal exchange pad(s) 110, the ambient air, and the heat exchange fluid 612 in the fluid reservoir 610, in a return line 630 upon exiting a thermal exchange pad 110 or zone 102, and in a supply line 620 prior to entering a thermal exchange pad 110 or zone 102. Additionally, in various embodiments, the controller 510 may control multiple zones 102a-n, a single zone 102, or a single thermal exchange pad 110, controlling the thermal exchange pad individually, by zone, or collectively. Additionally, the controller(s) 510 may be located with or in the thermal exchange pad(s) 110, for example within the access compartment 222, with or in the zone(s) 102, or may be remotely located.

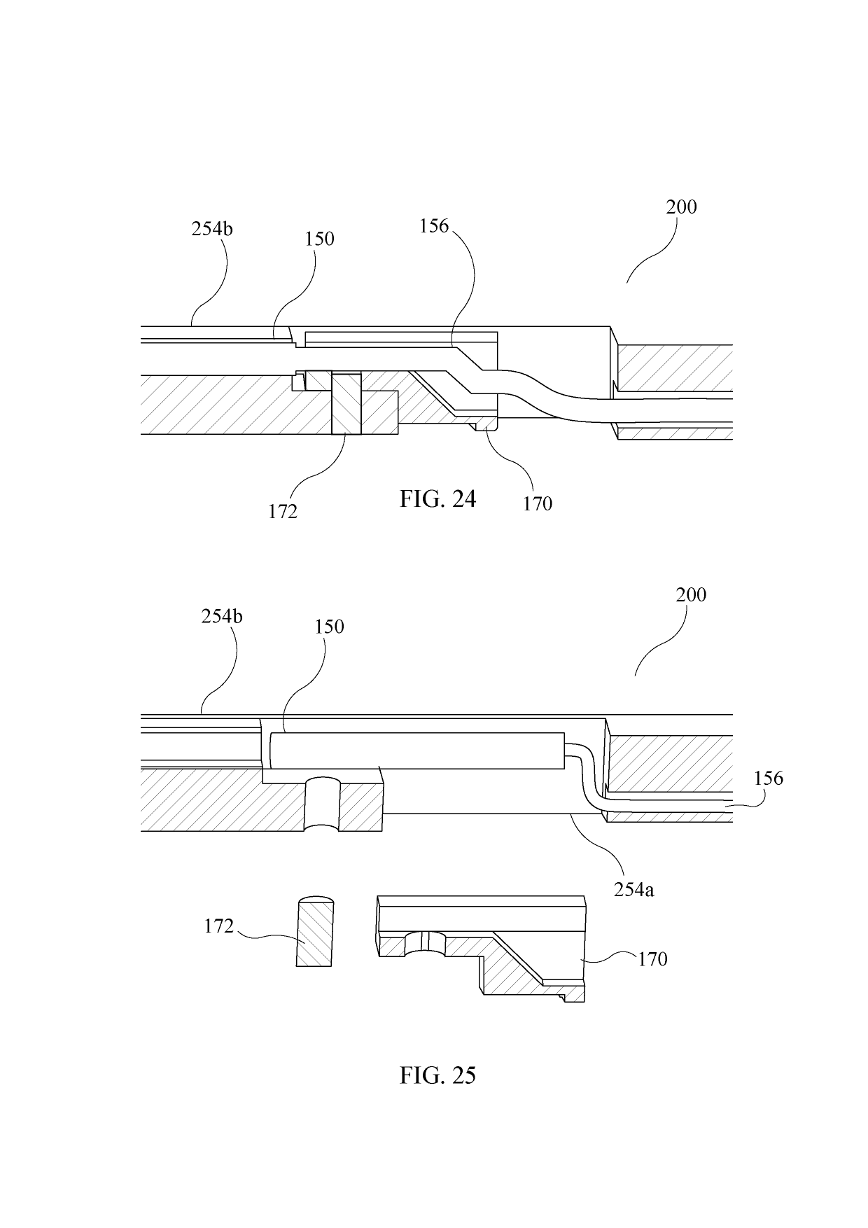

In the illustrative embodiment, at least one temperature sensor 150 is used to measure and control the temperature of the heat exchange fluid in fluid reservoir 610 and as least one temperature sensor 150 is used with the thermal exchange pads 110a-n in a zone 102, which are fluidly coupled directly with supply line 620, and at least one temperature sensor 150 is used to measure the temperature of the heat exchange fluid 612 exiting last thermal exchange pad 110n in the zone via the return line 630. Optionally, an ambient temperature sensor 514 provides a temperature signal to the controller 510 to control the fluid system 600, for example, if the ambient temperature warrants activating the system 600 to heat and/or cool pads 110a-n in zones 102a-n. Optionally, temperature sensors 150 may be provided to measure the heat exchange fluid 612 in supply line 620 entering the thermal exchange pads 110a-n in zones 102a-n. Also optionally, one or more temperature sensors 150 may be provided with one or more of the thermal exchange pads 110a-n in zones 102a-n as shown in FIG. 21-25 and discussed further below.

Other embodiments may include additional or fewer temperature sensors 150 and 514 than identified for the illustrative embodiment, for example, only one of the temperature sensors 150 and 514 listed above in order to control the system 600. In at least one embodiment a zone 102 only optionally includes temperature sensors associated with the thermal exchange pads, and the controller controls the fluid system 600 based on one or more of an ambient temperature, a livestock temperature, heat exchange fluid temperature, thermal source temperature, and historic data and/or system calibration to provide a desired reduction in heat stress. Temperature signals are communicated from the temperature sensors 150 to the controller 510 by a controller cable 512. The controller 510 uses a function of at least the temperature signals and a desired temperature set point for the thermal exchange pads 110 to control various components of the fluid system 600 as will be further discussed below.

The fluid system 600 includes a source of heat exchange fluid 612 to thermally manage the thermal exchange pads 110 of the thermal exchange system 100. In the illustrative embodiment, the heat exchange fluid 612 is water stored by a reservoir 610 that is chilled or heated, for example by circulating the heat exchange fluid 612 through a thermal element 614 of thermal source 602 using a pump 611. In alternative embodiments other heat exchange fluids 612 known in the art may be substituted in place of water.

A pump 616 provides the heat exchange fluid 612 to the zones 102 of the thermal heat exchange loop 604 via supply lines 620 and return lines 630. The heat exchange fluid 612 is optionally returned to the reservoir 610 via return lines 630 to be recycled and used again, bypasses the reservoir and is recirculated back to supply lines 620 via bypass valve 644, e.g. if sufficient thermal reserve is present in the heat exchange fluid 612, or may be discharged from the fluid system 600. In the illustrative embodiment the thermal element 614 includes at least one of a chiller and a heater to maintain the temperature of the heat exchange fluid 612 in the fluid reservoir 610 at a desired supply temperature. The chiller and/or heater may be powered by electricity, a hydrocarbon-based fuel, or a different source, as are commercially available. In alternative embodiments, the fluid system 600 may include an open- or closed-loop systems, including the thermal element 614 being a geothermal system heat exchanger or a water supply to provide a heat differential, for example, cool water drawn from a cistern, well, or public supply, thus eliminating the need for a chiller.

In one embodiment, a flow regulating valve 642 controls the instantaneous volumetric flow rate of heat exchange fluid 612 supplied to each of the zone 102s via the supply lines 620, for example, by using a proportional flow control valve that is controlled by controller 510, or by using an automatic flow regulating valve that always provides a fixed flow rate regardless of the fluid supply pressure provided by pump 616, or by providing on/off control, for example, a solenoid type valve. The flow of heat exchange fluid 612 can be turned on and off for each zone 102 by a flow regulating valve 642 controlled by the controller 510. With a fixed flow rate and on/off control, the heat exchange rate of each zone 102 of the thermal exchange system 100 is varied by modulating the proportion of time periods for which the flow is on and the flow is off. It is understood that the heat exchange rate is varied to control the temperature of the thermal exchange pad 110 and thus reduce the temperature related stress of the livestock.

In an alternative embodiment, a flow regulating valve 642 may be included for each of the thermal exchange pads 110 so that the controller 510 can control the heat exchange rate of each thermal exchange pad, for example, based in part on a temperature signal received from at least one temperature sensor associated with each respective thermal exchange pad. The instantaneous volumetric flow rate for any one thermal exchange pad 110 may vary depending on the available pressure for the heat exchange fluid 612 and how many thermal exchange pads are instantaneously supplied with an active fluid flow. To address this potential variation of instantaneous flow rates and to prevent turbulent flow within the thermal exchange pads, which reduces heat transfer efficiency, and to reasonably limit the rate of temperature change for a thermal exchange pad, it may be important to include an automatic flow regulating valve 642 with each pad to limit the volumetric flow rate to a set rate, for example 1 gallon per minute.

In the illustrative embodiment the heat exchange rate of the thermal heat exchange loop 604 is controlled by varying the temperature of the heat exchange fluid 612 in the fluid reservoir and/or by selectively bypassing the fluid reservoir using bypass valve 644. In at least one embodiment, the heat exchange rate of the thermal heat exchange loop 604 or of each zone 102 or of each thermal exchange pad 110 of the thermal exchange system 100 can be varied by modulating the instantaneous volumetric flow rate, for example, using a variable pump 616 and/or proportional flow regulating valve 642 controlled by the controller 510. In at least one embodiment, the heat exchange rate is varied by modulating the relative time for which the flow of heat exchange fluid is turned on and off using the pump 616 and/or proportional flow regulating valve 642. A level sensor 618 may be used by controller 510 to monitor and control the fill level of heat exchange fluid 612 in reservoir 610.

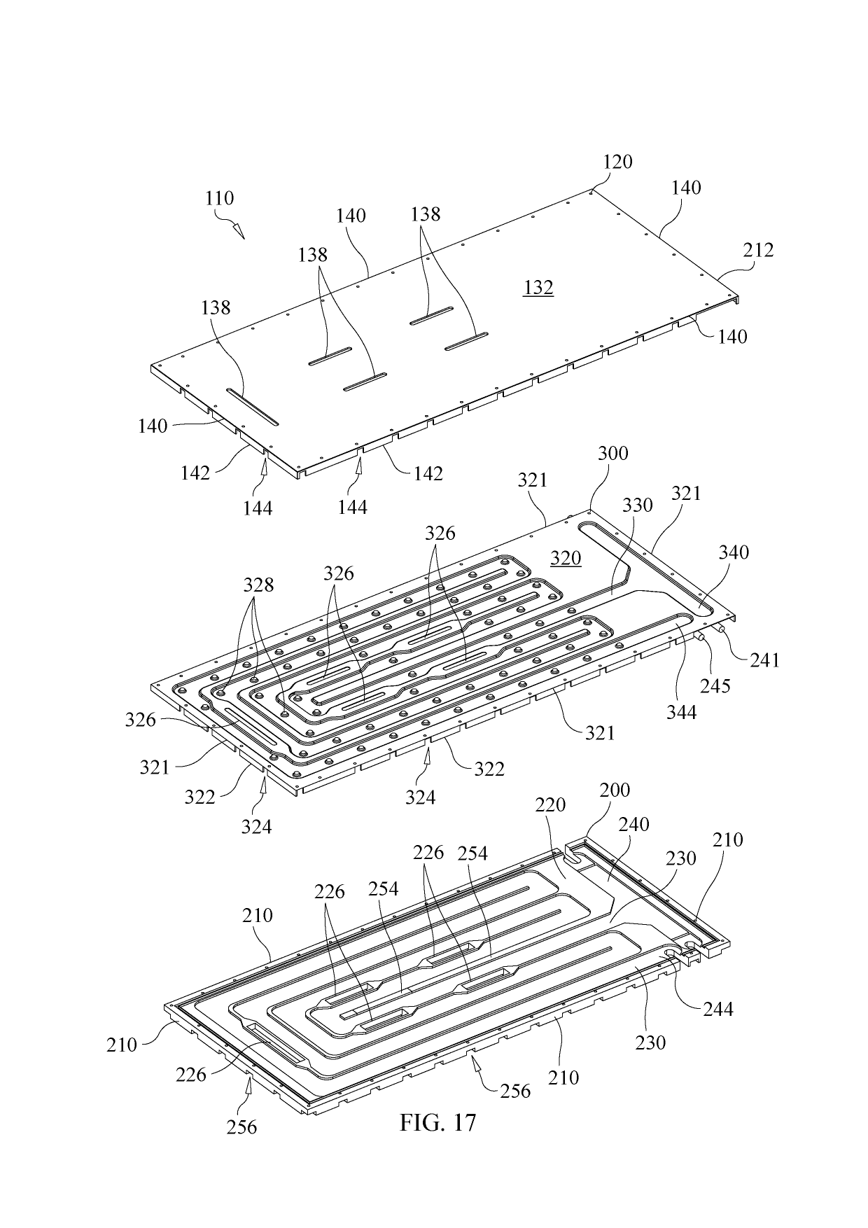

Referring to FIG. 17, an exploded view of an illustrative embodiment of a thermal exchange pad 110 according to the present disclosure is illustrated. The thermal exchange pad 110 includes three layers: a base 200, an intermediate layer 300, and a heat exchange plate 120. In prior embodiments the base 200 defined all of the fluid supply channel 240, the first channel 230, the fluid return channel 244, and the openings 326 as defined by a top surface 220; however, in the instant embodiment some of these structures include separate conduits provided for the heat exchange fluid 612, including a fluid supply channel 340, a first channel 330, and a fluid return channel 344 which are instead formed in a top surface 320 of an intermediate layer 300, of which the fluid supply channel and fluid return channel are formed at a first end 212 of the thermal exchange pad 110. Thus, the intermediate layer 300 comprises the fluid plate for this embodiment which the heat exchange plate spans over, including the first channel 330. The fluid supply channel 340 can be fluidly coupled to and supply heat exchange fluid 612 to the first channel 330 adjacent a midpoint between the opposite sides 116, and the fluid return channel 344 can be fluidly coupled to and receive heat exchange fluid 612 from the first channel 330 adjacent a side 116.

The intermediate layer 300 can be formed from thermally conductive material, for example, by stamping a metal or metal alloy such as stainless steel. To maximize the thermal conveyance with the heat exchanged fluid 612, the intermediate layer 300 can be bonded with the overlying heat exchange plate 120. The heat exchange plate 120 can be formed from a rigid and thermally conductive sheet, for example a metal or metal alloy such as aluminum or stainless steel, which may be stamped, cast, or otherwise formed.

Advantageously, the channel 330 follows a serpentine path and maximizes the distribution of the heat exchange fluid across the full span of the heat exchange plate 120 of thermal exchange pad 110. Optionally, the channels 330 loop around some or all the debris openings 326 for debris drains 138 and associated openings 226 defined in base 200 so that both excreta drainage and heat exchange can be maximized for the thermal exchange pad 110, for example.

The debris drains 138 and associated openings 226 and 326 may be bores, slots, or other shaped holes formed to provide a passageway through the heat exchange plate 120 and promote the passage of excreta and water used during cleaning operations. The density of distribution of debris drains 138 and associated openings 226 and 326 defined through base 200 may also be maximized adjacent a second end 114 and minimized or non-existent adjacent a first end 112 in accordance with the anatomy of the livestock intended for use with and maximizing excreta drainage in those areas of the thermal exchange pad 110.

The thermal exchange pad 110 may include more than one fluid inlet 241a-b coupled to a fluid supply channel 340. For example, the fluid inlets 241a-b may be located on opposite sides 116 of the thermal exchange pad 110 to facilitate a parallel supply connection of a zone 102 of thermal exchange pads 110, or to provide the heat exchange fluid 612 from either side 116 of the pad. The fluid outlet 245 coupled to a fluid return channel 344 may also be provided in more than one location of the thermal exchange pad 110 to provide flexibility of connection and interconnection of adjacent pads.

The edges 140 and 321 of the heat exchange plate 120 and intermediate layer 300 may include flanges 142 and 322 to increase strength and prevent deformation and/or to prevent water intrusion between the plate, intermediate layer, and base 200, for example, during pressure wash cleaning. Cutouts (or channels) 144, 324, and 256 may also be defined between flanges 142 and 322 to enable tool access to fasteners and/or to advance off-flow of excreta, including during pressure wash cleaning.

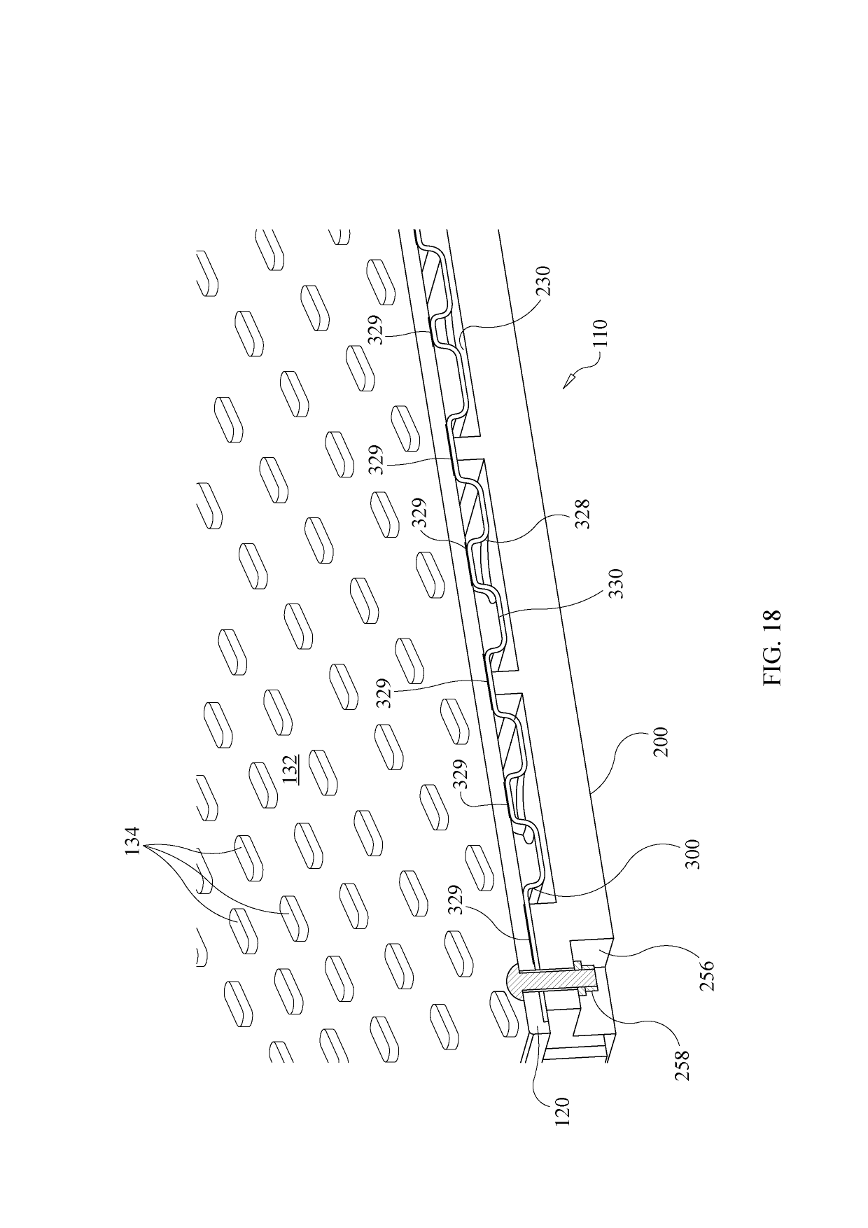

Referring to FIG. 18, a cross-sectional assembly view of the components of FIG. 17, advantageously, the heat exchange plate 120 and intermediate layer 300 can be bonded together using spot or stir welding or the like, or by using an alloy filler process such as soldering or brazing or the like. To add structural stability and increase bond strength, additional supports 328 can be located within the confines of the first channel 330, for example, the supports appear as dimple or capped tube-like structure to provide added vertical structure and bonding area between the intermediate layer 300 and the heat exchange plate 120.

Advantageously, the heat exchange fluid 612 conveyed by the first channel 330 is in direct contact with a bottom surface 146 of the heat exchange plate 120 to maximize thermal conduction and transfer. The material choice and dimensions of the heat exchange plate 120 must be selected to provide a shear and tensile strength sufficient to support the weight and movement of the intended livestock, while also maximizing the heat transfer from the heat exchange fluid 612 to the livestock resting on the heat exchange plate. In one embodiment, the material is 3/16 inch (0.48 cm) thick 3003 aluminum alloy plate, which provides a weight reduction over many other metal choices and is of sufficient shear and tensile strength to support the movement and rest of adult swine. Advantageously, a structure to increase the friction and reduce the likelihood of livestock slipping and being injured may be added to or formed by the top surface 132 of the heat exchange plate 120, for example a pattern of treads 134 as is typically found in tread plate, for example a “diamond” plate.

The base 200 provides structural support for the thermal exchange pad 110 and intermediate layer 300 and can formed from a thermally insulating material to reduce condensation and heat loss under the intermediate layer 300, for example using engineered composites, including but not limited to a thermoset resin reenforced with materials such as carbon fiber or fiberglass, a thermoplastic, or a resin hybrid. Common examples of such engineered composite materials are high density polyethylene (HDPE) and fiberglass reinforced plastic (FRP); however, other materials providing sufficient strength, insulation, corrosion resistance, and weight reduction as engineered composite materials provide can be used. Such materials for base 200 may be molded, machined, or otherwise formed as is known in the art for such materials.

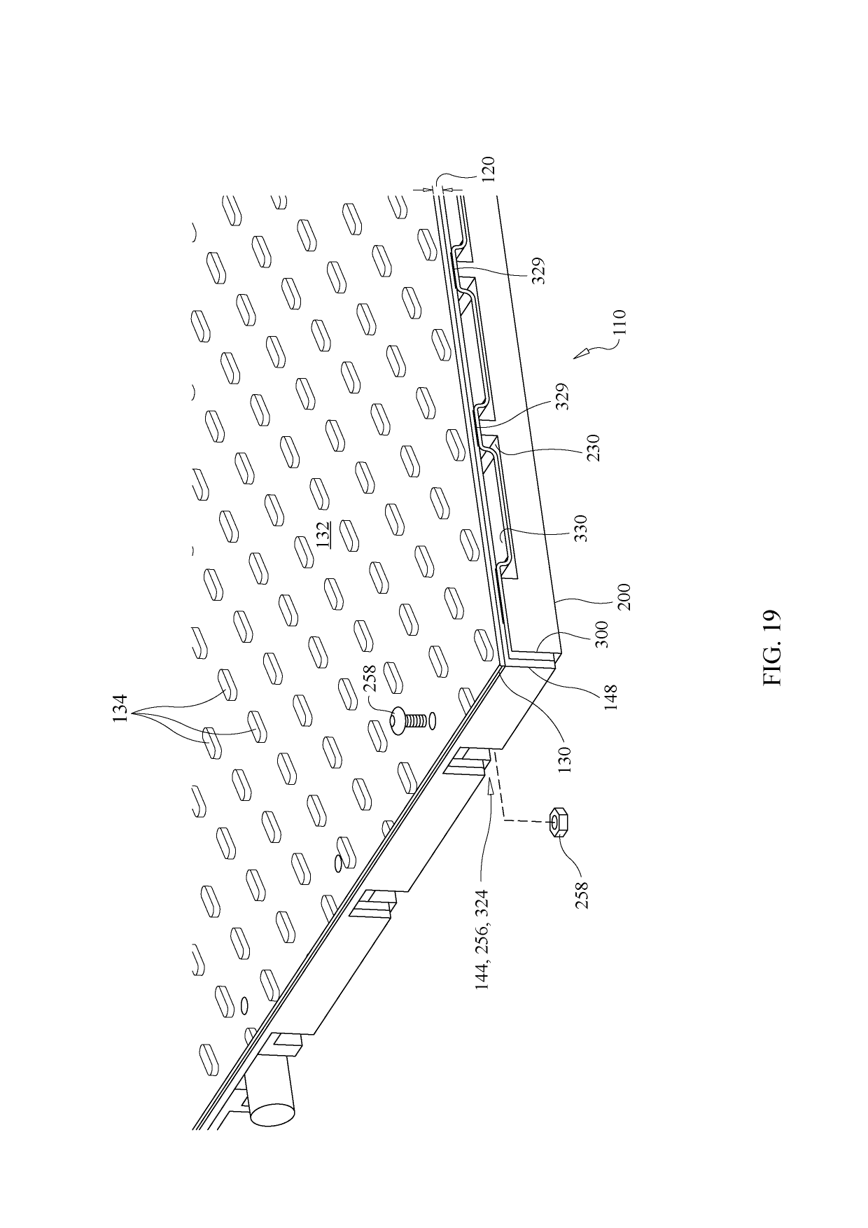

Referring to FIG. 19, a modification of the above discussed embodiment includes the addition of a bottom layer 148 to the top layer 130 of the heat exchange plate 120. Thus, instead of the top layer 130 being bonded directly to the intermediate layer 300, the bottom layer 148 is bonded to the intermediate layer. The potential advantage of this arrangement is that sheets of the same type of uniform thickness material, whether or not the same thickness, can be used to form each of the bottom layer 148 and top layer 130, providing an economical and reliable bond to seal the first channel 330. For example, stainless steel may be selected for the bottom layer 148 and intermediate layer 300, and aluminum alloy selected for the top layer 130. Bonding the two like materials of bottom layer 148 and intermediate layer three at 100 can be easily accomplished first, and then subsequent bonding of the differing materials of the bottom layer 148 and top layer 130 of the heat exchange plate 120 can be accomplished with less concern or no concern for achieving a liquid tight seal.

As illustrated in FIGS. 18 and 19, the heat exchange plate 120 can be secured to the base 200 using typical fasteners 258. To facilitate removal of the heat exchange plate 120, for example the access cover portion 122 after installation, a cut out 144, 256, 324 can be provided in the various layers to reach fastener component 258 located adjacent the bottom surface 250 of the base 200. For the embodiment discussed immediately above, in which the heat exchange plate 120 includes a top layer 130 and a bottom layer 148 bonded to an intermediate layer 300, the fasteners 258 may optionally fasten the top layer 130 to the bottom layer 148 and to the base 200.

A tool can be used to more easily tighten or loosen the fasteners 258 securing the heat exchange plate 120 to the base 200 after installation with the prior art livestock flooring 80. Some livestock flooring 80 may include elevated runners 86 and other such structures, which may be accommodated by providing recess areas 252 along edges 210 or other areas of the base 200. Alternatively, shims (not shown) between the livestock flooring 80 and the base 200 may be used to provide a planar support surface for the thermal exchange pad 110.

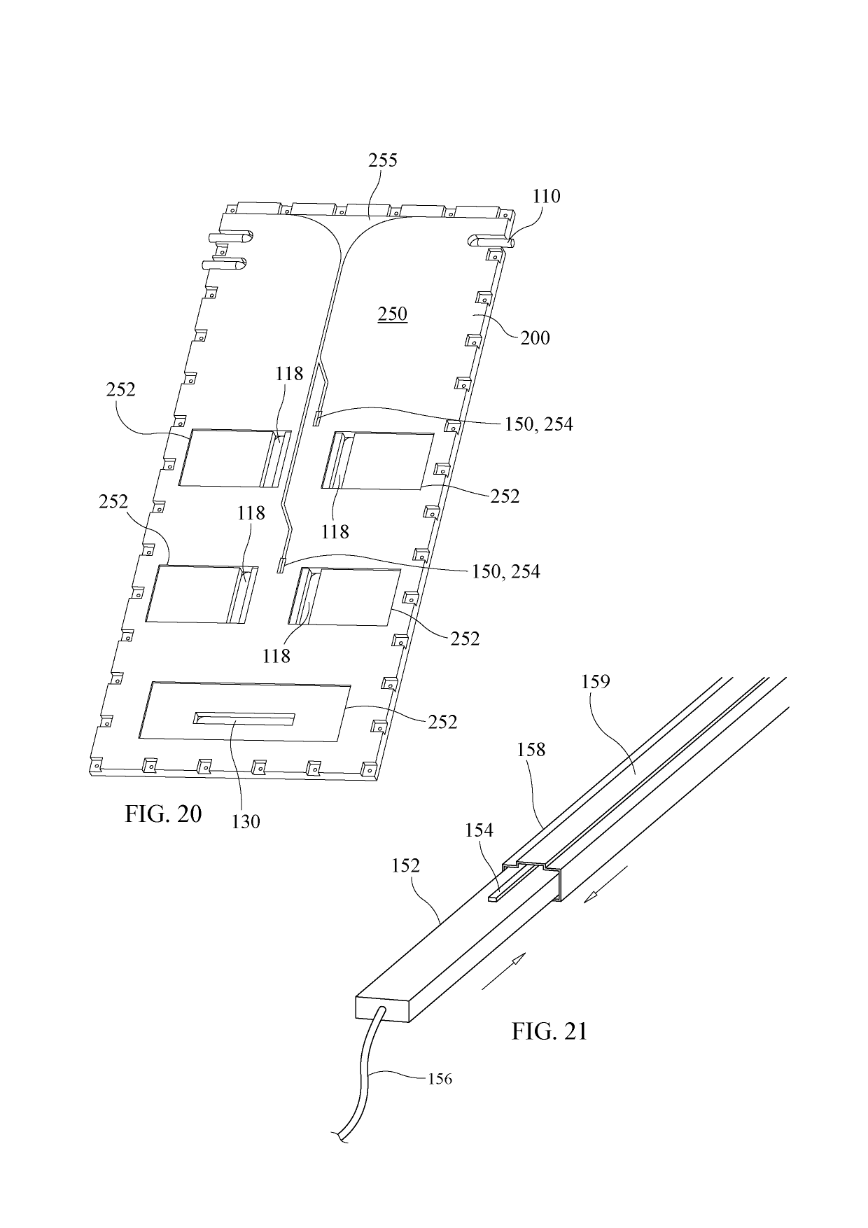

Referring to FIG. 20, an assembled bottom view of the thermal exchange pad 110 of FIG. 17 is illustrated to show the recesses 252 formed around the debris drains 118 to facilitate flow of excreta from the debris drains and into underlying drains 82 in the livestock flooring 80 (see FIG. 1). In some cases areas of flooring 80 may lack drains 82 or lack sufficient concentration of drains 82 underlying a debris drain 118, thus recesses 252 expands the unobstructed open area between each debris drain and the livestock flooring to help ensure excreta does not back up and clog any of the debris drains. Also shown in FIG. 20 are receivers 254 formed in base 200 to each receive a temperature sensor 150 and associated slot 255 that provides a passageway to guide and protect sensor cable 156. Optionally, the receiver 254 and the slot 255 may be filled with a sealant to encapsulate and further protect and/or seal the temperature sensor 150 and cable 156, for example, an extractable sealant that provides waterproof sealing and facilitates later removal and replacement of the sensor 150 and cable 156 if needed.

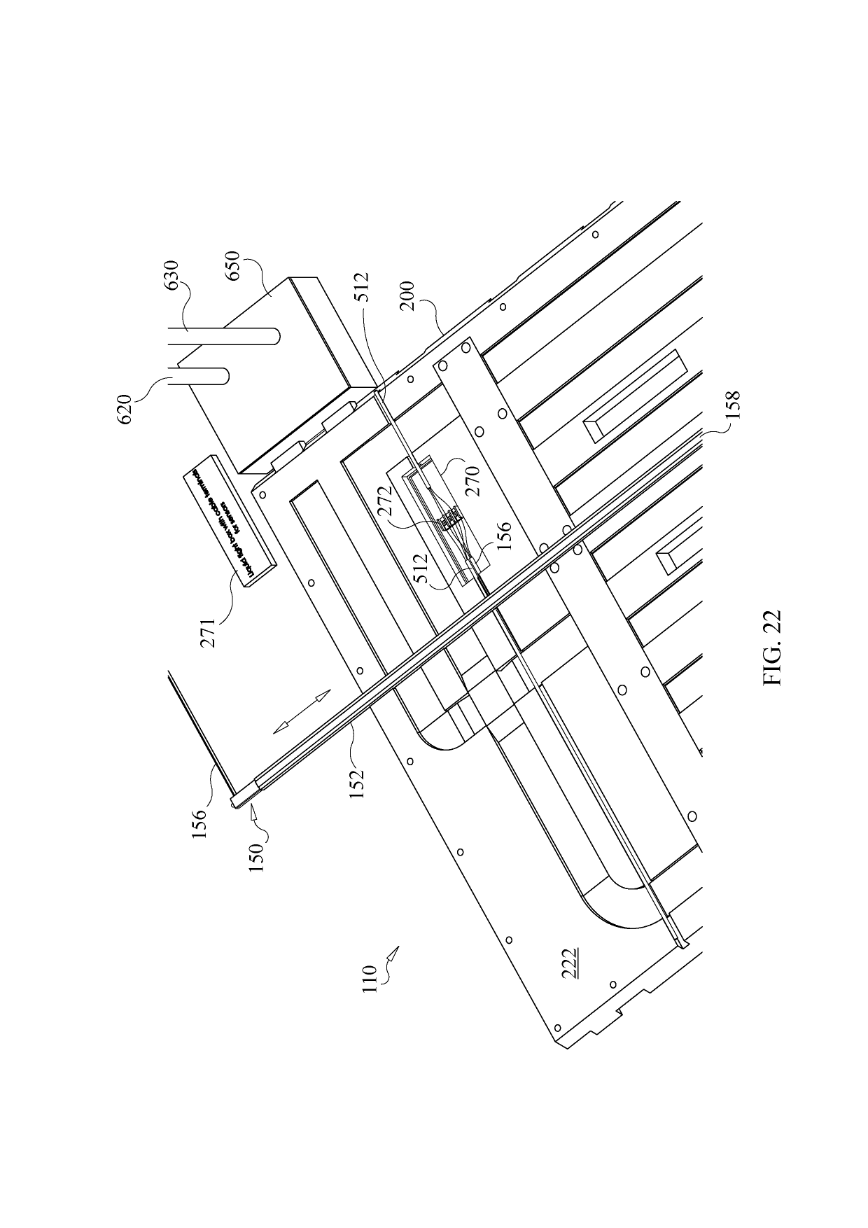

Referring to FIG. 21, an illustrative embodiment of a temperature sensor 150 according to the present disclosure is shown with the mounting structure 152 shown partly extracted from a protective sleeve 158. The temperature sensor 150 is used to sense the temperature of the heat exchange plate 120 and provide temperature signals to the controller 510 that are used to regulate the thermal exchange provided by fluid system 600 and the thermal exchange pads 110. A mounting structure 152, for example, a printed circuit board, supports one or more sensors 154, for example a surface mount thermistor or other electrical temperature sensing device. Advantageously, the sensor 154 and mounting structure 152 can be housed by a protective sleeve 158, for example, a stainless steel enclosure have an optional protrusion 159 to accommodate the sensor 154 and to provide thermal contact between a bottom surface 146 of the heat exchange plate 120 and the sensor. As shown in cross-sectional view FIG. 22, a cable 156 extends out of the protective sleeve 158 to carry the temperature signals from the sensor 154 and mounting structure 152. In at least one embodiment, the protective sleeve 158 has a watertight seal to further protect the sensor 154.

The temperature sensor 150 can include more than one sensor 154 to provide redundancy and a more accurate sensing of the average temperature of the heat exchange plate 110 because the sensors 154 are physically displaced from one another. Additionally, or alternatively, such advantages can be provided by the heat exchange plate 110 including more than one temperature sensor 150.

Referring to FIG. 22, a thermal exchange pad 110 illustrating an exemplary embodiment of a temperature sensor 150 with the mounting structure 152 partially extracted from the protective sleeve 158 is shown. In this embodiment, the protective sleeve 158 is fixed to the base 200 or heat exchange plate 120, so to change out the sensor 154, the mounting structure 152, and the cable 156, the mounting structure and cable are axially extracted from the protective sleeve 158 via access compartment 222. Additionally, electrical terminal box 270 may be in access compartment 222 and provide a watertight resealable enclosure for electrically coupling cable 156 with controller cable 512, for example using terminal 272 shown in FIG. 21, which is electrically connected with the controller 510 and optionally may be electrically coupled with adjacent thermal exchange pads 110.

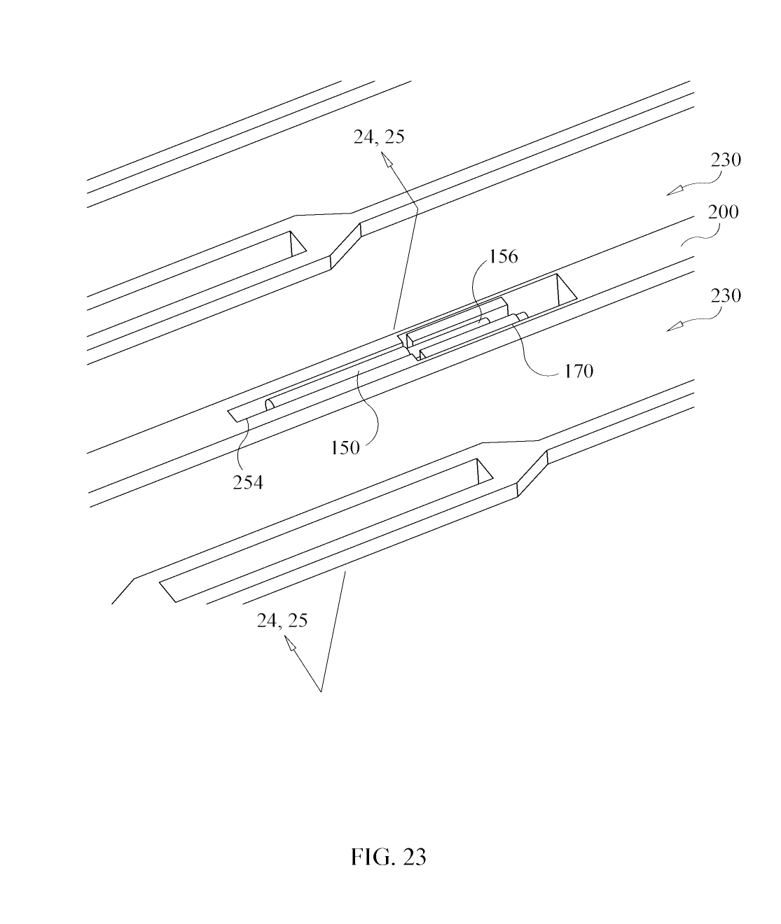

Referring to FIGS. 23-25, the sensor 150 positioned into the receiver 254 of base 200 is illustrated along with the retainer 170 and fastener 172. The sensor 150 may include a thermally conductive protective sleeve for sensor 154. A receiver 254 defined by base 200 allows retainer 170 to position and retain the sensor 150 flush with top surface 220 of the base, and thereby in thermal contact with the overlying bottom surface 146 of the heat exchange plate. For example, the receiver 254 may be located between adjacent portions of the first channel 230.As can be understood from the illustrations, an enlarged portion 254a of the receiver 254 provides access and accommodates retainer 170 and fastener 172, for example a set screw, that retain the sensor 150 with a reduced portion 254b and also press the sensor into thermal contact with the bottom surface 146 of the heat exchange plate 110 (not shown) that is positioned against the top of base 200.

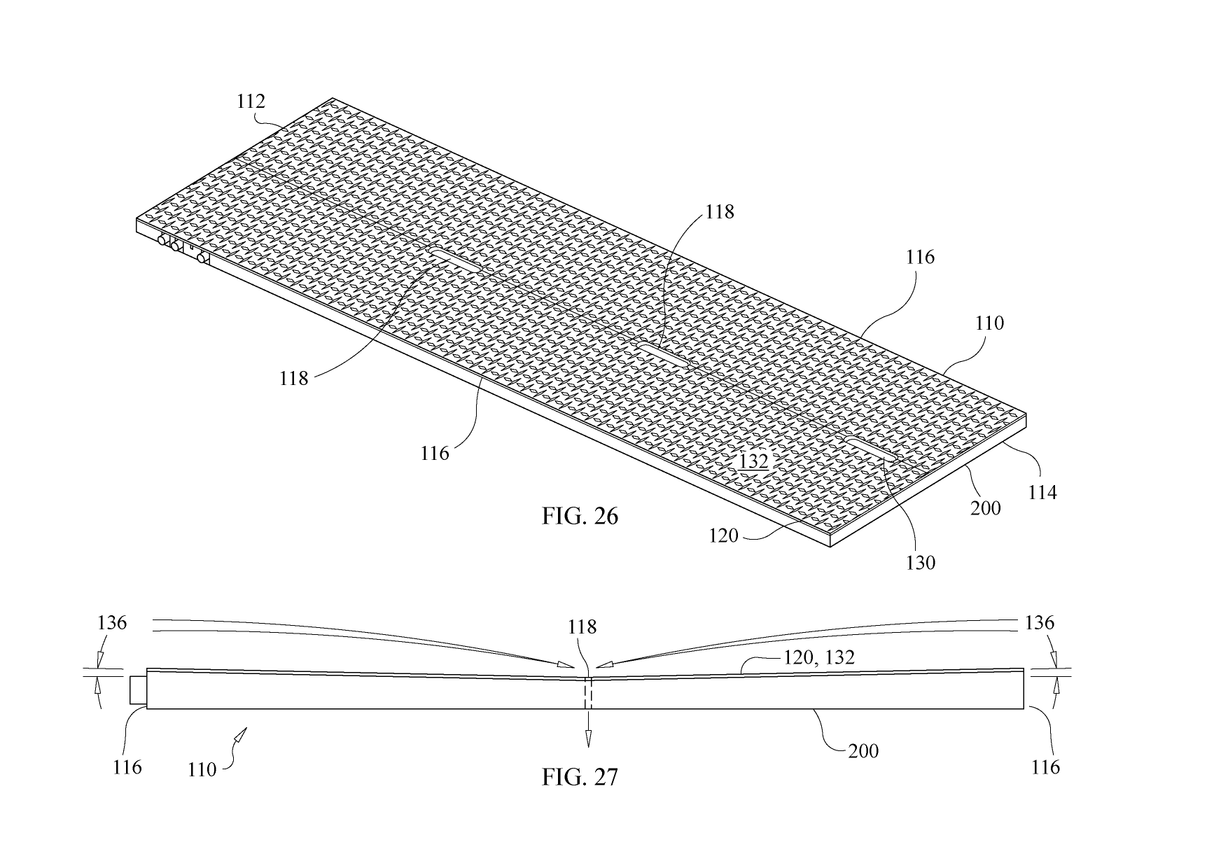

Referring to FIGS. 26 and 27, another illustrative embodiment of a thermal exchange pad 110 according to the present disclosure is illustrated. This embodiment provides a top surface 132 of the heat exchange plate 120 having a downward slope 136 between sides 116 and the debris drains 118, thereby facilitating enhanced runoff of excreta from the top surface 132 to and through the debris drains 118, including during a washing operation. The slope 136 may be oriented differently than illustrated, for example the slope 136 could be formed to direct excreta toward one or more of ends 112, 114 and sides 116.

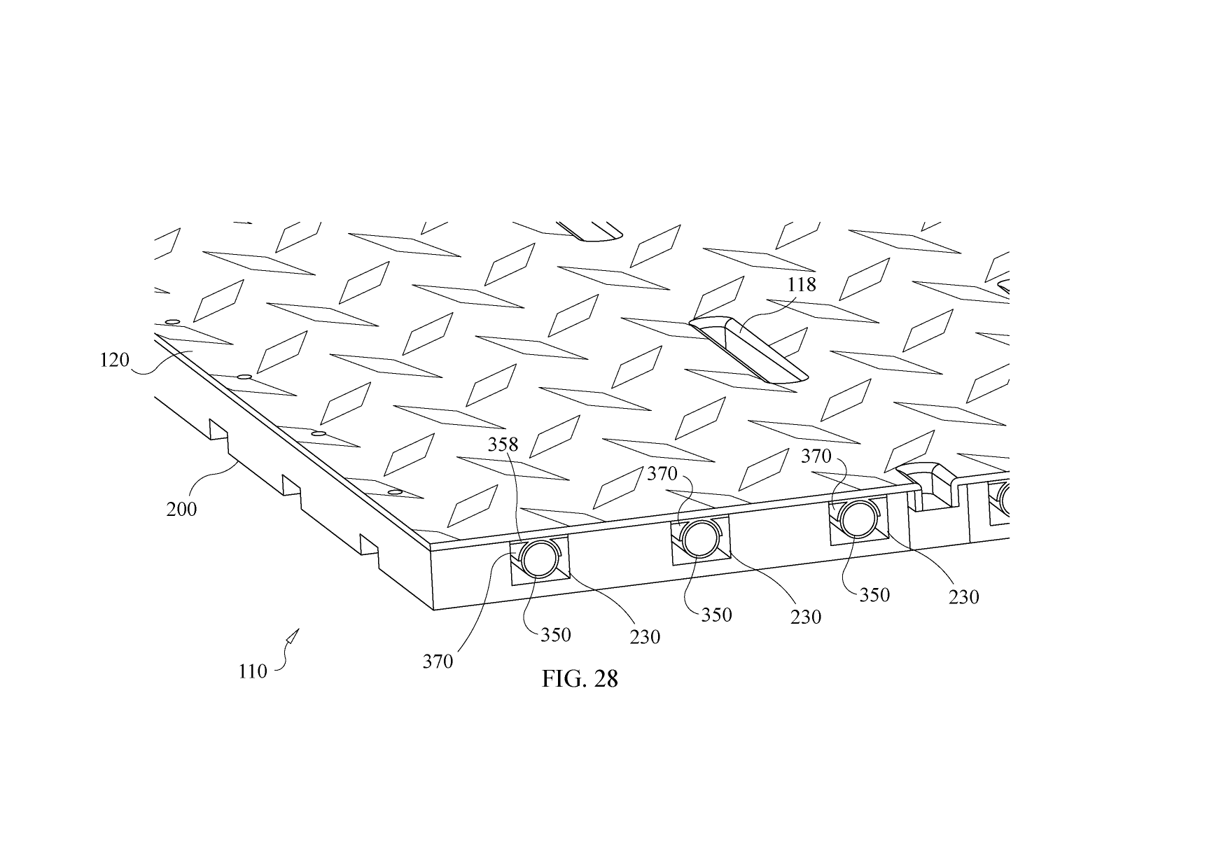

Referring to FIG. 28, another embodiment of a thermal exchange pad 110 according to the present disclosure is illustrated. Specifically, this embodiment incorporates standard thermally conductive conduit 350, for example a schedule stainless steel pipe, that is thermally coupled to the bottom surface 146 of the heat exchange plate 120 with a thermal coupling structure 370 that maximizes thermal transfer, for example including planar extensions 352 to maximize contact area with the heat exchange plate.

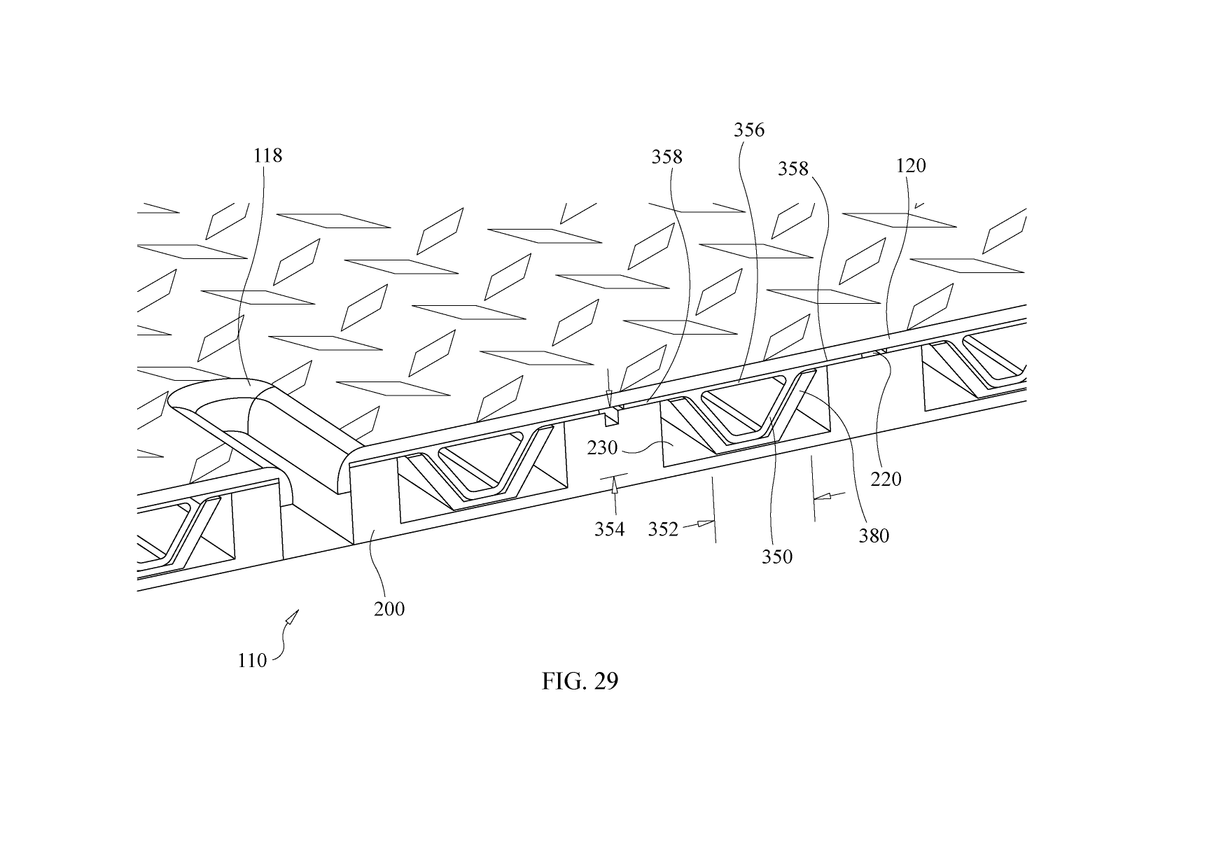

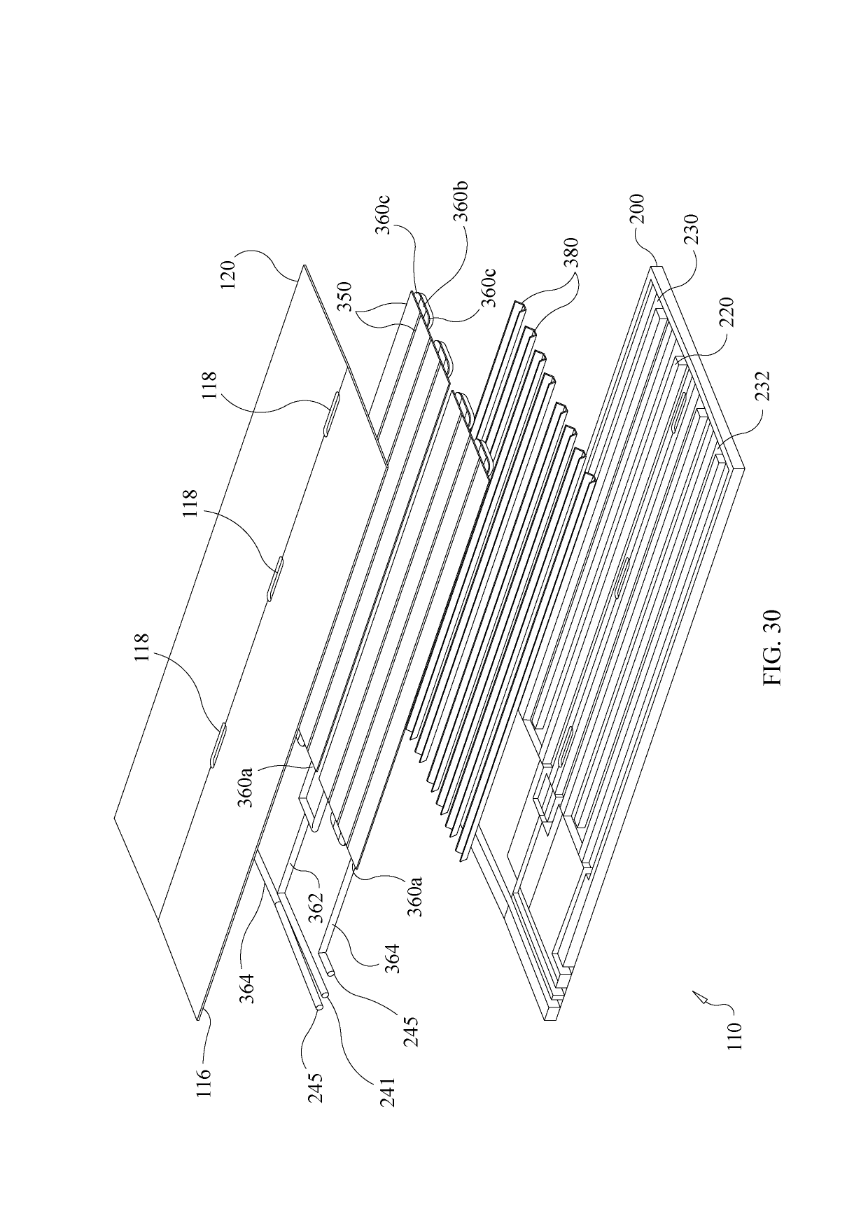

Referring to FIG. 29, a cross-sectional view of another embodiment of a thermal exchange pad 110 according to the present disclosure is illustrated. FIG. 30 illustrates an exploded view of the embodiment of the thermal exchange pad 110 shown in FIG. 29. To maximize the heat conductance between the heat exchange fluid 612 and the heat exchange plate 120 a thermally conductive conduit 350 is received with the first and second channels 230 and 232 defined in the top surface 220 of base 200. The top 356 of the conduit 350 includes planar extensions 358 to provide additional thermal transfer contact area with the bottom surface 146 of the heat exchange plate 120. Additionally, the largest width 352 of the lateral cross-section of the conduit 350 is located at the top 356 adjacent the planar extensions 358. In the illustrative embodiment, the width 352 is greater than the height 354 and the lateral cross-section is trapezoidal. An optional layer of insulation 380 is located between the conduit 350 and the channels 230 and 232, reducing condensation and maximizing heat exchange with the heat exchange plate 120. The illustrative embodiment is extruded from an aluminum alloy; however, other thermally conductive materials and manufacturing methods can be used. Advantageously, the first and channels 230, 232 each form a serpentine path across the heat exchange plate 120 and the channels are fluidly in parallel, thus exposing both sides of the heat exchange plate 120 to the heat exchange fluid having just entered the thermal exchange pad at inlet 241.

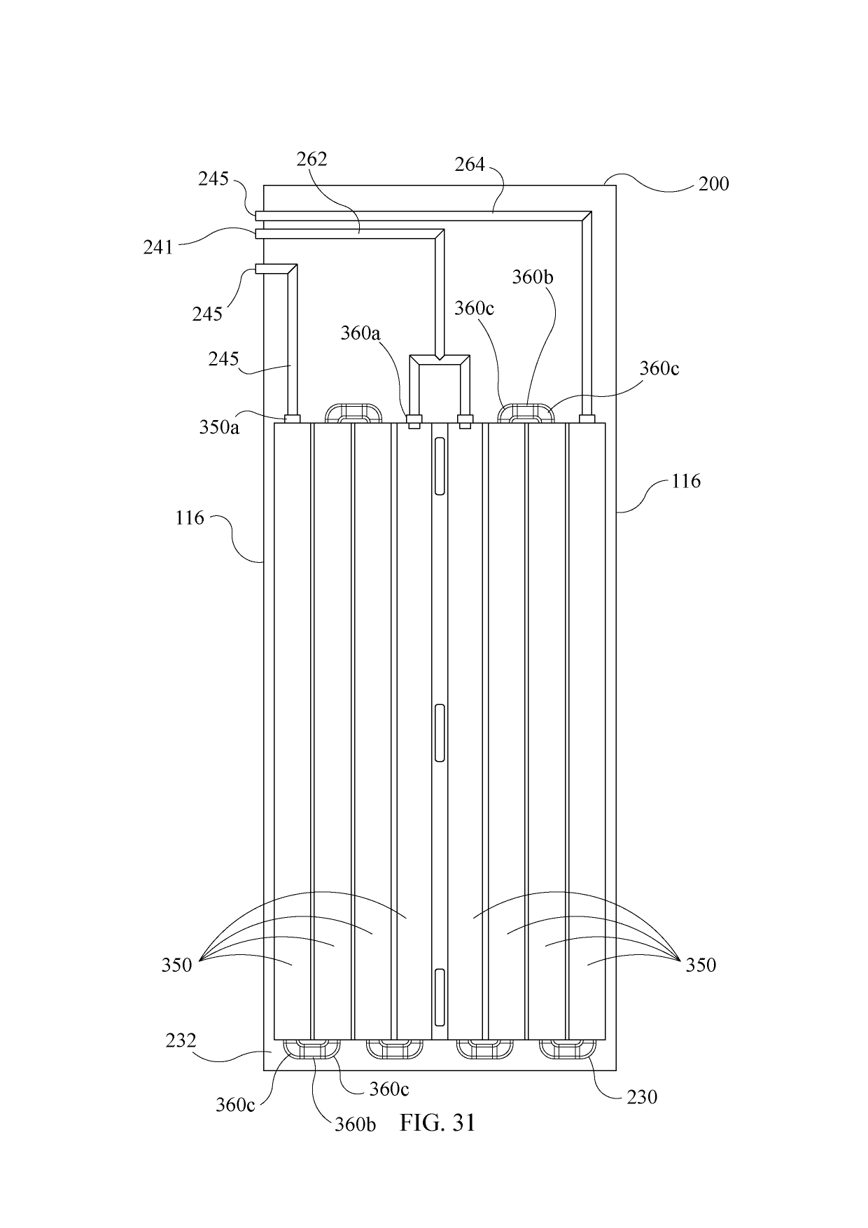

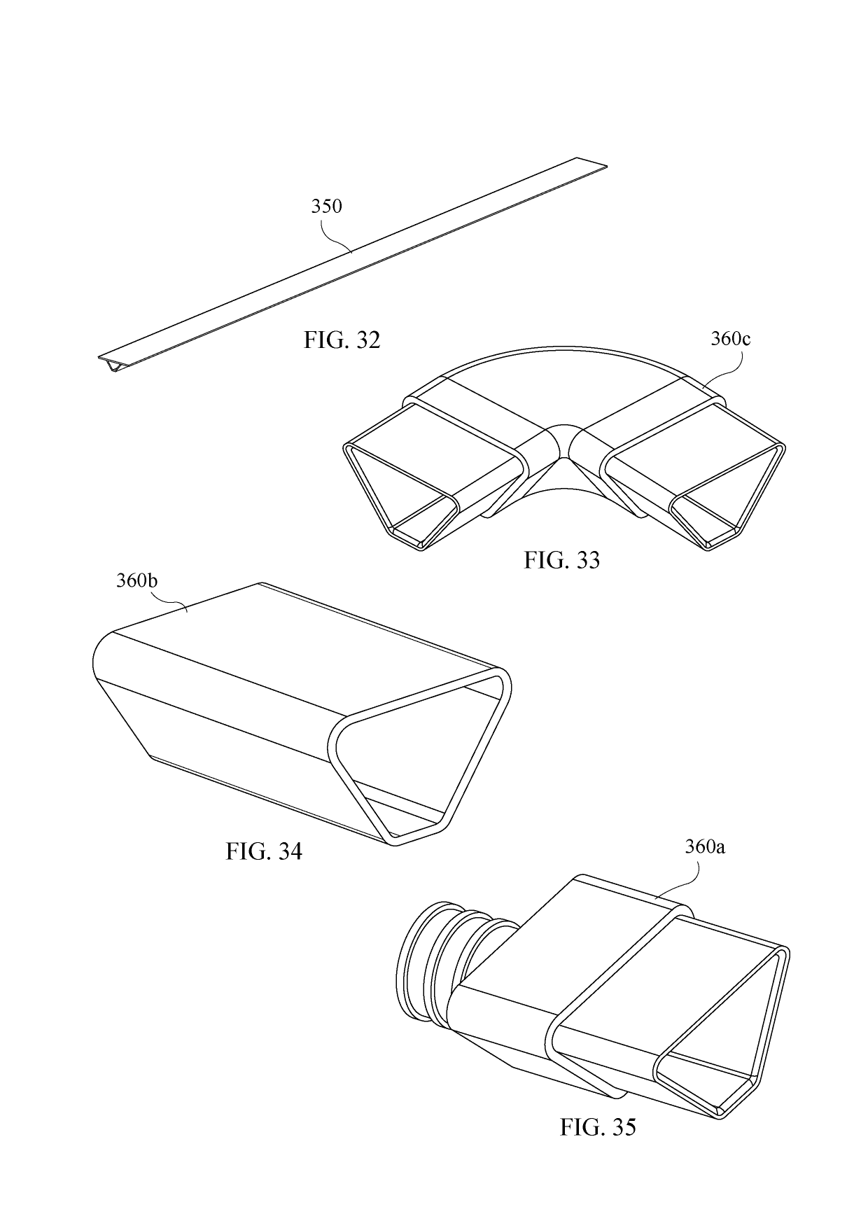

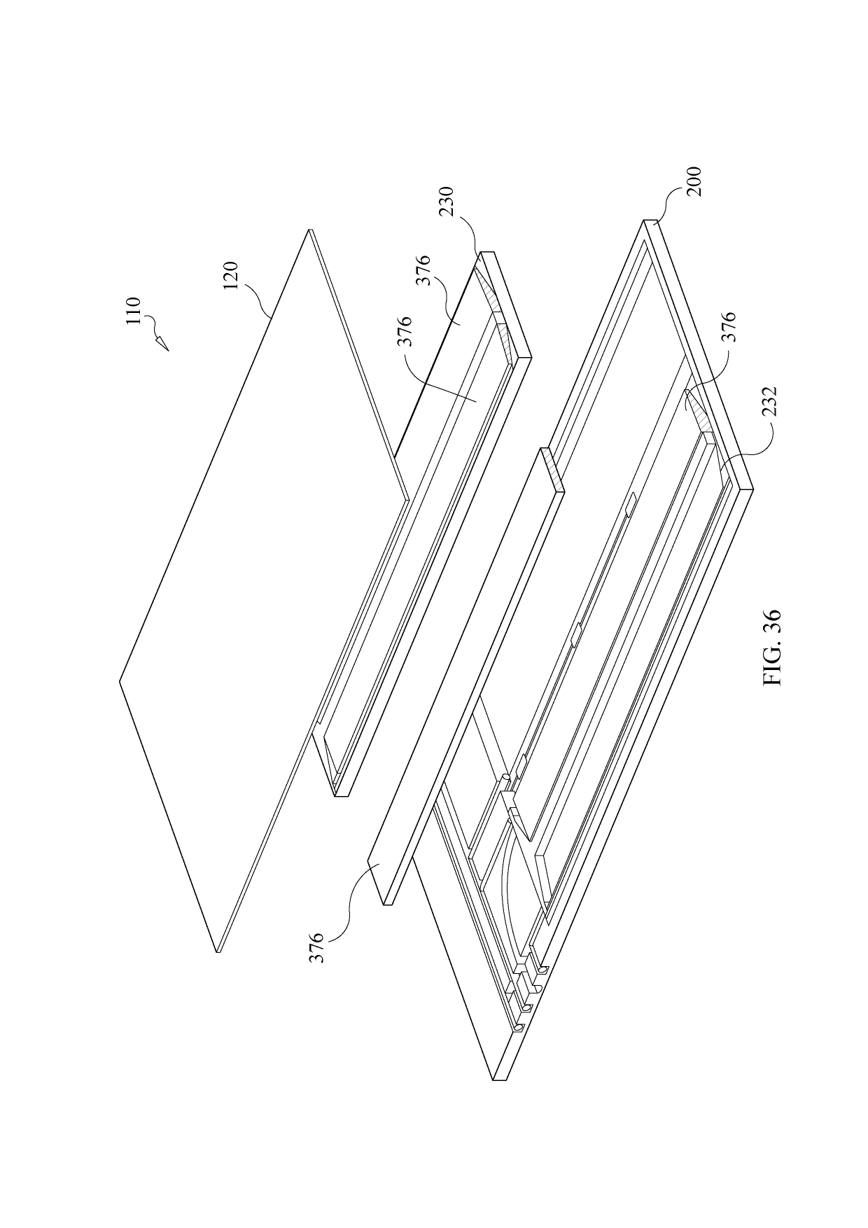

Referring to FIGS. 30-35, fittings 360a-c can be used to connect optional standard schedule pipe used for supply conduit 262, 362 between the inlet 241 and the conduit 350, and for return conduit 264, 364 between the conduit 350 and the outlets 245. The fittings 360a-c can also be used to couple together adjacent ends of channels 230 and 232 at the first and second ends 112, 114 of the thermal exchange pad. As shown in FIGS. 30 and 31, the supply channel 262, 362 can be fluidly coupled to and supply heat exchange fluid 612 to conduits 350 of the first and second channels 230, 232 adjacent a midpoint between the opposite sides 116, and the return channel 264, 364 can be fluidly coupled to and receive heat exchange fluid 612 from the conduits 350 of the first and second channels 230, 232 the sides 116.

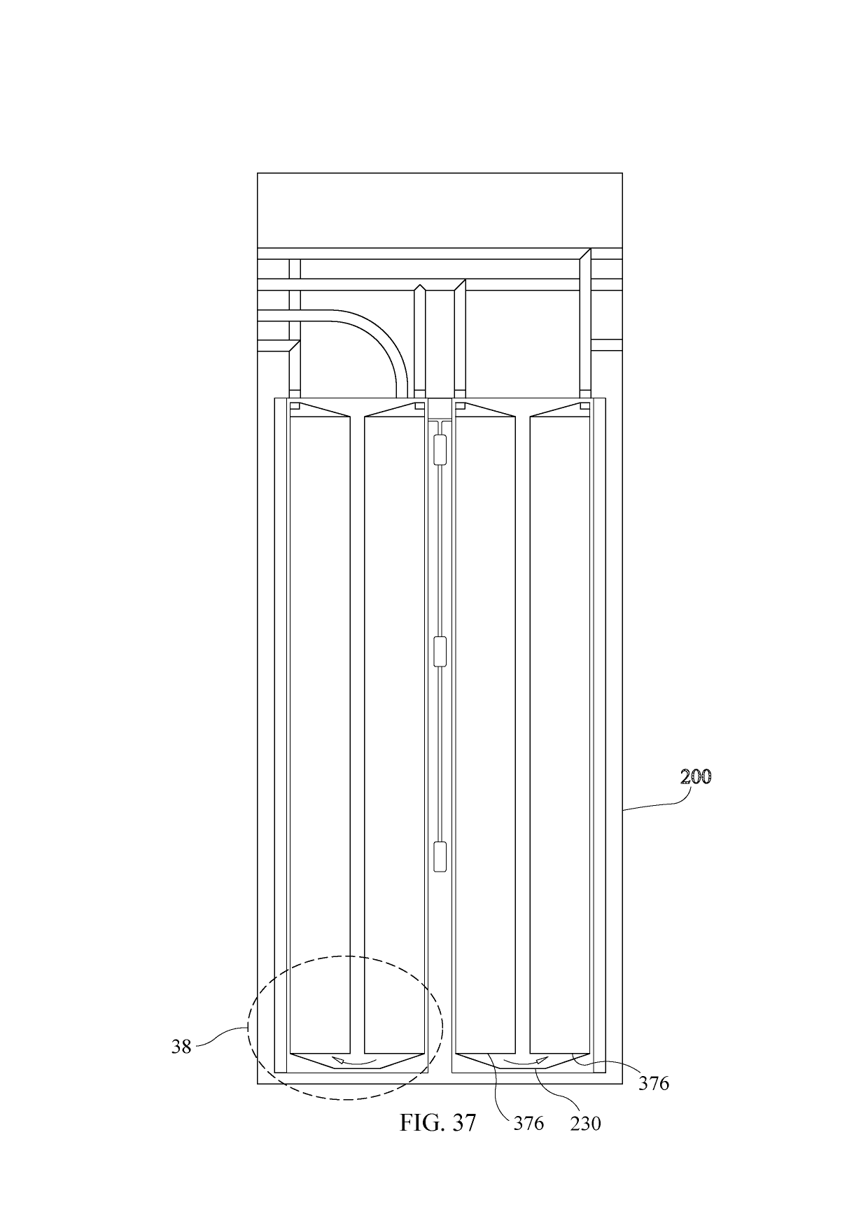

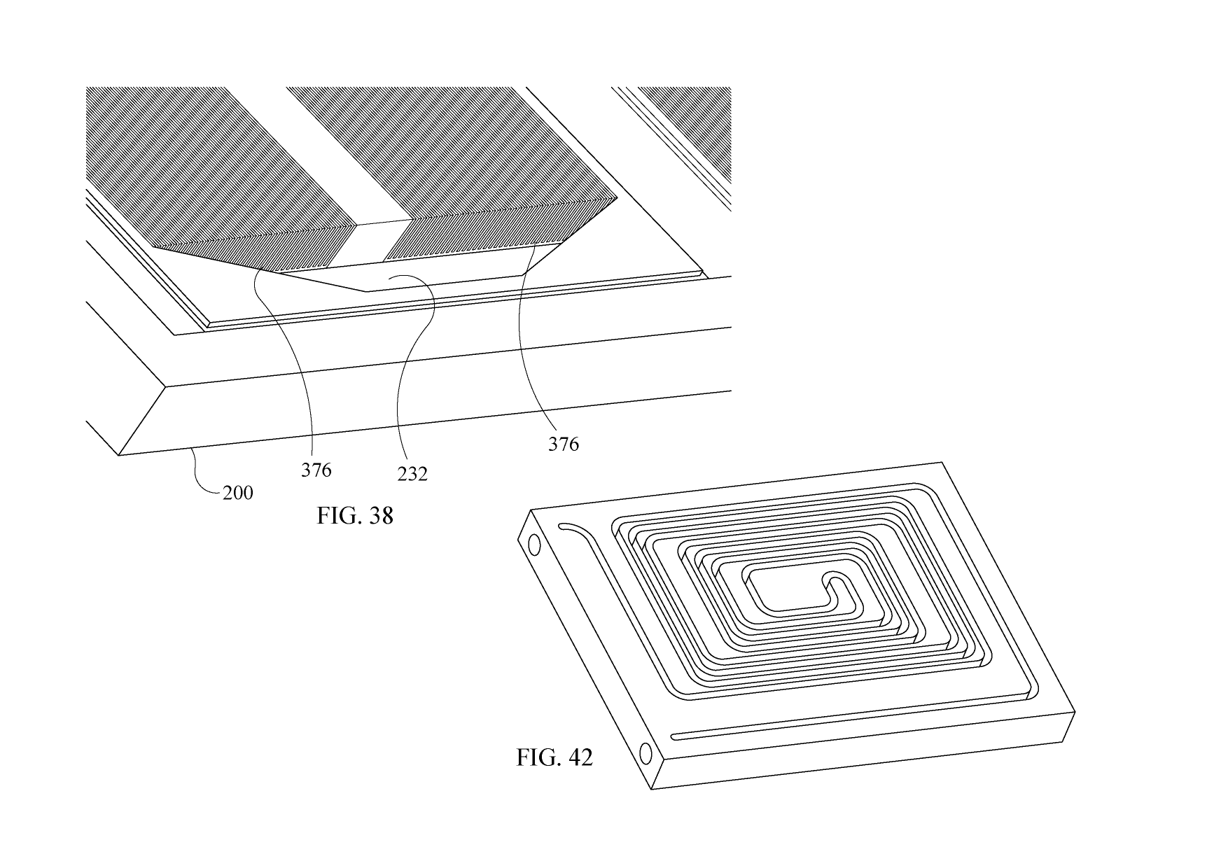

Referring to FIGS. 36-38, exploded, planar, and enlarged views of an illustrative embodiment of another thermal exchange pad 110 according to the present disclosure are illustrated. Advantageously, heat transfer arrays 376, for example thermally conductive heat sink with fins or other structures to maximize heat transfer is position within and fill the first and second channels 230, 232. The heat transfer arrays 376 are also in direct contact with and are optionally bonded or integral with the bottom surface 146 of the heat exchange plate 120 in order to maximize heat transfer. As can heat exchange fluid 612 flows there the large surface area provided by the heat transfer arrays 376, heat transfer is maximized. Additionally, the first and second channels 230, 232 each form a serpentine path across the heat exchange plate 120 and the channels are fluidly in parallel, thus exposing left and right sides of the heat exchange plate 120 to the heat exchange fluid having just entered the thermal exchange pad at inlet 241.

Referring to FIG. 36, the bottom surface of the heat exchange plate 120 may include structures to help seal and/or contact with the heat transfer arrays 376. In one embodiment a watertight seal around each of the first and second channels 230, 232 is provided by a gasket (not shown).

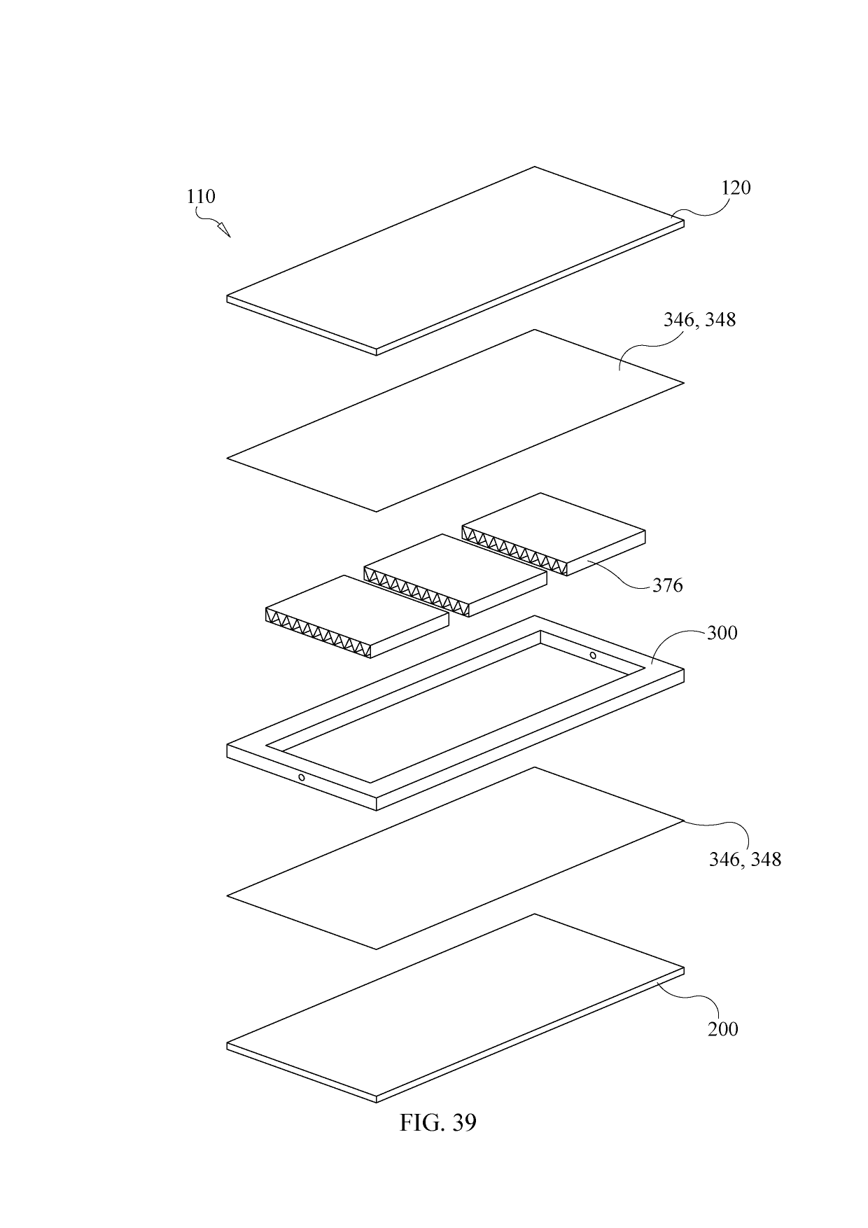

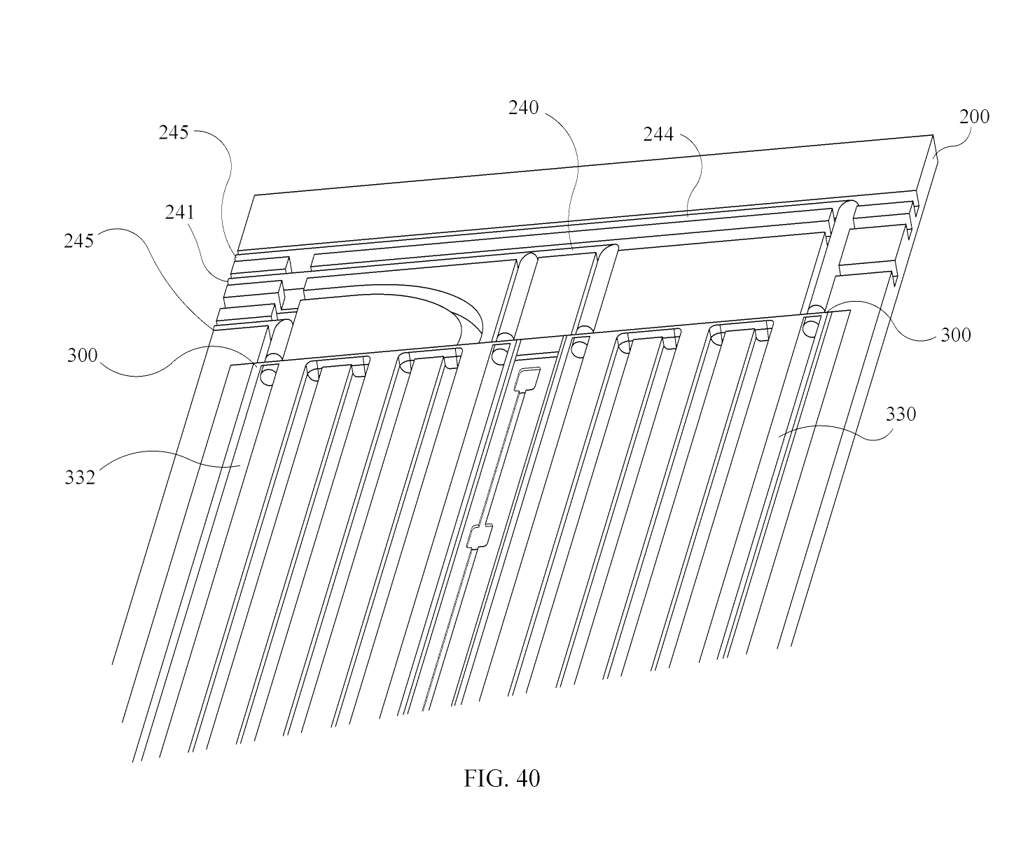

Referring to FIG. 39, an exploded view of another illustrative embodiment of a thermal exchange pad 110 according to the present disclosure is illustrated. The thermal exchange pad 110 including a channel 230 formed by intermediate layer 300 between heat exchange plate 120 and base 200. Advantageously, a heat transfer array 376, for example a heat sink having fins or other area expanding structures, can be in thermal contact with the heat exchange plate 120 and also can fill the channel 230 for the heat exchange fluid 612 to flow therethrough and maximize heat transfer. The components of the thermal exchange pad 110 can be bonded in a high-temperature vacuum brazing furnace, for example, by including a filler alloy sheet 348 between each of the layers. Alternatively, one or both of the filler alloy sheets 348 may be replaced by gaskets 346 between the layers that provide sealing with fasteners providing compression of the heat exchange plate 120, intermediate layer 300, and base 200.

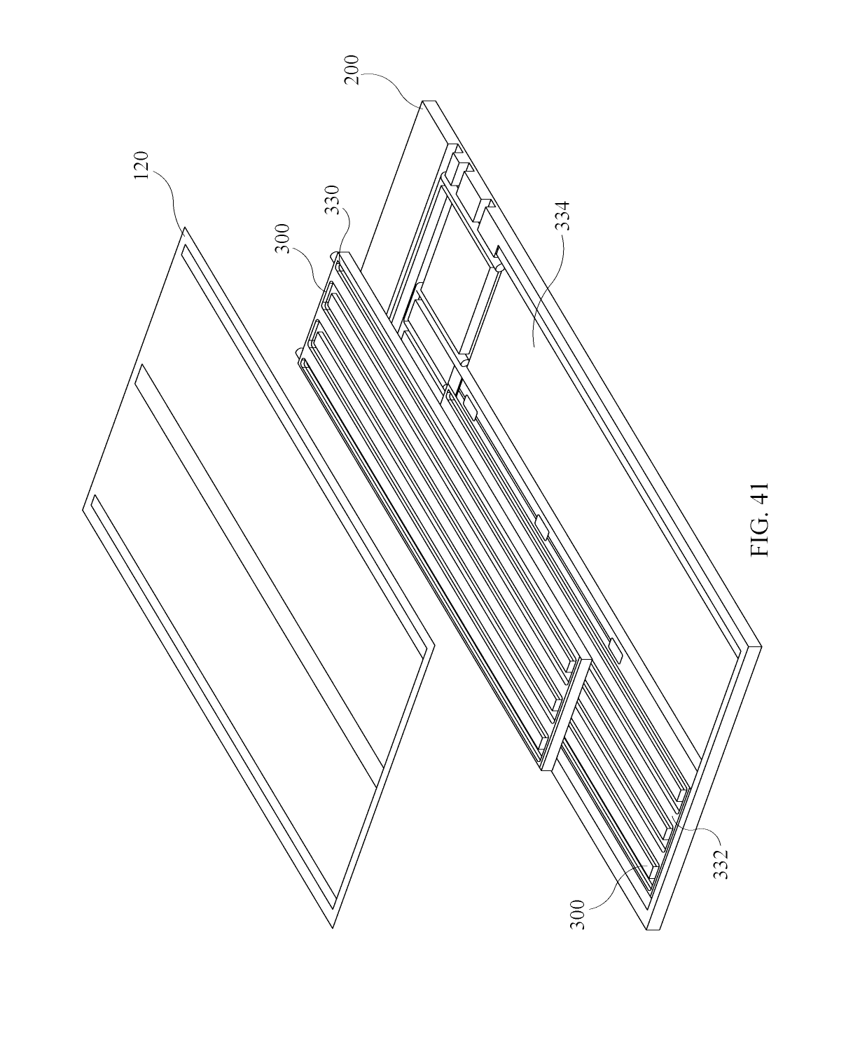

Referring to FIG. 40, a top view of another illustrative embodiment of a thermal exchange pad 110 according to the present disclosure is illustrated, and FIG. 41 illustrates a partially exploded view of the thermal exchange pad of FIG. 40. Base 200 includes large recesses 334, each of which house an intermediate layer 300 in which is formed a first or second channel 330. The first and second channels 330, 332 each form a serpentine path across the heat exchange plate 120 and the channels are fluidly in parallel, thus exposing left and right sides of the heat exchange plate 120 to the heat exchange fluid having just entered the thermal exchange pad at inlet 241. Assembly and bonding of the components of the thermal exchange pad 110 can be provided by the various means and materials discussed herein for other embodiments.

FIG. 42 illustrates a top perspective view of the base portion of another embodiment of a thermal exchange pad according to the present disclosure, the pad base having a single serpentine heat exchange fluid path that spirals from the outer edge, to the center, and out to the edge again for even thermal exchange across the entire pad.

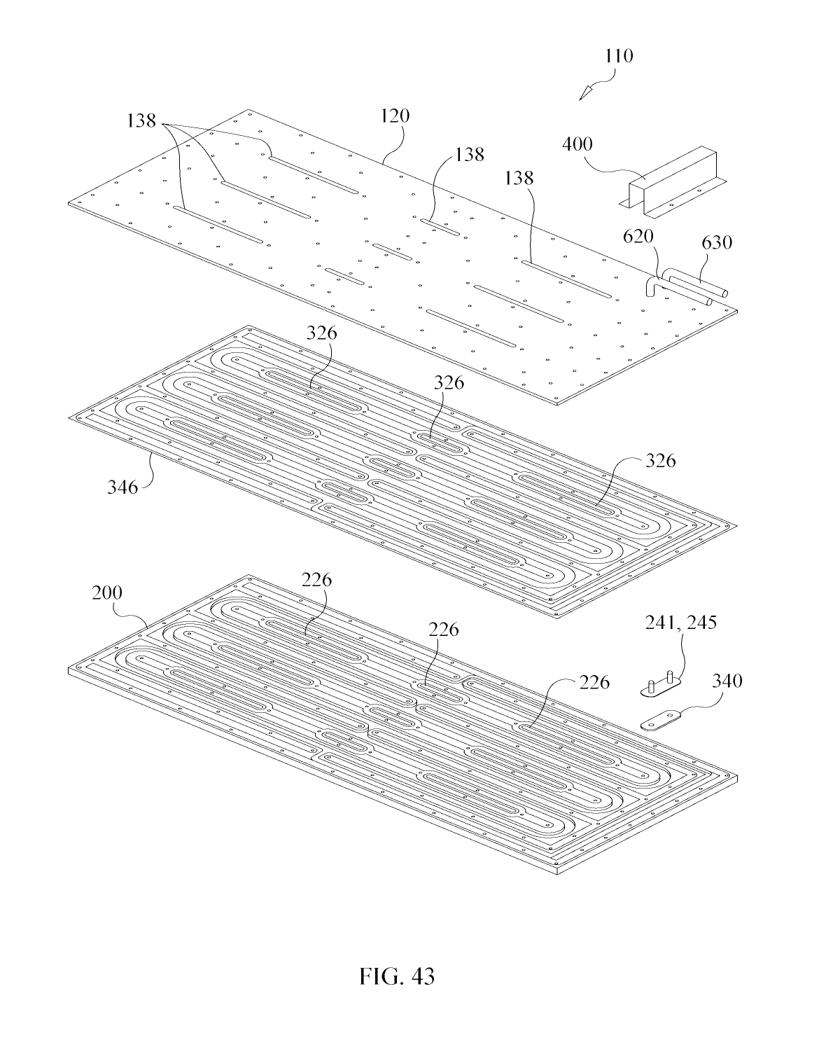

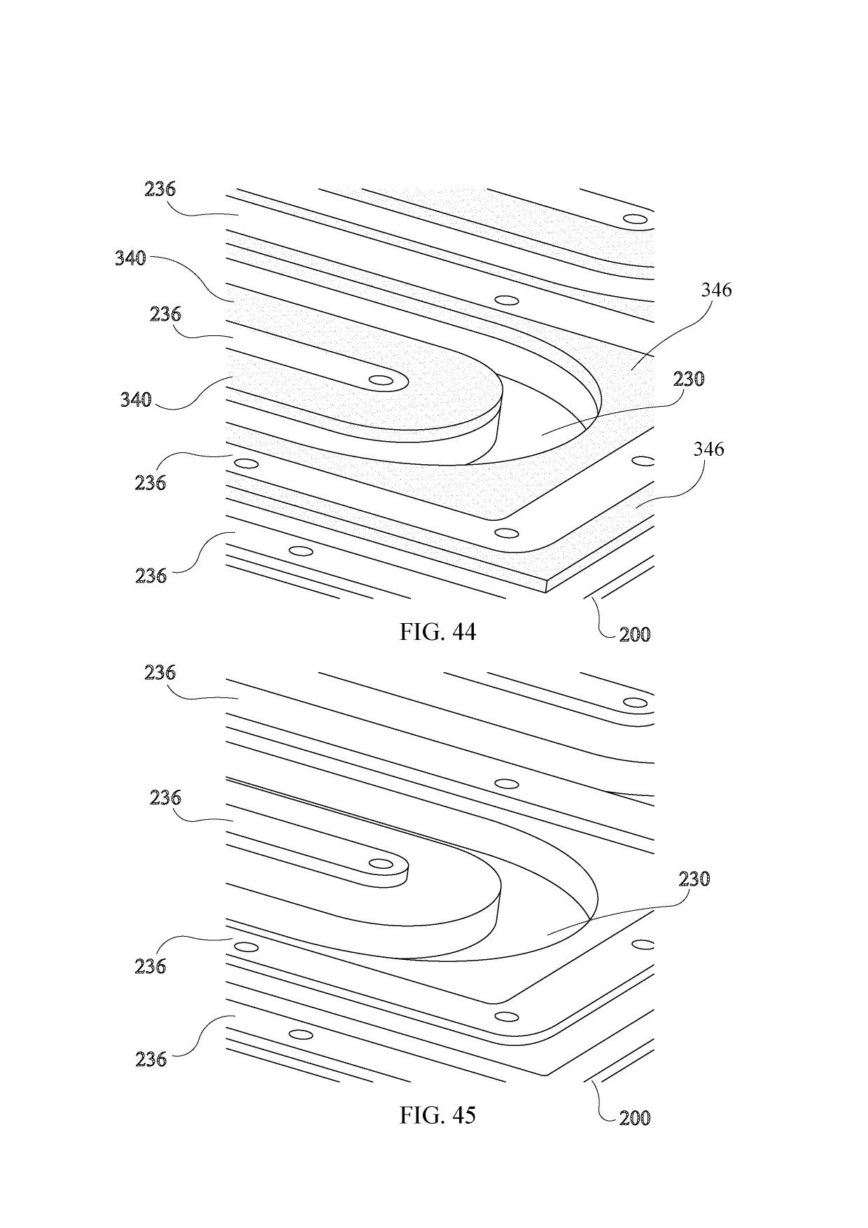

Referring to FIG. 43, an exploded view of another illustrative embodiment of a thermal exchange pad 110 according to the present disclosure is illustrated. This embodiment is highlighted by an intermediate gasket 346, for example a neoprene gasket, located between the heat exchange plate 120 and base 200. The base 200 defines fluid supply and return channels 240 and 244 and first and second channels 230 and 232. With the heat exchange plate mounted to base 200, for example, using fasteners 258 as discussed above for another embodiment, the gasket 346 is compressed, providing sealing of the various channels 240, 244, 230, and 232. In order to avoid over compression and failure of the gasket 346, compression stops 236, best illustrated in comparing FIGS. 44 and 45, extend from base 200.

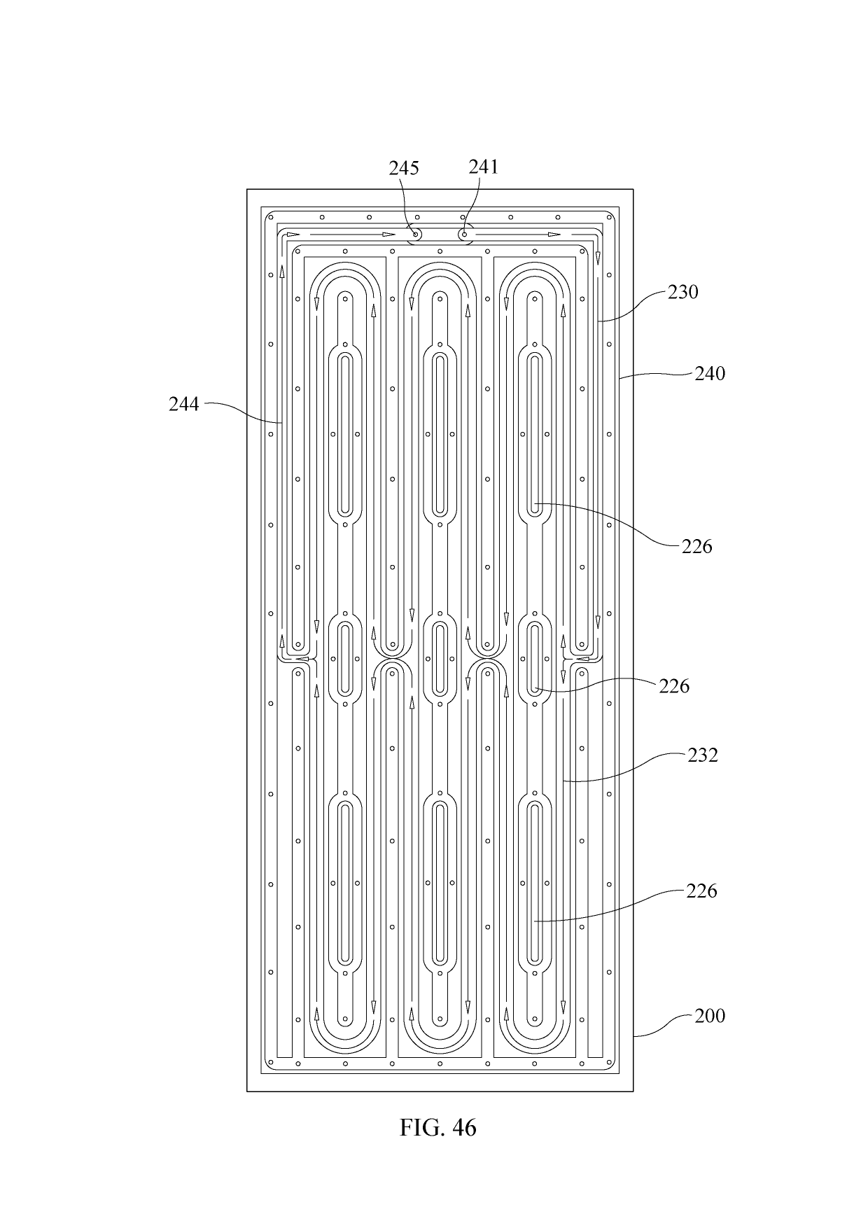

Referring to FIG. 46, an exemplary flow path plan for supply channel 240, first and second channels 230 and 232, and return channel 244 is illustrated. Advantageously, the first and second channels 230, 232 each form a serpentine path across the heat exchange plate 120 and the channels are fluidly in parallel, thus exposing first and second ends 112 and 114 of the heat exchange plate 120 to the heat exchange fluid having just entered the thermal exchange pad through supply channel 240.

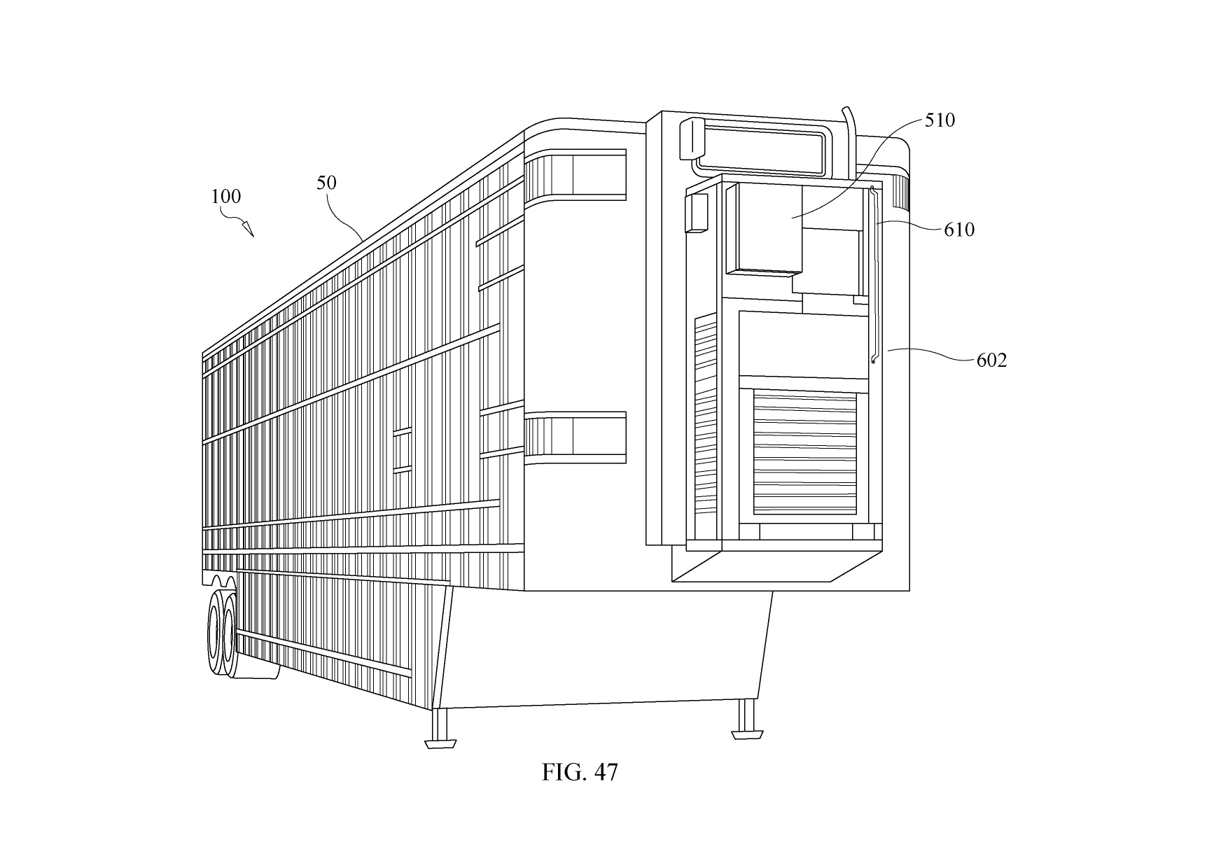

FIG. 47 illustrates a livestock transport trailer 50 having an illustrative embodiment of thermal exchange system 100 of FIG. 16, including thermal exchange pads 110, control system 500, and fluid system 600. While most portions of the thermal exchange system 100 can be located inside the transport trailer 50, some may be mounted externally, for example, at a front of the trailer 50 as shown in FIG. 47, including, for example, controller 510, thermal source 602, and reservoir 610.

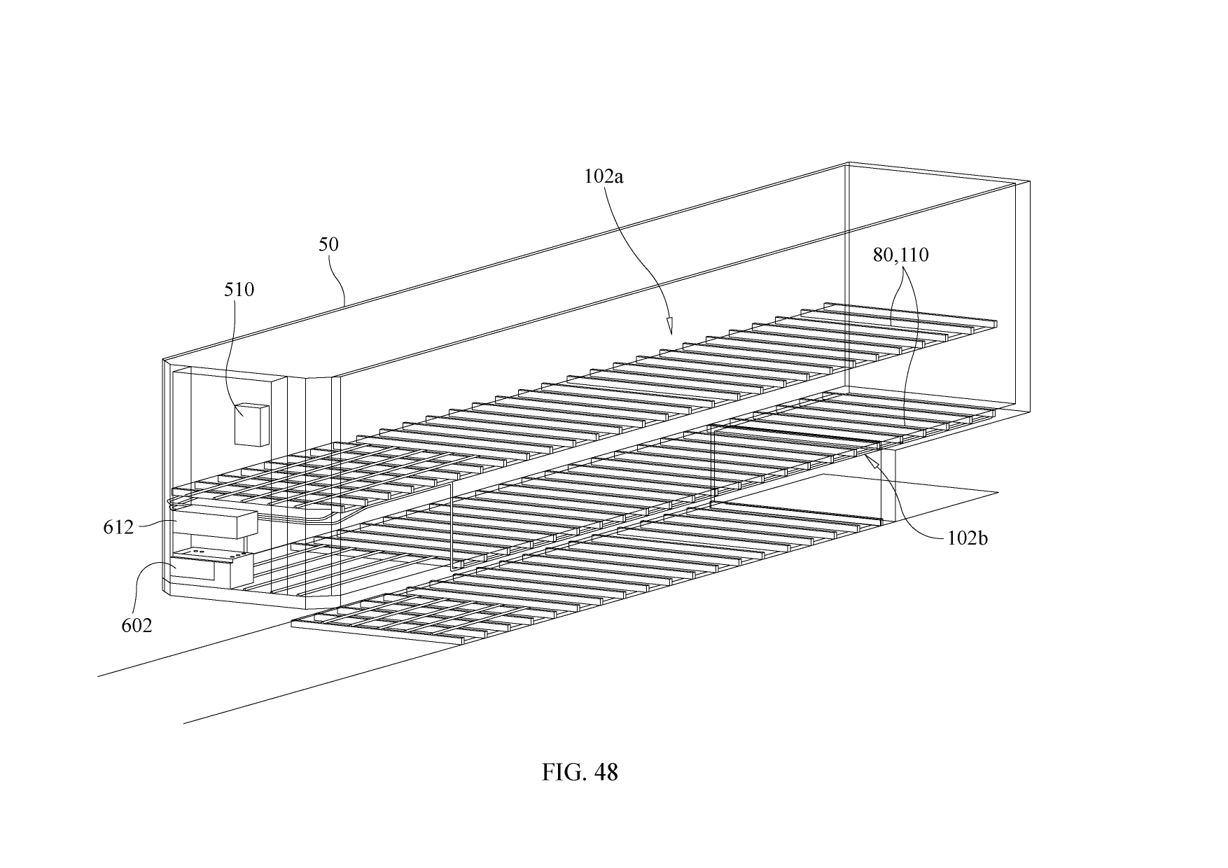

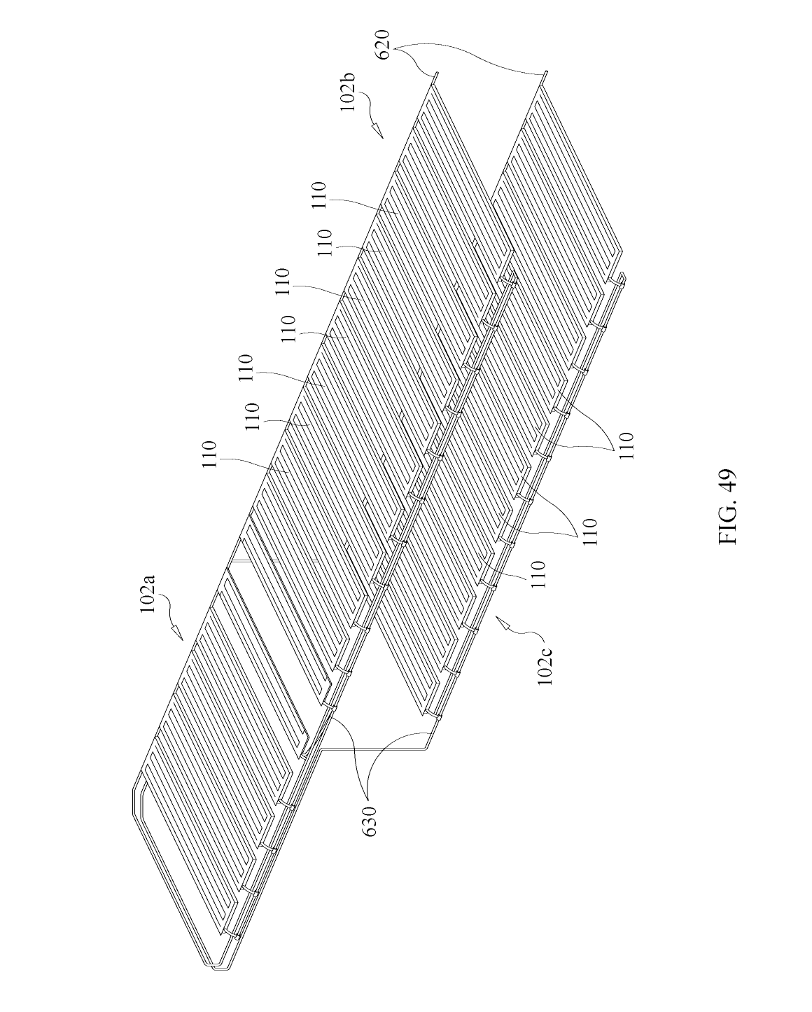

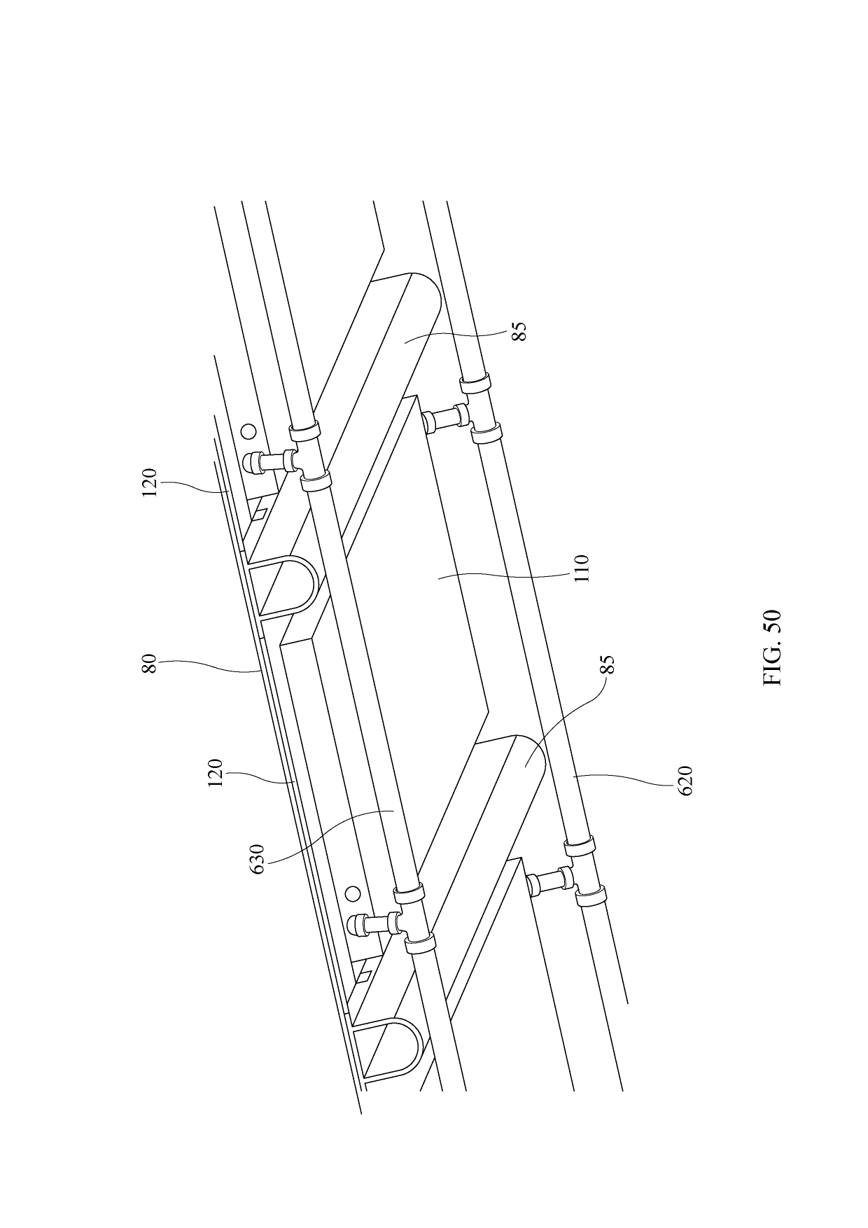

Referring to FIG. 48, a semitransparent view of the livestock transport trailer and thermal exchange system of FIG. 47 is illustrated. Livestock trailers 50 for swine may include multiple levels of floor 80. Advantageously, features of various embodiments of the above discussed thermal exchange system 100, including thermal exchange pads 110 may be incorporated into an existing livestock trailer, with one or more zones 102a-n included on each flooring level. For example, as illustrated in FIG. 49, thermal exchange pads 110a-n for each zone 102a-n can be arranged and supplied with heat exchange fluid 612 via supply lines 620 and return lines 630 in order to heat and/or cool the livestock flooring 80 (see FIG. 50) upon which livestock such as mature or immature swine rest in the livestock trailer 50.

FIG. 50 illustrates an embodiment of the thermal exchange pads 110 adapted for installation with existing flooring 80 in a livestock transport trailer 50. More specifically, the top surface 132 of heat exchange plates 120 of thermal exchange pads 110 can be thermally coupled, e.g. placed in direct mechanical contact with the bottom surface of livestock flooring 80 sections located between flooring superstructure 85, e.g. beams or other periodic flooring support members. Supply lines 620 and return lines 630 of fluid system 600 can run on the same or opposite sides of the interior of trailer 50 to couple with the reservoir 610 and other components of the control system 500 and fluid system 600 as illustrated in FIG. 16, including those components of the system located at the front of the trailer as shown in FIG. 47. The heat exchange fluid 612 may be supplied to the pads 110 with a zone 102 either in a parallel or series fluid connection.

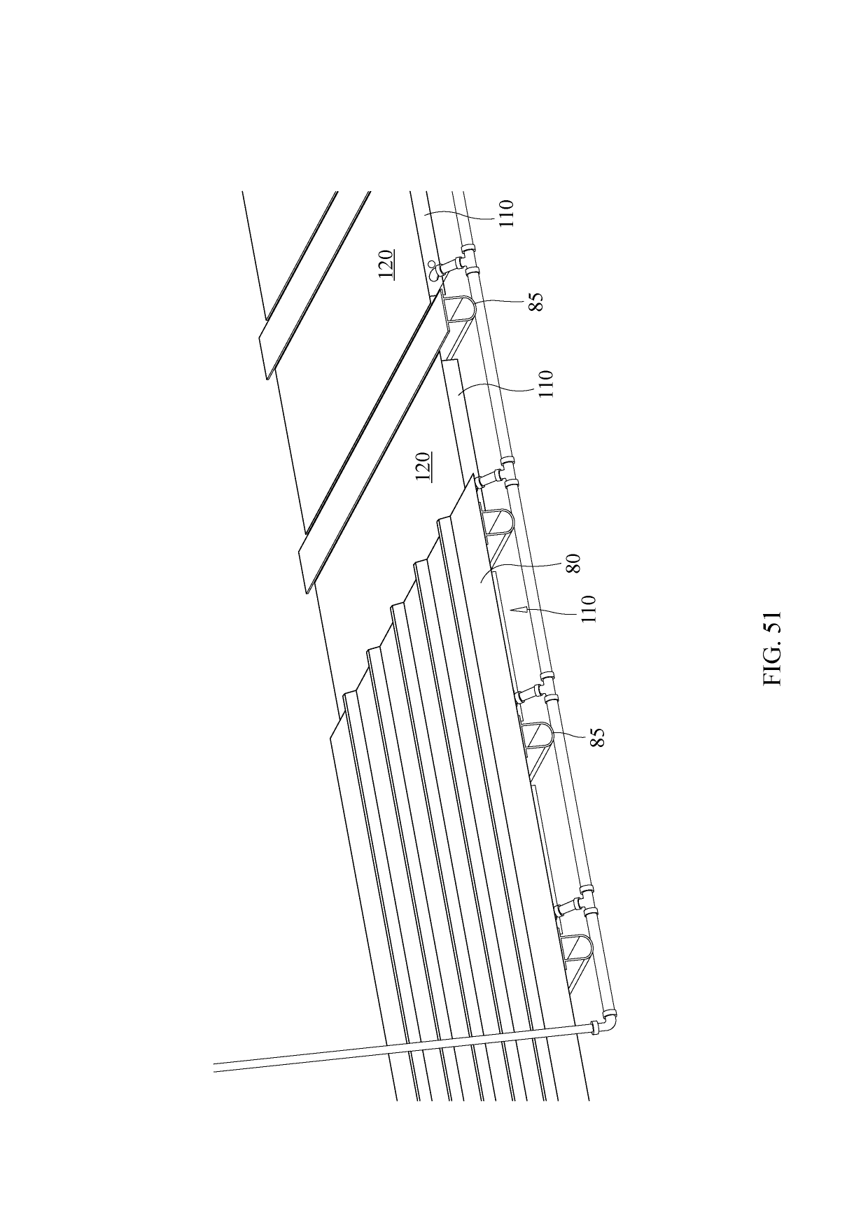

Alternatively, as shown in FIG. 51, another embodiment of the thermal exchange pads 110 adapted for installation in a livestock transport trailer 50 may provide the structural support to serve as the flooring upon which the livestock are carried, thus providing more direct heating and cooling of the livestock. For example, the thermal exchange pads 110 may be fastened to the flooring superstructure 85, for example, thermal exchange pads may be sized such that a portion of the heat exchange plate 120 overlaps and is supported along opposite sides by adjacent flooring superstructures 85.

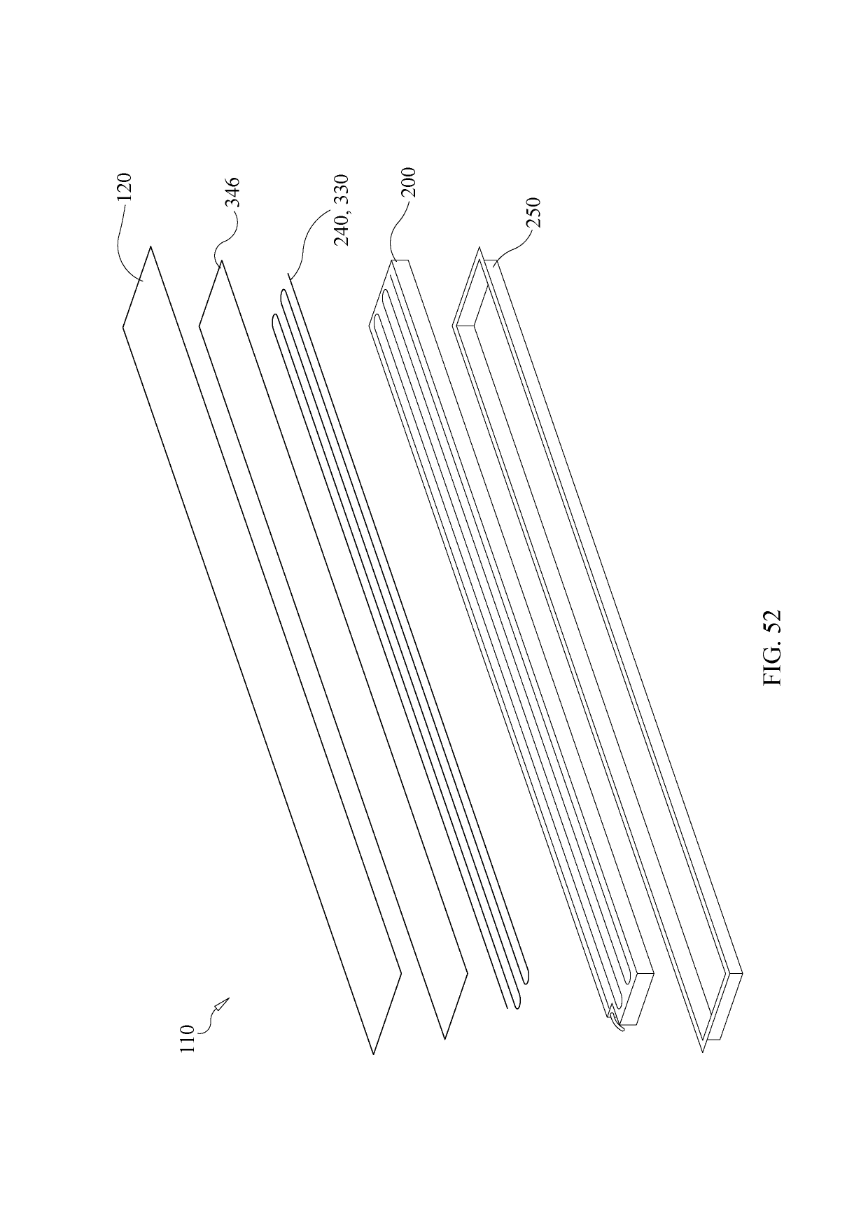

Referring to FIG. 52, an exploded view of an illustrative embodiment of a thermal exchange pad 110 adapted for installation in a livestock transport trailer 50 is shown. Thermal exchange pad 110 may include an heat exchange plate 120, for example, stamped or cast aluminum sheet, water sealing gasket 346, fluid supply channels 240, for example formed from conduits 330, base 200 that provides at least one of structural support and insulation below and to the sides of the fluid supply channels, and bottom surface 250, which in the illustrated embodiment is shaped to form a tray, for example, formed from aluminum sheet, which can be sized to encapsulate the base 200, conduit 330, and be fastened along flanges to the bottom of the heat exchange plate 120 with fasteners, welding, adhesives, and the like.

Features and functions discussed in the other above listed embodiments for system 100 adapted for installation in a barn may also be incorporated into the thermal exchange pad 110 and other components of system 100. For thermal exchange pads 110 that serve as the flooring in the livestock transport trailer 50, a top surface 132 of the heat exchange plate 120 may define a structure to increase the friction and reduce the likelihood of livestock slipping and being injured, for example a pattern of treads 134 (shown in FIGS. 9 and 10) as is typically found in tread plate, for example a “diamond” plate. For thermal exchange pads 110 that are coupled to the bottom surface of existing flooring 80, such treads 134 or other structure would be absent in order to maximize contact are and thermal transfer between the flooring 80 and heat exchange plate 120. In at least one embodiment of the thermal exchange pads 110 adapted for installation in a transport trailer 50, debris drains 118 are omitted based on the stacked arrangement of flooring 80 that is typical.

While examples, one or more representative embodiments and specific forms of the disclosure have been illustrated and described in detail in the drawings and foregoing description, the same is to be considered as illustrative and not restrictive or limiting. The description of particular features in one embodiment does not imply that those particular features are necessarily limited to that one embodiment. Some or all of the features of one embodiment can be used or applied in combination with some or all of the features of other embodiments unless otherwise indicated. One or more exemplary embodiments have been shown and described, and all changes and modifications that come within the scope of the disclosure are desired to be protected.

### ELEMENT NUMBERING

Table 1 includes element numbers and at least one word used to describe the member and/or feature represented by the element number. It is understood that none of the embodiments disclosed herein are limited to these descriptions, other words may be used in the description or claims to describe a similar member and/or feature, and these element numbers can be described by other words that would be understood by a person of ordinary skill reading and reviewing this disclosure in its entirety.

50 livestock transport trailer

70 farrowing crate (prior art)

72 head end

74 tail end

76 side

80 livestock flooring (prior art)

81 drain

82 open area

84 side area

85 flooring superstructure

86 elevated runner

88 pit

90 boar pen (prior art)

92 head end

100 thermal exchange system

102 zones

110 thermal exchange pad

112 first end

114 second end

116 side

118 debris drains

120 heat exchange plate

122 access cover portion

124 main portion

130 top layer

132 top surface

134 treads

136 slope

138 openings

140 edges

142 flanges

144 cutouts

146 bottom surface

148 bottom layer

150 temperature sensor

152 mounting structure

154 sensors

156 cable

158 protective sheath

170 retainer

172 fastener

200 base or fluid plate

210 edge

212 first end

214 second end

220 top surface

222 access compartment

224 thermal exchange portion

226 openings

230 first channel

232 second channel

234 recess

236 compression stops

240 fluid supply channel

241 inlet

242 manifold

243 manifold cover

244 fluid return channel

245 outlet

246 receptacle

250 bottom surface / tray

252 recessed area

254 receiver

255 slot

256 cutout

258 fastener

262 supply conduit

264 return conduit

270 electrical terminal box

271 terminal cover

272 terminal

376 heat transfer array

300 intermediate layer

321 edge

322 flange

324 cutouts

326 openings

328 support

329 bond

330 first channel

332 second channel

340 fluid supply channel

344 fluid return channel

346 gasket / fluid seal

348 filler alloy

350 conduit

352 width

354 height

356 top

358 planar extensions

360 conduit fittings

362 supply conduit

364 return conduit

370 thermal couple

376 heat transfer arrays

380 insulation

400 raceway

402 body

404 length

406 first end

408 second end

410 central portion

412 fillets

414 channel

500 control system

510 controller

512 controller cable

514 ambient temperature sensor

600 fluid system

602 thermal source

604 thermal fluid exchange loop

610 reservoir

611 reservoir pump

612 heat exchange fluid

614 heat element

616 pump

618 level sensor

620 supply line

625 fluid connector

630 return line

640 flow control devices

642 flow regulating valve

644 bypass recirculation valve

646 flow rate sensor

650 expansion box

What is claimed is:

1. A thermal exchange pad for livestock flooring, comprising:
a fluid plate defining a first plurality of openings therethrough;
a heat exchange plate spanning over and coupled to the fluid plate, the heat exchange plate rigid, adapted for supporting livestock thereon, and defining a second plurality of openings therethrough;
at least a first channel for receiving a heat exchange fluid therein, the at least a first channel formed by coupling of the fluid plate and the heat exchange plate; and
wherein:
the at least a first channel is defined at least in part by and open to at least a portion of a bottom surface of the heat exchange plate, thereby enabling the heat exchange fluid to directly contact the bottom surface of the heat exchange plate and maximize the heat exchange with livestock thereon; and
the first plurality of openings are coterminous with the second plurality of openings to define a plurality of debris drains through the thermal exchange pad.

2. The thermal exchange pad of claim 1, further comprising a first manifold and wherein:
the at least a first channel comprises at least two parallel channels; and
the manifold fluidly couples the at least a first channel at a first end.

3. The thermal exchange pad of claim 2, further comprising a second manifold fluidly coupling the at least a first channel at a second end.

4. The thermal exchange pad of claim 3, wherein the first manifold and the second manifold are defined by the fluid plate and the heat exchange plate.

5. The thermal exchange pad of claim 1, wherein the heat exchange plate further defines anti-slip treads protruding from a top surface of the heat exchange plate.

6. The thermal exchange pad of claim 1, wherein:
the at least a first channel comprises at least two parallel channels; and
the at least a first channel transits past opposite sides of at least a subset of the plurality of debris drains.

7. The thermal exchange pad of claim 1, wherein a bottom surface of the fluid plate defines recesses that encompass a plurality of the debris drains and form debris channels to enable a flow of debris from debris drains located atop a supporting livestock floor member.

8. The thermal exchange pad of claim 1, wherein at least a portion of a top surface of the heat exchange plate is sloped downwardly from a center toward at least a pair of opposite sides, thereby facilitating runoff of debris from the top surface.

9. The thermal exchange pad of claim 1, wherein an edge perimeter of the fluid plate is angled outwardly from a top edge to a bottom edge.

10. The thermal exchange pad of claim 1, further comprising:
a fluid supply inlet fluidly coupled to the at least a first channel; and
a fluid discharge outlet fluidly coupled to the at least a first channel; and
wherein at least a subset of the at least a first channel define a serpentine routing of the heat exchange fluid between the fluid supply inlet and the fluid discharge outlet.

11. The thermal exchange pad of claim 1, further comprising a layer located between the heat exchange plate and the fluid plate and wherein the layer provides a fluid seal between the heat exchange plate and the fluid plate, including sealing the at least a first channel.

12. The thermal exchange pad of claim 1, wherein the heat exchange plate comprises:
a removable access cover portion spanning a compartment of the fluid plate; and
a main portion spanning a remaining portion of the fluid plate.

13. The thermal exchange pad of claim 1, wherein a lateral cross-section of the at least a first channel defines a largest width that is greater than a largest height.

14. The thermal exchange pad of claim 1, further comprising a receptacle for a temperature sensor, the receptacle adapted to position the temperature sensor in contact with a bottom surface of the heat exchange plate.

15. The thermal exchange pad of claim 1, wherein the fluid plate is configured as a base plate to rest upon an existing livestock flooring in a barn.

16. The thermal exchange pad of claim 1, wherein the thermal exchange pad is configured to couple with existing livestock flooring of a livestock transport trailer.

17. The thermal exchange pad of claim 16, wherein a top surface of the heat exchange plate is thermally coupled with the bottom surface of the existing livestock flooring.

18. The thermal exchange pad of claim 1, wherein the thermal exchange pad is configured to provide structural support to function as the livestock flooring in a barn or in a livestock transport trailer.

19. A thermal exchange system for livestock flooring, comprising:
a first plurality of thermal exchange pads each including:
a plurality of heat exchange fluid channels for receiving a heat exchange fluid therein; and
a heat exchange plate that is thermally conductive and spans over the plurality of heat exchange fluid channels, the heat exchange plate adapted for supporting livestock thereon and defining a plurality of debris drains therethrough;
wherein:
the plurality of heat exchange fluid channels are defined at least in part by and open to at least a portion of a bottom surface of the heat exchange plate, thereby enabling the heat exchange fluid to directly contact the bottom surface of the heat exchange plate and maximize the heat exchange with livestock thereon;
a thermal fluid system, including:
a heat exchange fluid reservoir;
a thermal source supplying temperature regulated heat exchange fluid to the heat exchange reservoir;
a pad supply line supplying heat exchange fluid from the reservoir to a fluid supply inlet of the first plurality of thermal exchange pads;
a pad return line for returning heat exchange fluid from a fluid return outlet to the heat exchange fluid reservoir;
a supply pump for pumping the heat exchange fluid between the reservoir and the fluid supply inlet; and
a recirculation valve for selectively directing heat exchange fluid in the pad return line to the reservoir and to the pad supply line; and
a controller;
a reservoir temperature sensor to enable the controller to control the thermal source to maintain the heat exchange fluid in the reservoir at a preset reservoir temperature; and
a first return line temperature sensor to measure the temperature of the heat exchange fluid exiting the fluid return outlet of the first plurality of thermal exchange pads; and
wherein the controller is configured to selectively switch the recirculation valve at a preset temperature of the heat exchange fluid measured by the first return line temperature sensor.

20. The thermal exchange system of claim 19, further comprising an ambient temperature sensor; and wherein the controller is configured to activate the thermal fluid system above or below a preset ambient temperature.

21. The thermal exchange system of claim 19, wherein:
each of the first plurality of thermal exchange pads further include:
a fluid plate coupled with the heat exchange plate, the coupling of the fluid plate and the heat exchange plate defining the first plurality of exchange fluid channels; and
wherein the heat exchange plate spans over the fluid plate.

22. The thermal exchange system of claim 19, further comprising:
a second plurality of thermal exchange pads;
a second return line temperature sensor;
a first flow control device controlled by the controller for selectively supplying the flow of heat exchange fluid to the first plurality of thermal exchange pads; and
a second flow control device controlled by the controller for selectively supplying the flow of heat exchange fluid to the second plurality of thermal exchange pads; and
wherein the controller is further configured to control the first and second flow control devices to maintain the heat exchange fluid exiting the fluid return outlet of the first plurality of thermal exchange pads to a preset temperature based in part on a signal from the first return line temperature sensor and to maintain the heat exchange fluid exiting the heat exchange fluid channels of the second plurality of thermal exchange pads to a preset temperature based on a signal from the second return line temperature sensor.

23. The thermal exchange system of claim 19, further comprising a first supply line temperature sensor, and wherein the controller is configured to control the fluid system to maintain the heat exchange fluid entering the fluid supply inlet of the first plurality of thermal exchange pads to a preset temperature.

24. The thermal exchange system of claim 19, wherein the thermal exchange system is adapted for installation on a livestock transport trailer.

25. The thermal exchange system of claim 19, wherein the fluid plates of the first plurality of thermal exchange pads are configured as a base plate to rest upon an existing livestock flooring in a barn.
